(19) United States
(12) Patent Application Publication
(10) Pub. No.: US 2021/0155277 A1
(43) Pub. Date: May 27, 2021

(54) WHEELBARROW MODULAR ATTACHMENTS

(71) Applicant: ConceptsM LLC, Akron, OH (US)

(72) Inventor: Anton G. C. Milo, Akron, OH (US)

(21) Appl. No.: 17/102,021

(22) Filed: Nov. 23, 2020

Related U.S. Application Data
(60) Provisional application No. 62/938,468, filed on Nov. 21, 2019.

(51) Int. Cl. B62B 1/20; B62B 1/26; B62B 1/00

(52) U.S. Cl. CPC B62B 1/20; B62B 1/008; B62B 1/262

(57) ABSTRACT

Wheelbarrow auxiliary or modular attachments that can include auxiliary storage devices, transport/stability pins, lids/covers, seats, stabilizers/struts, other storage/support devices, auxiliary power (outlets, charges, etc.), batteries, cupholders, tub extensions/baskets, device holders, attachment holders, counterweights, stabilizer wheels, quick connection/release mechanisms, etc. In various embodiments, one or more modular attachments or devices can be selectively added or attached to a wheelbarrow as needed. In some embodiments, the modular attachments or devices can be included with the wheelbarrow from the onset. In other embodiments, modular attachments can be added to the wheelbarrow later, including as a kit.

### CROSS REFERENCE TO RELATED APPLICATIONS

This application claims priority to, and any other benefit of, U.S. Provisional Patent Application Ser. No. 62/938,468, filed on Nov. 21, 2019 and entitled WHEELBARROW MODULAR ATTACHMENTS (Attorney Docket No. 35773/04022).

### BACKGROUND

Wheelbarrows are designed to haul various materials in a tub of the wheelbarrow. The materials are typically associated with a particular project that also requires various other materials, including, for example, tools, gloves, hardware, user devices, etc.

### SUMMARY

According to one embodiment, a wheelbarrow auxiliary storage device includes a tube configured to attach to a frame or a tub of a wheelbarrow, wherein the tube is configured to store an item transported by the wheelbarrow and retain the item stored in the tube when the wheelbarrow is in a tipping position, and an integrated mounting member for attaching the tube to the frame or the tub of the wheelbarrow, wherein a length of the attached tube and a length of an elongated item stored in the tube are in a substantially horizontal position when the wheelbarrow is not in a tipping position.

The descriptions of the invention do not limit the words used in the claims in any way or the scope of the claims or invention. The words used in the claims have all of their full ordinary meanings.

### BRIEF DESCRIPTION OF THE DRAWINGS

In the accompanying drawings, which are incorporated in and constitute a part of the specification, embodiments of the invention are illustrated, which, together with a general description of the invention given above, and the detailed description given below, serve to exemplify embodiments of this invention and highlight the functional modality of the invention, including any methods.

FIG. 1 is a rear-side perspective view of an exemplary embodiment of a wheelbarrow having multiple auxiliary storage devices;

FIG. 2 is a top view of an exemplary embodiment of a wheelbarrow having multiple auxiliary storage devices;

FIG. 3 is a side view of an exemplary embodiment of a wheelbarrow having multiple auxiliary storage devices;

FIG. 4 is a front view of an exemplary embodiment of a wheelbarrow having multiple auxiliary storage devices;

FIG. 5 is a rear view of an exemplary embodiment of a wheelbarrow having multiple auxiliary storage devices;

FIG. 6 is a side view of an exemplary embodiment of a wheelbarrow having multiple auxiliary storage devices in a tipping position;

FIG. 7 is a top view of an exemplary embodiment of a wheelbarrow having multiple transport pins;

FIG. 8 is a perspective view of an exemplary embodiment of a transport pin and a mating recess;

FIG. 9 is a perspective view of another exemplary embodiment of the transport pin and another mating recess;

FIG. 10 is a side view of an exemplary embodiment of a wheelbarrow having multiple transport pins in the transport position;

FIG. 11 is a side view of an exemplary embodiment of a wheelbarrow having multiple transport pins in the stored position;

FIG. 12 is a rear-side perspective view of an exemplary embodiment of a wheelbarrow having multiple auxiliary storage devices;

FIG. 13 is a perspective view of an exemplary embodiment of a storage tube;

FIG. 14 is a bottom view of an exemplary embodiment of a wheelbarrow having multiple auxiliary storage devices;

FIG. 15 is a rear cross-section view of an exemplary embodiment of a wheelbarrow having multiple storage tubes;

FIG. 16 is a rear-side perspective view of an exemplary embodiment of a wheelbarrow having multiple auxiliary storage devices;

FIG. 17 is a perspective view of an exemplary embodiment of a tube extender;

FIG. 18 is a perspective view of an exemplary embodiment of a tube extender;

FIG. 19 is a perspective view of an exemplary embodiment of a tube extender;

FIG. 20 is a perspective view of an exemplary embodiment of a tube extender;

FIG. 21 is a perspective view of an exemplary embodiment of a storage tube and tube extenders;

FIG. 22 is a perspective view of an exemplary embodiment of a transport pin;

FIG. 23 is a perspective view of an exemplary embodiment of a transport pin;

FIG. 24 is a perspective view of an exemplary embodiment of a transport pin;

FIG. 25 is a perspective view of an exemplary embodiment of a transport pin;

FIG. 26 is a side view of an exemplary embodiment of a transport pin;

FIG. 27 is a side view of an exemplary embodiment of a transport pin;

FIG. 28 is a side view of an exemplary embodiment of a transport pin;

FIG. 29 is a side view of an exemplary embodiment of a transport pin;

FIG. 30 is a rear-side perspective view of an exemplary embodiment of a wheelbarrow having multiple auxiliary storage devices, a cover, and transport pins;

FIG. 31 is a rear-side perspective view of an exemplary embodiment of a wheelbarrow having multiple auxiliary storage devices and transport pins;

FIG. 32 is a rear-side perspective view of an exemplary embodiment of a wheelbarrow having multiple auxiliary storage devices, a seat, and supports;

FIG. 33 is a rear-side perspective view of an exemplary embodiment of a wheelbarrow having multiple auxiliary storage devices, a removed seat, and supports;

FIG. 34 is a bottom view of an exemplary embodiment of a wheelbarrow with a seat in a stowed position;

FIG. 35 is a side view of an exemplary embodiment of a wheelbarrow having multiple auxiliary storage devices, a seat, and supports;

FIG. 36 is a bottom view of an exemplary embodiment of a wheelbarrow having multiple auxiliary storage devices, a seat, and supports;

FIG. 37 is a bottom view of an exemplary embodiment of a wheelbarrow with a seat in a stowed position;

FIG. 38 is a perspective view of an exemplary embodiment of a seat with supports;

FIG. 39 is a perspective view of an exemplary embodiment of a seat with supports in a stowed position;

FIG. 40 is a perspective view of an exemplary embodiment of a stabilizer;

FIG. 41 is a side view of an exemplary embodiment of a stabilizer;

FIG. 42 is a rear-side perspective view of an exemplary embodiment of a wheelbarrow having multiple auxiliary storage devices and stabilizers;

FIG. 43 is a rear view of an exemplary embodiment of a wheelbarrow having multiple auxiliary storage devices and stabilizers;

FIG. 44 is a perspective view of an exemplary embodiment of a stabilizer;

FIG. 45 is a side view of an exemplary embodiment of a stabilizer;

FIG. 46 is a front-side perspective view of an exemplary embodiment of a wheelbarrow having multiple auxiliary storage devices and stabilizers;

FIG. 47 is a side view of an exemplary embodiment of a wheelbarrow having multiple auxiliary storage devices and stabilizers;

FIG. 48 is a perspective view of an exemplary embodiment of a stabilizer;

FIG. 49 is a side view of an exemplary embodiment of a stabilizer;

FIG. 50 is a rear-side perspective view of an exemplary embodiment of a wheelbarrow having multiple auxiliary storage devices and stabilizers;

FIG. 51 is a rear view of an exemplary embodiment of a wheelbarrow having multiple auxiliary storage devices and stabilizers;

FIG. 52 is a rear-side perspective view of an exemplary embodiment of a wheelbarrow having multiple auxiliary storage devices and support struts;

FIG. 53 is a side view of an exemplary embodiment of a wheelbarrow having multiple auxiliary storage devices and support struts in a tipping position;

FIG. 54 is a rear-side perspective view of an exemplary embodiment of a wheelbarrow having multiple auxiliary storage devices and wall extender;

FIG. 55 is a side view of an exemplary embodiment of a wheelbarrow having multiple auxiliary storage devices and wall extender;

FIG. 56 is a side view of an exemplary embodiment of a wheelbarrow having multiple auxiliary storage devices and wall extenders;

FIG. 57 is a rear-side perspective view of an exemplary embodiment of a wheelbarrow having multiple auxiliary storage devices and extendable wall extender;

FIG. 58 is a rear-side perspective view of an exemplary embodiment of a wheelbarrow having multiple auxiliary storage devices and power system;

FIG. 59 is a side view of an exemplary embodiment of a storage bin with power unit;

FIG. 60 is a top view of an exemplary embodiment of a storage bin with power unit;

FIG. 61 is a rear-side perspective view of an exemplary embodiment of a wheelbarrow having multiple auxiliary storage devices and tool battery charger;

FIG. 62 is a rear-side perspective view of an exemplary embodiment of a wheelbarrow having multiple auxiliary storage devices and tool battery charger;

FIG. 63 is a rear view of an exemplary embodiment of a storage bin with power unit and tool battery chargers;

FIG. 64 is a rear-side perspective view of an exemplary embodiment of a storage bin with power unit and tool battery chargers;

FIG. 65 is a rear-side perspective view of an exemplary embodiment of a wheelbarrow having multiple auxiliary storage devices and accessory bin;

FIG. 66 is a top view of an exemplary embodiment of a storage bin with power unit and accessory bin;

FIG. 67 is a side view of an exemplary embodiment of a storage bin with power unit and accessory bin;

FIG. 68 is a top view of an exemplary embodiment of a wheelbarrow having multiple auxiliary storage devices and power system;

FIG. 69 is a rear-side perspective view of an exemplary embodiment of a storage bin with power system;

FIG. 70 is a rear cross-section view of an exemplary embodiment of a storage bin with power system;

FIG. 71 is a rear-side perspective view of an exemplary embodiment of a storage bin with power system;

FIG. 72 is a rear-side perspective view of an exemplary embodiment of a storage bin with power system;

FIG. 73 is a rear-side perspective view of an exemplary embodiment of a wheelbarrow having multiple auxiliary storage devices and secondary storage bin;

FIG. 74 is a rear-side perspective view of an exemplary embodiment of a wheelbarrow having multiple auxiliary storage devices and storage bin cupholder;

FIG. 75 is a top view of an exemplary embodiment of a wheelbarrow having multiple auxiliary storage devices and storage bin cupholder;

FIG. 76 is a side cross-section view of an exemplary embodiment of a wheelbarrow having multiple auxiliary storage devices and storage bin cupholder;

FIG. 77 is a rear cross-section view of an exemplary embodiment of a storage bin cupholder;

FIG. 78 is a side cross-section view of an exemplary embodiment of a wheelbarrow having multiple auxiliary storage devices and storage bin cupholder in a tipping position;

FIG. 79 is a rear-side perspective view of an exemplary embodiment of a wheelbarrow having multiple auxiliary storage devices and attachment holders;

FIG. 80 is a perspective view of an exemplary embodiment of a locking tab and attachment holder;

FIG. 81 is a perspective view of an exemplary embodiment of a locking tab and attachment holder;

FIG. 82 is a perspective view of an exemplary embodiment of a locking tab and attachment holder;

FIG. 83 is a perspective view of an exemplary embodiment of a locking tab and attachment holder;

FIG. 84 is a rear-side perspective view of an exemplary embodiment of a wheelbarrow having multiple auxiliary storage devices and accessory holder;

FIG. 85 is a perspective exploded view of an exemplary embodiment of an accessory holder and accessory;

FIG. 86 is a perspective front view of an exemplary embodiment of an accessory holder and accessory;

FIG. 87 is a perspective rear view of an exemplary embodiment of an accessory holder;

FIG. 88 is a perspective front view of an exemplary embodiment of an accessory holder and accessory;

FIG. 89 is a rear-side perspective view of an exemplary embodiment of a wheelbarrow having multiple auxiliary storage devices and accessory holder;

FIG. 90 is a rear-side perspective view of an exemplary embodiment of a wheelbarrow having multiple auxiliary storage devices and accessory holders with tubes;

FIG. 91 is a perspective view of an exemplary embodiment of an accessory holder and tube;

FIG. 92 is a rear-side perspective view of an exemplary embodiment of a wheelbarrow having multiple auxiliary storage devices and accessory holders with a tube and counterweights;

FIG. 93 is a perspective cutout view of an exemplary embodiment of an accessory holder and counterweight;

FIG. 94 is a front-side perspective view of an exemplary embodiment of a wheelbarrow having multiple auxiliary storage devices and accessory wheels;

FIG. 95 is a rear-side perspective view of an exemplary embodiment of a wheelbarrow having multiple auxiliary storage devices;

FIG. 96 is a rear-side perspective view of an exemplary embodiment of a wheelbarrow having multiple auxiliary storage devices;

FIG. 97 is a rear-side perspective view of an exemplary embodiment of a wheelbarrow having multiple auxiliary storage devices.

### DESCRIPTION OF EMBODIMENTS

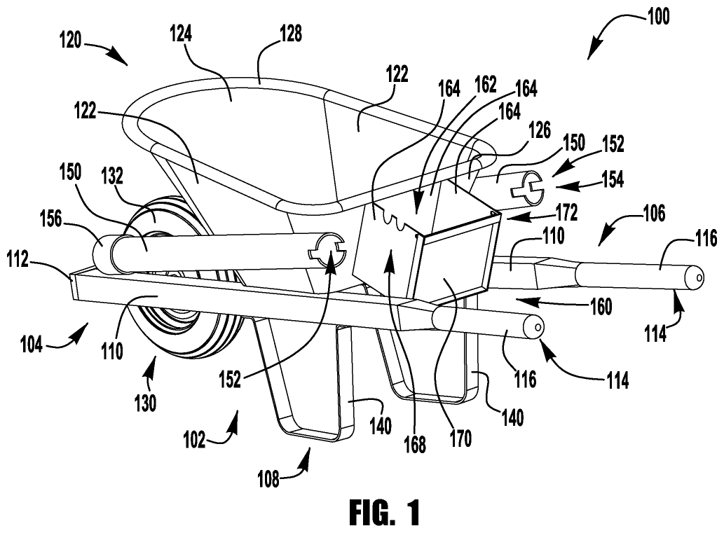

FIG. 1 illustrates a rear-side perspective view of one exemplary embodiment of a wheelbarrow 100 having multiple modular attachments, including, for example, auxiliary storage devices. Exemplary wheelbarrow 100 includes a frame assembly 102 including a front extension 104, a rear extension 106, and a base extension 108. The frame assembly 102 may be constructed from various materials, including, for example, plastic, wood, metal, and combinations thereof.

In this embodiment, the frame assembly 102 includes two side members 110. The side members 110 may form portions of the front extension 104, the rear extension 106, and the base extension 108. As shown in this embodiment, the side members 110 form a portion of the front extension 104, which also includes a front cross member 112. Also shown in this embodiment, the side members 110 form a portion of the rear extension 106 with handles 114. The handles 114 may include grips 116 to increase friction and/or improve comfort when the handles 114 are grasped by a user. The grips 116 may be constructed from various materials, including, for example, rubber, foam, tape, etc.

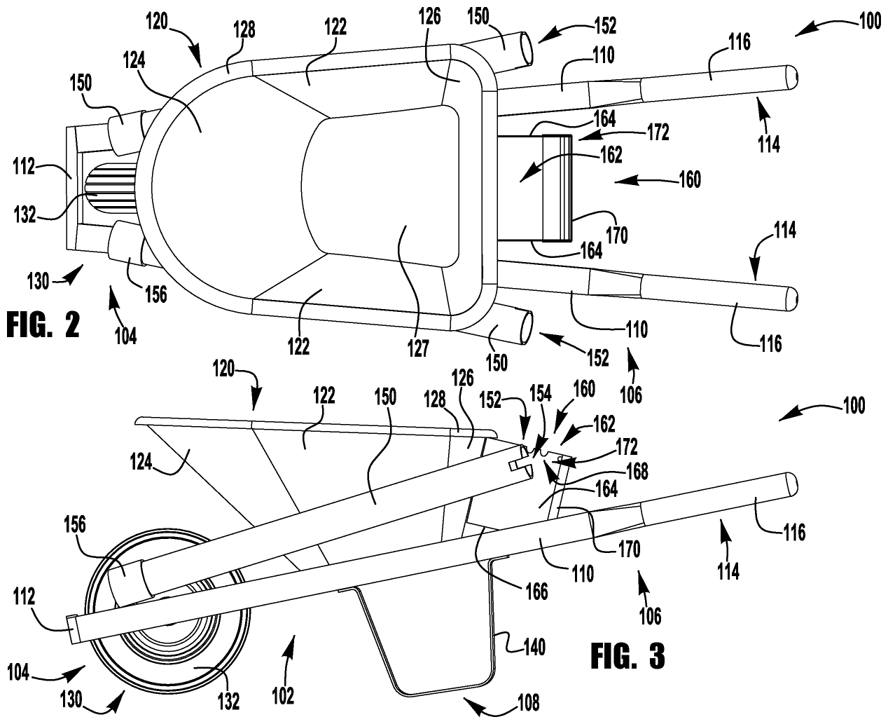

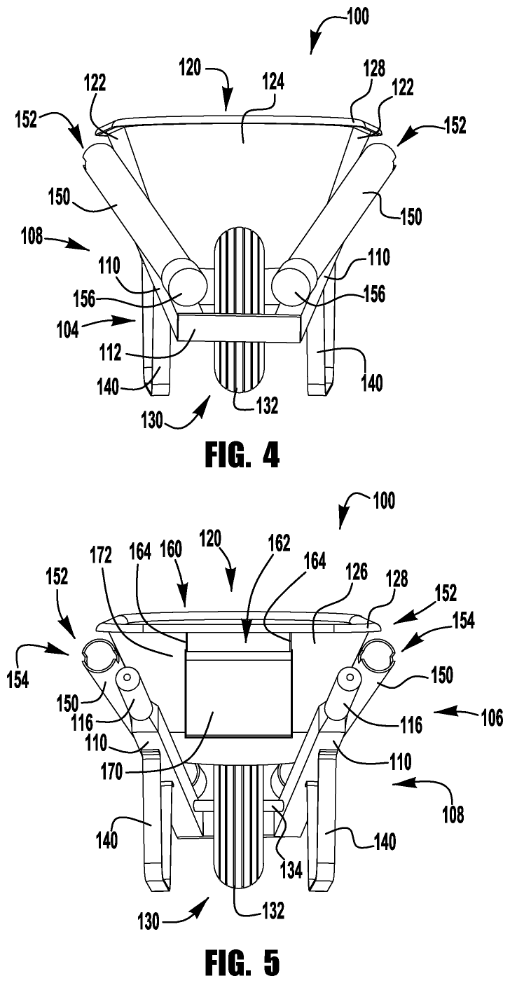

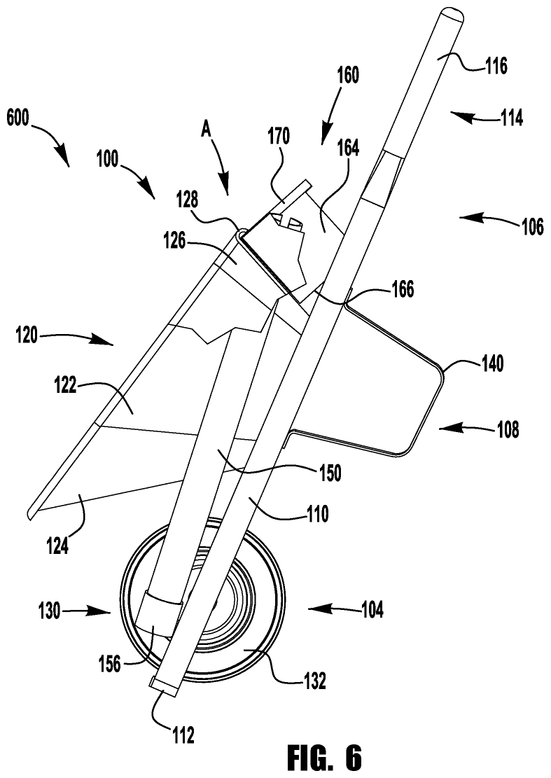

FIGS. 2-5 show various other views of the wheelbarrow 100, including a top view (FIG. 2), a side view (FIG. 3), a front view (FIG. 4), and a rear view (FIG. 5).

With continued reference to FIG. 1 and further reference to FIG. 2, the wheelbarrow 100 also includes a tub 120 mounted to the frame assembly 102. In one embodiment, the tub 120 may be mounted to the side members 110 of the frame assembly 102. In another embodiment, the tub 102 may be mounted to cross members (not shown) mounted between the side members 110 of the frame assembly 102. In this embodiment, the tub 120 includes two side walls 122, a front wall 124, a rear wall 126, and a bottom wall 127. The tub 120 also includes a rim 128 around a top perimeter of the tub 120. In one embodiment, the rim 128 is a molded or rolled edge. As shown in this embodiment, the rim 128 may be curved and form an arc along a tight radius extending outward approximately 180 degrees from the top perimeter of the tub 120 walls. The tub 120 may be constructed from various materials, including, for example, plastic, metal, etc. The tub 120 may be formed as one piece or may be assembled from multiple pieces to create the side walls 122, front wall 124, rear wall 126, bottom wall 127, and rim 128. The tub 120 may also include various coatings.

The wheelbarrow 100 also includes a wheel assembly 130 mounted to the front extension 104 of the frame assembly 102. In one embodiment, the wheel assembly 130 includes one wheel 132. In other embodiments, the wheel assembly 130 may include more than one wheel. With additional reference to FIG. 5, the wheel assembly 130 includes a wheel axle 134 for mounting the wheel 132 to the front extension 104 of the frame assembly 102, such that the wheel 132 rotates about the wheel axle 134. The wheel 132 may include a separate tire and rim or may be one piece. The wheel 132 may be constructed from various materials, including, for example, rubber, plastic, etc. The wheel assembly 130 may also include other components, such as, for example, a wheel hub, a wheel bearing, etc., suitable for allowing the wheelbarrow 100 to roll in a preferably stable and smooth manner

With additional reference to FIG. 3, the base extension 108 of the frame assembly 102 includes leg supports 140 mounted to the side members 110 of the frame assembly 102. In this embodiment, the leg supports 140 are “U” shaped such that the bottom of the “U” can support the wheelbarrow 100 on the ground. In other embodiments, the leg supports may be any shape and configuration suitable for supporting the wheelbarrow 100, including, for example, straight supports. The leg supports 140 may be constructed from various materials, including, for example, plastic, wood, metal, and combinations thereof.

In one exemplary embodiment, the side members 110 have a square or rectangular cross section where the tub 120, the wheel assembly 130, and the leg supports 140 are mounted to the side members 110 and a round or elliptical cross section where the side members 110 are formed into the handles 114.

The wheelbarrow 100 is configured such that the tub 120 is supported by the wheel assembly 130 and the leg supports 140 of the base extension 108 when the wheelbarrow 100 is at rest. When the wheelbarrow 100 is in motion, the tub 120 is supported by the wheel assembly 130, as the wheel 132 rolls along the ground, and a user as the user lifts the handles 114 of the rear extension 106, which lifts the leg supports 140 off of the ground and allows the wheel 132 to rotate to move the wheelbarrow 100 at the direction of the user.

Other exemplary embodiments of the wheelbarrow 100 may include various other components, configurations of components, shapes of components, and component materials for the wheelbarrow 100. The wheelbarrow 100 also includes various mounting members, which may include, for example, brackets, hardware (e.g., nuts, bolts, screws, washers, etc.), spacers, adhesives, etc., necessary to assemble the various components mentioned above.

The wheelbarrow 100 can also include one or more modular attachments, including, for example, auxiliary storage devices, transport/stability pins, lids/covers, seats, stabilizers/struts, other storage/support devices, auxiliary power (outlets, charges, etc.), batteries, cupholders, tub extensions/baskets, device holders, attachment holders, counterweights, stabilizer wheels, quick connection/release mechanisms, etc. In various embodiments, one or more modular attachments or devices can be selectively added or attached to the wheelbarrow 100 as needed. In some embodiments, the modular attachments or devices can be included with the wheelbarrow from the onset. In other embodiments, modular attachments can be added to the wheelbarrow later.

In the exemplary embodiments shown in FIGS. 1-6, the wheelbarrow 100 includes auxiliary storage devices as exemplary modular attachments: two exemplary tubes 150 and an exemplary storage bin 160 for storing various items and materials associated with the wheelbarrow 100 or a project, as described in more detail below.

One or more tubes 150 may be affixed to the frame assembly 102, the tub 120, and/or another portion of the wheelbarrow 100. In one embodiment, as shown, two tubes 150 are each affixed to the side members 110 of the frame assembly 102 and the side walls 122 of the tub 120. In particular, with further reference to FIGS. 3-4, each of the tubes 150 is affixed to a top side of one of the side members 110 near a front end of the tube 150 and is affixed to the outer surface of one of the side walls 122 near a rear end of the tube 150. The tubes 150 may be affixed to the frame assembly 102, the tub 120, and/or another portion of the wheelbarrow 100 using one or more mounting members, which may include, for example, various brackets, hardware (e.g., nuts, bolts, screws, washers, etc.), spacers, adhesives, etc., necessary to affix or mount the tubes 150.

The tubes 150 each have at least one open end 152 at the rear end of the tube 150. As described in more detail below, the open end 152 of the tube 150 can accept various elongated items, such as, for example, tools with elongated handles (e.g., rakes and shovels), and thin pieces of wood, metal, etc. to allow for storage of the item on the wheelbarrow 100. The open end 152 of the tube 150 may also include one or more notches 154 around the perimeter of the open end 152. These notches 154 may be used to engage a feature on the end of the stowed item, such as, for example, the tine of a rake or the spade of a shovel, to prevent the item from moving or rotating within the tube 150. The notches 154 may be oriented in various configurations, including, for example, an opposing pair of notches 154 (e.g., approximately 180 degrees around the perimeter of the open end 152 of the tube 150) in a horizontal orientation, an opposing pair of notches 154 in a vertical orientation, combinations thereof, etc. Different embodiments can include a tube 150 with various combinations of notch 154 sizes and configurations, including, for example, multiple pairs of same and/or different sized notches 154 distributed around the perimeter of the open end 152 of the tube 150 using a variety of spacing patterns.

The other end of the tubes 150 at the front end may also include an open end or may be closed. As shown, the tubes 150 each have a closed end at the front end of the tube 150. The closed end may be formed with the tube 150 or may be closed with a cap 156. In some embodiments, the cap 156 may be perforated or otherwise vented.

In some situations, it may be advantageous to have the tube 150 open or capped but perforated/vented to allow for cleaning, drainage, airflow, etc. In other situations, it may advantageous to have the tube 150 closed or capped to prevent items from sliding out of the tube 150. For example, materials without features that would prevent them from passing through the open end 152 of the tube 150, such as pipes, lengths of wood, pieces of rebar, etc., can be stored in the tube 150 without falling out if the front end of the tube 150 is closed. In some embodiments, the cap 156 may be removable so that the tube 150 can selectively function as a closed tube and an open tube. In other embodiments, the cap 156 may also be used to close the rear open end 152 of the tube 150.

The tubes 150 may be cylindrically shaped as shown. However, in other embodiments, the tubes 150 may have elliptical, square, rectangular, or any other shaped cross-section. In other embodiments, the cross-section shape may vary from one end of the tube 150 to the other end. For example, the tube 150 may narrow, taper, and/or step at some point over the length of the tube 150. This may be advantageous, for example, in situations where items with different lengths and/or other features are stored in the same tube 150 and changes in the tube 150 geometry prevent and/or allow different items to slide into the tube 150 more or less. In other embodiments, the tubes 150 may include various dividers (not shown) to compartmentalize the tubes 150 into different areas. For example, in various embodiments, these dividers may be along the length of the tube 150 or may be only at the open end 152.

The tubes 150 and caps 156 may be constructed from various materials, including, for example, plastic, metal, etc. In other embodiments, the tubes 150 and/or caps 156 may be constructed from different materials. In yet other embodiments, one or more tubes 150 may be integrated or formed with the tub 120 as a one-piece assembly. For example, the tub 120 and one or more tubes 150 may be molded as one plastic part.

As shown in this exemplary embodiment, the tubes 150, notches 152, and caps 156 have the same size, configuration, mounted location (opposite side), etc. In other embodiments, any combination of tubes 150, notches 152, and caps 156 with various sizes (e.g., diameters, lengths, tapers, etc.), configurations (e.g., open, closed, capped, etc.), locations (affixing points, pitch angles, etc.), materials, can be utilized in one or more wheelbarrows 100. Utilization of different tubes 150 on the same wheelbarrow 100 may be advantageous to accommodate storing a variety of items on one wheelbarrow 100.

One or more storage bins 160 may also or alternatively be affixed to the frame assembly 102, the tub 120, and/or another portion of the wheelbarrow 100. In one embodiment, as shown, a storage bin 160 is affixed to the rear wall 126 of the tub 120. In particular, with further reference to FIG. 3 and FIG. 6, the storage bin 160 is affixed to the outer surface of the rear wall 126 towards the rear of the wheelbarrow 100 between the side members 110. In other embodiments, the storage bin 160 may be affixed to the frame assembly 102, including, for example, the side members 110 in addition to or without affixing to the tub 120. In yet other embodiments, the storage bin 160 may be affixed to a cross member of the frame assembly 102 mounted between the side members 110 in addition to or without affixing to the tub 120. The storage bin 160 may be affixed to the frame assembly 102, the tub 120, and/or another portion of the wheelbarrow 100 using one or more mounting members, which may include, for example, various brackets, hardware (e.g., nuts, bolts, screws, washers, etc.), spacers, adhesives, etc., necessary to affix or mount the storage bin 160.

The storage bin 160 has an open area (e.g., top or side) and various surfaces to form a storage volume capable of storing various items. As shown in this embodiment, the storage bin 160 includes an open top 162, side surfaces 164, and a bottom surface 166. In one embodiment, the outer surface of the rear wall 126 of the tub 120 acts as a side surface 164 of the storage bin 160. In other embodiments, where the storage bin 160 is affixed to the tub 120 in other locations, other walls of the tub 120 may act as surfaces of the storage bin 160. As described in more detail below, the open top 162 of the storage bin 160 can accept a variety of items to allow for storage of the items on the wheelbarrow 100. The open top 162 of the storage bin 160 may also include one or notches 168 around the perimeter of the open top 162 (i.e., along the top of the side surfaces 164). These notches 168 may be used to engage a feature of a stored item to hang or attach the item to the side surface 164 of the storage bin 160, including inside or outside of the storage bin 160. The notches 168 may be oriented in various configurations and be of various shapes and sizes.

The bottom surface 166 of the storage bin 160 may have holes (not shown). In some situations, it may be advantageous to have holes for engaging features of stored items and/or to allow for cleaning, drainage, airflow, etc. In some embodiments, the holes may be selectively plugged or capped.

The storage bin 160 may be box shaped (with a rectangular cross section) as shown. However, in other embodiments, the storage bin 160 may have circular, elliptical, square, or any other shaped cross-section. In other embodiments, the cross-section shape may vary from one end of the storage bin 160 to the other end. For example, the storage bin 160 may narrow, taper, or step at some point over the height of the storage bin 160. This may be advantageous, for example, in situations where items with different sizes and/or other features are stored in the same storage bin 160 and changes in the storage bin 160 geometry prevent and/or allow different items to fit into the storage bin 160 more or less. In other embodiments, the storage bin 160 may include various dividers (not shown) to compartmentalize the storage bin 160 into different areas. For example, in various embodiments, these dividers may be the full height of the storage bin 160 or may be only at the bottom.

The storage bin 160 may be constructed from various materials, including, for example, wood, plastic, metal, etc. In yet other embodiments, one or more storage bins 160 may be integrated or formed with the tub 120 as a one-piece assembly. For example, the tub 120 and one or more storage bins 160 may be molded as one plastic part.

As shown in this embodiment, the storage bin 160 may also include a lid 170. The lid 170 can cover the open area (e.g., top or side) of the storage bin 160. The lid 170 may be attached to the storage bin 160 or selectively removable. In other embodiments, the lid 170 may be hinged to a surface of the storage bin 160. In some embodiments, the lid 170 includes a locking mechanism 172 for locking the lid 170 in an open and/or a closed position. In yet another embodiment, the locking mechanism 172 includes a pivotable portion and a slidable portion such that the lid 170 can slide under the rim 128 of the tub 120 when the lid 170 is closed on top of the storage bin 160.

FIG. 6 is a side view of one exemplary embodiment of the wheelbarrow 100 in a tipping position 600. In this embodiment, the storage bin 160 includes the lid 170 and the locking mechanism 172 for locking the lid 170 in the closed position while the wheelbarrow 100 is tipped forward, for example, to dump materials from the tub 120. FIG. 6 includes a cut-out section A showing a top surface of the lid 170 locked under the rim 128 of the tub 120 to prevent the lid 170 from opening while the wheelbarrow 100 is tipped forward.

In some embodiments, the wheelbarrow 100 may include more than one storage bin 160. The storage bins 160 may have the same size, configuration, mounted location (e.g., opposite sides), etc. In other embodiments, any combination of storage bins 160 with various sizes (e.g., heights, widths, lengths, diameters, tapers, etc.), configurations (e.g., top open, side open, notched, holed, etc.), locations (affixing points, etc.), materials, can be utilized in one or more wheelbarrows 100. Utilization of different storage bins 160 on the same wheelbarrow 100 may be advantageous to accommodate storing a variety of items on one wheelbarrow 100.

In some embodiments, the mounting members used to affix the tubes 150 and/or the storage bins 160 to the frame assembly 102, the tub 120, and/or another portion of the wheelbarrow 100 may be the same mounting members used to assemble the various components of the wheelbarrow 100 mentioned above. In other words, the mounting members may be shared or multi-purposed, such that the mounting members perform more than function.

In some embodiments, one or more auxiliary storage devices (e.g., tubes 150 and/or storage bins 160) may be mounted to the wheelbarrow 100 during or after assembly of the wheelbarrow 100. For example, the wheelbarrow 100 may be originally built with tubes 150 and/or storage bins 160 or the tubes 150 and/or the storage bins 160 may be affixed to the wheelbarrow 100 after assembly of the wheelbarrow 100. For example, in one embodiment, one or more modular attachments (e.g., tubes 150 and/or storage bins 160) may be included in a kit to add functionality or additional capabilities to an existing wheelbarrow that did not originally include the modular attachments or devices. The attachment kit may include one or more mounting members, which may include, for example, various brackets, hardware (e.g., nuts, bolts, screws, washers, etc.), spacers, adhesives, etc., necessary to affix or mount the modular attachments or devices (e.g., tubes 150 and/or storage bins 160) to the wheelbarrow 100.

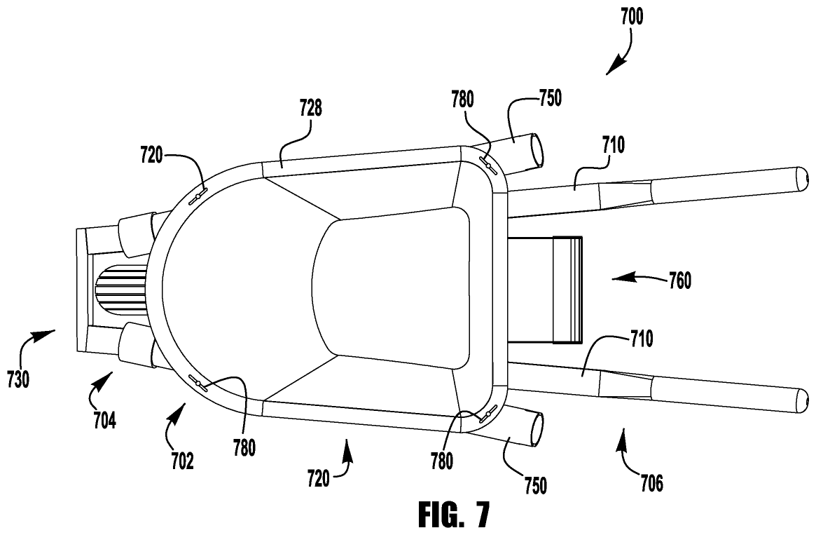

FIGS. 7-11 illustrate exemplary embodiments of a wheelbarrow with transport pins for stabilizing materials transported by a wheelbarrow 700. FIG. 7 illustrates a top view of an embodiment of a wheelbarrow 700, which includes a frame assembly 702 (including a front extension 704, a rear extension 706, side members 710, and a base extension (not shown)), a wheel assembly 730 mounted to the front extension 704 of the frame assembly 702, and a tub 720 mounted to the frame assembly 702. In this embodiment, the tub 720 includes a rim 728 around a top perimeter of the tub 720. In one embodiment, the rim 728 is a molded or rolled edge.

The wheelbarrow 700 may also include one or more auxiliary or modular attachments or devices. As shown, the wheelbarrow 700 includes two exemplary tubes 750 and an exemplary storage bin 760 for storing various items and materials associated with the wheelbarrow 700 or a project, as described in more detail above.

The features of the wheelbarrow 700 may be the same and/or similar to the corresponding features, for example, 102, 104, 106, 108, 120, 128, 130, 150, 160, of the exemplary wheelbarrow 100 described above, including any associated other components, configurations of components, shapes of components, and component materials for the wheelbarrow 100, 700. The wheelbarrow 700 also includes various mounting members, which may include, for example, brackets, hardware (e.g., nuts, bolts, screws, washers, etc.), spacers, adhesives, etc., necessary to assemble the various components mentioned above.

Wheelbarrow 700 also includes four transport pins 780 installed in exemplary locations around the rim 728 of the tub 720 and generally extending vertically above the rim 728 surface. The transport pins 780 may be selectively attached to and/or installed into the wheelbarrow 700 and utilized to stabilize items transported by the wheelbarrow 700. For example, items that may be too long to fit inside of the tub 720 (e.g., lumber, pipes, rebar, tools with long handles, etc.) may be placed across the rim 728 of the wheelbarrow 700 in a side-to-side and/or front-to-back orientation between the transport pins 780. These items can rest against and/or attach to the transport pins 780 during transport, thereby providing additional benefits, including, for example, greater capacity, improved safety, etc.

For example, the transport pins 780 can prevent items too long to fit inside of the tub 720 from moving by resting against the transport pins 780. In another example, various items, including, for example, items too long to fit inside of the tub 720 and/or unstable items inside the tub 720, may be attached or tethered to one or more transport pins 780 for increased stability and to prevent and/or reduce movement of the item(s) during transport. In other embodiments, the transport pins may have one or more bends, eyelets, or loops at their ends, making them more suitable for tethering uses, as discussed in more detail below. It should be appreciated that various transport pin sizes, shapes, variations, configurations, and combinations can be implemented as required to stabilize items transported by the wheelbarrow 700. The transport pins 780 may be constructed from various materials, including, for example, plastic, wood, metal, and combinations thereof.

Increased stability can increase the capacity and/or the safety of the wheelbarrow 700. For example, more materials can be transported safely if the materials are stabilized to prevent them from toppling over or rolling off of the wheelbarrow 700. Also, heavy items within the tub 720 can destabilize the center of gravity of the wheelbarrow 700 if they are allowed to move and/or roll around within the tub 720, potentially causing the wheelbarrow 700 to tip due to imbalance.

Although four transport pins 780 generally located in the four corners of the rim 728 around the tub 720 are shown in FIG. 7, in other embodiments any number of transport pins 780 may be installed in various and optional locations around the rim 728 of the tub 720 and/or at other locations on the wheelbarrow 700. For example, in another embodiment, transport pins may be attached to the side members 710 of the wheelbarrow 700.

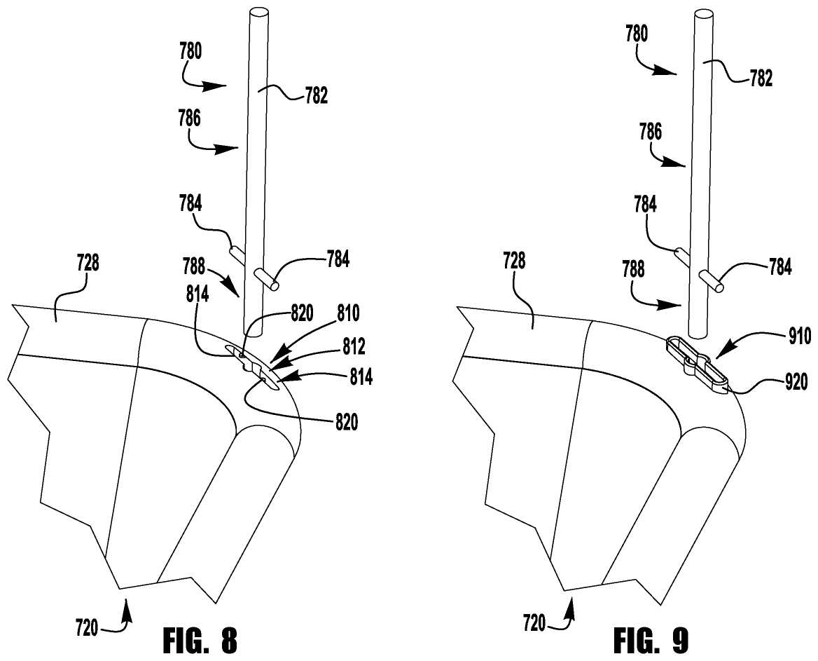

With further reference to FIG. 8, in one exemplary embodiment, the transport pins 780 may include a center shaft 782 and cross-arms 784. The center shaft 782 may act as the primary stability feature of the transport pin 780, while the cross-arms 784 may act as an engagement feature to interface with the rim 728 of the tub 720 and/or other features of the wheelbarrow 700.

For example, in one exemplary embodiment, as shown in FIG. 8, the cross-arms 784 of the transport pin 780 are configured to engage with a recess 810 formed in the rim 728 of the tub 720. The recess 810 is shown with a center portion 812 configured to accept the center shaft 782 of the transport pin 780 and side portions 814 configured to accept the cross-arms 784 of the transport pin 780. The recess 810 is also shown with nubs 820 to create an interference fit between the cross-arms 784 of the transport pin 780 and the recess 810 when the transport pin 780 is installed into the tub 720 to prevent the transport pin 780 from excessive movement within and/or falling out of the recess 810. For example, the transport pin 780 can “snap” into the recess 810 for retention. In other embodiments, various other engagement features (e.g., tabs, notches, etc.) may be associated with the transport pin 780 and/or the recess 810 instead of or in addition to the nubs 820 to retain the transport pin 780 in the recess 810.

The bottom of the center portion 812 of the recess 810 is configured with a hole that allows the center shaft 782 of the transport pin 780 to pass through the rim 728 of the tub 720 as the transport pin 780 is inserted into the tub 720. The bottom of the side portions 814 of the recess 810 are configured with a shape that nests with the cross-arms 784 of the transport pin 780 to stop the transport pin 780 as it is inserted into the tub 720.

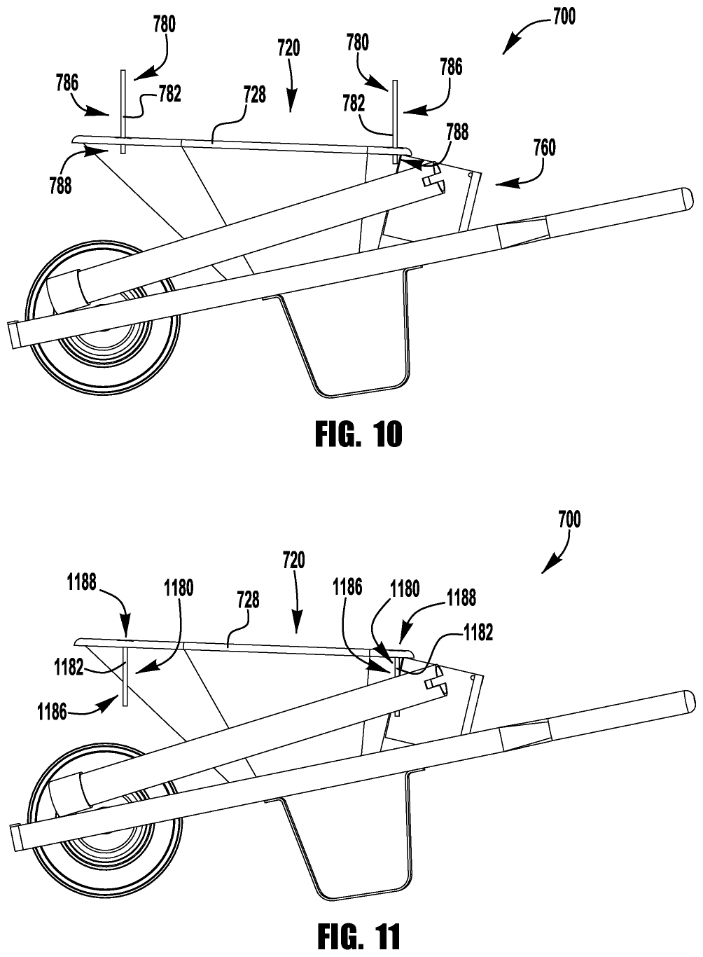

In one exemplary embodiment, the recess 810 may be molded into the rim 728 of the tub 720 when the tub 720 is manufactured. In another embodiment, as shown in FIG. 9, a recess 910 may be added on top of the rim 728 of the tub 720 with a transport pin catch 920. The pin catch 920 may be installed by the tub 720 manufacturer or may be part of a retrofit kit that adds the transport pin 728 feature to an existing wheelbarrow. In this embodiment, the pin catch 920 may be installed to the tub 720 with any suitable attachment means, including, for example, adhesives, brackets, hardware, etc. To allow the transport pin to engage with the pin catch 920, a hole may be created in the rim 728 of the tub 720 at the center portion of the pin catch 920 to allow the center shaft 782 of the transport pin 780 to pass through the rim 728 of the tub 720 as the transport pin 780 is inserted into the tub 720. The cross-arms 784 of the transport pin 780 will stop against the rim 728 of the tub 720 as the transport pin 780 is inserted into the tub 720. The pin catch 920 may be constructed from various materials, including, for example, plastic, wood, metal, and combinations thereof.

It should be appreciated that various other engagement features may be included in the transport pins 780 and the rim 728 of the tub 720 and/or other features of the wheelbarrow 700 to attach and/or install one or more transport pins 780 into the wheelbarrow 700.

FIG. 10 illustrates a side view of an exemplary embodiment of wheelbarrow 700 with transport pins 780 installed into the tub 720 of the wheelbarrow 700 with the center shafts 782 of the transport pins 780 passing through the rim 728 of the tub 720. In this manner, a top portion 786 of the center shaft 782 extends generally vertically above the rim 728 of the tub 720 and a bottom portion 788 of the center shaft 782 extends generally vertically below the rim 728 of the tub 720. When not installed in the tub 720 of the wheelbarrow 700, the transport pins 780 may be stored elsewhere, including, for example, in the storage bin 760 of the wheelbarrow, in holes in the side members 710 of the wheelbarrow 700, etc. In some embodiments, the storage bin 760 may include various holes (not shown) for accepting a feature of the transport pins 780 during storage. In yet other embodiments the transport pins 780 may include a magnetic material, allowing them to be stored against a ferromagnetic material, or vice versa.

In another exemplary embodiment, as shown in FIG. 11, transport pins 1180 are shown in a storage position in the recess 810 (not shown) of the rim 728 of the tub 720. In this embodiment, a center shaft 1182 of the transport pins 1180 includes a top portion 1186 and a bottom portion 1188. In the transport position (not shown), the top portion 1186 extends generally vertically above the rim 728 of the tub 720 and the bottom portion 1188 extends generally vertically down into the hole of the recess 810. For the storage position, as shown in FIG. 11, this embodiment allows the transport pins 1180 to be stored upside down in the recess 810, engaged in a manner similar to the transport position. However, in this embodiment, the length of the bottom portion 1188 of the center shaft 1182 of the transport pins 1180 is such that, when stored upside down in the recess 810, the bottom portion 1188 of the center shaft 1182 does not extend above the surface of the rim 728 of the tub 720. I.e., the stored transport pins 1180 are flush with or below the surface of the rim 728, thereby allowing unencumbered use of the wheelbarrow 700 when the transport pins 1180 are not needed and stored in the recess 810.

In other exemplary embodiments, various caps or covers may be installed over and/or within recesses 810, 910 when the transport pins 780, 1180 are not in use (including when the transport pins are stored in the storage bin 760 or in the recesses 810, 910), to prevent debris and/or other materials from collecting in the recesses 810, 910 and obstructing their use.

In yet other exemplary embodiments, multiple and various sizes, shapes, and configurations of transport pins 780, 1180 may be used together or individually. For example, various transport pins 780, 1180 may have center shafts 782, 1182 with different top portion 786, 1186 lengths suitable for different and various uses. In one embodiment, transport pins 780, 1180 with longer top portion 786, 1186 lengths may be used at the front of the wheelbarrow 700 to support or stabilize one type of item while transport pins 780, 1180 with shorter top portion 786, 1186 lengths may be used at the rear of the wheelbarrow 700 to support or stabilize another type of item.

Wheelbarrow 700 may include a transport pin kit that includes various sizes, shapes, and configurations of transport pins. For example, the transport pin kit may include various transport pins with different top portion straight lengths and various transport pins with bends, eyelets, and/or loops, making them more suitable for tethering uses.

In operation, the tub of a wheelbarrow is commonly used to transport loose materials. However, the loose materials are typically associated with a project that also requires various other items and/or materials, including, for example, tools, gloves, hardware, etc. For example, the tub of a wheelbarrow may be used to transport soil, gravel, mulch, etc. associated with a landscaping project. Other materials, such as, for example, a rake, a shovel, gloves, a hand spade, a bag of grass seed, etc. may also be required. Ordinarily, a user would have to make multiple trips from where the other items and materials are located to the project area or try to load the other materials onto the wheelbarrow. It can be difficult, awkward, and even dangerous to try to balance the wheelbarrow with these other items and materials. For example, if tools like a shovel and/or a rake are draped over the top of the loose materials in the tub, they may not lay flat or may tend to roll off of the wheelbarrow. It may be difficult for the user to balance these tools as the wheelbarrow rolls, especially over uneven terrain. It can be dangerous for the user to try to maneuver the wheelbarrow to stop the tools from rolling off of the wheelbarrow. The user may inadvertently dump the loose materials out of the tub in an area that is not the project area by losing control of the wheelbarrow or by running into or over a fallen tool.

A wheelbarrow 100, 700 with one or more auxiliary storage devices (e.g., tubes 150 and/or storage bins 160) and/or transport pins (e.g., transport pins 780, 1180) allows a user to store additional items and materials in the auxiliary storage devices of the wheelbarrow 100, 700 and/or on the wheelbarrow 100, 700. In the example above, the rake and the shovel may be stored in one or more tubes 150 and/or supported by transport pins 780, 1180. The long handles of the rake and shovel can be laid across the tub and supported by the transport pins 780, 1180 and/or slipped into the open end 152 of the tube 150 until the tine or spade end of the tool stops against the perimeter of the open end 152 or the tool handle stops against the closed end of the tube 150. Where the tine or spade end meets the open end 152, the notches 154 can engage these features of the tool to prevent the tool from moving or rotating within the tube 150. The gloves, hand spade, and bag of grass seed may be stored in one or more storage bins 160. A lid 170 on the top of the storage bin 160 can be locked into a closed position to prevent these items from falling out of the wheelbarrow 100, even as the wheelbarrow 100 is tipped forward to dump the loose materials from the tub 120 (see FIG. 6).

In another example, the tub 120 of the wheelbarrow can be used to transport cement or gravel, while transport pins 780, 1180 and/or one or more tubes 150 can be used to stabilize and/or store framing boards, rebar, rakes, and shovels, and the storage bin 160 can store papers with a drawn layout, wooden/metal stakes, a hammer, a tool belt with a measuring tape and a chalk line, a sculpting/finishing trowel, safety goggles, and nails for the framing boards. As can be appreciated, the situations where the transport pins and/or auxiliary storage devices of the wheelbarrow 100 can be utilized are many.

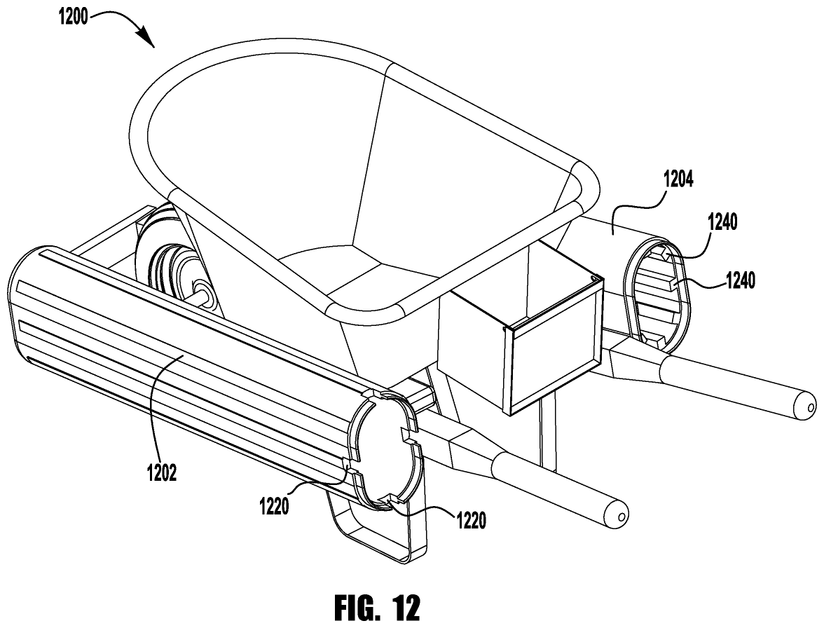

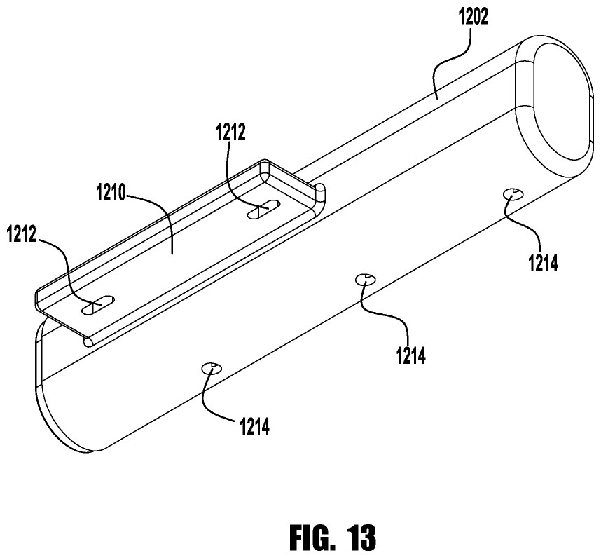

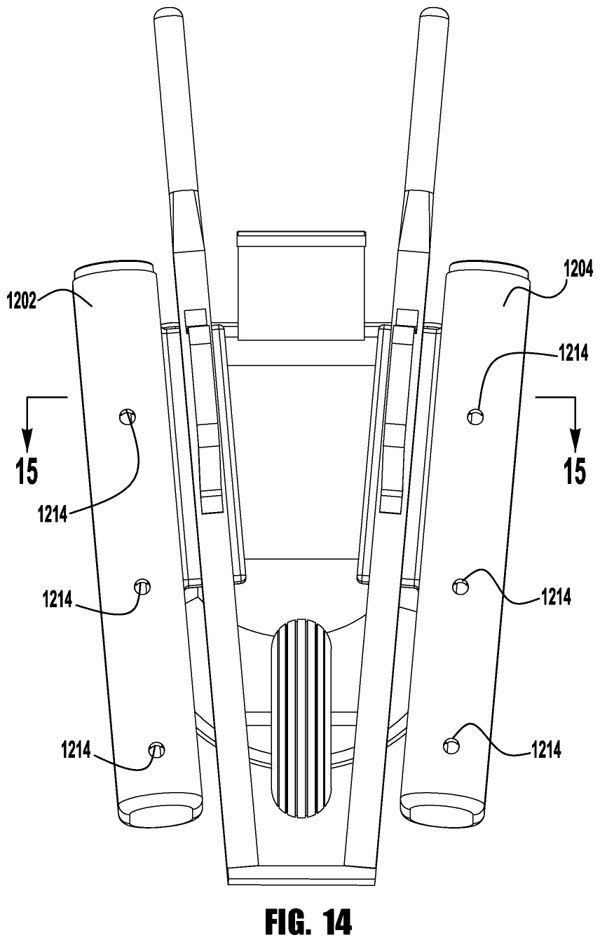

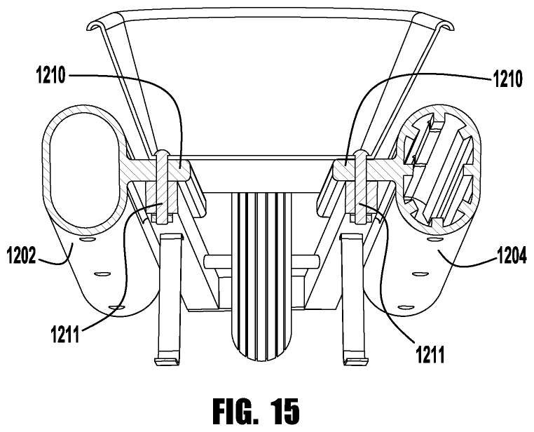

FIG. 12 shows another exemplary embodiment 1200 with tubes attached to a wheelbarrow. In particular, tubes 1202, 1204 may be similar to tubes 150, including materials, attachments, positions/orientations, functions, etc. The tubes 1202, 1204 can be configured as a one-piece design for use as a modular attachment. With additional reference to FIGS. 13-15, tubes 1202, 1204 can be configured as a one-piece modular attachment, including as a one-piece molded design. In this embodiment, the tubes 1202, 1204 have a fin or strut mounting member 1210 attached to one side of the tubes that is used to secure the tube 1202, 1204, for example, between the tub and side members/handles. In one embodiment, the tubes 1202, 1204 can be added to a wheelbarrow by using common (e.g., same or longer) bolts 1211 used to attach the tub to the side members through holes/slots 1212. The strut 1210 can be various shapes and lengths (e.g., flat, wedge, angled, etc.). In various embodiments, the tubes 1202, 1204 can fit both sides of a wheelbarrow by simply flipping it upside down/over.

For example, in one embodiment, the tube 1202, 1204 is a wheelbarrow auxiliary storage device, configured to attach to a frame or a tub of a wheelbarrow, wherein the tube 1202, 1204 is configured to store an item transported by the wheelbarrow and retain the item stored in the tube when the wheelbarrow is in a tipping position (for example, as shown in FIG. 6). The tube 1202, 1204 can include an integrated mounting member 1210 for attaching the tube 1202, 1204 to the frame or the tub of the wheelbarrow. In this manner, a length of the attached tube 1202, 1204 and a length of an elongated item stored in the tube are in a substantially horizontal position when the wheelbarrow is not in a tipping position.

In various exemplary embodiments, the tubes 1202, 1204 can be sealed at one end and/or perforated with holes 1214 along, for example, the length to allow drainage, airflow, etc. The tubes 1202, 1204 can have a number of different shaped notches and/or grooves around the open end and/or along the inside surface for improved retention of tools/equipment.

In one exemplary embodiment, tube 1202 has an end shape with one or more notches 1220 around the perimeter of the open end, similar to notches 154 described above. These notches 1220 may be used to engage a feature on the end of the stowed item, such as, for example, the tine of a rake or the spade of a shovel, to prevent the item from moving or rotating within the tube 1202, as described in detail above.

In another exemplary embodiment, tube 1204 has an inside surface with one or more grooves 1240 around the inside surface. These grooves 1240 may be used to engage a feature along the length of the stowed item, such as, for example, the handle of a rake or a shovel, to prevent the item from moving or rotating within the tube 1204. In some embodiments, these grooves may be tapered, for example, from large to small along the length of the tube 1204.

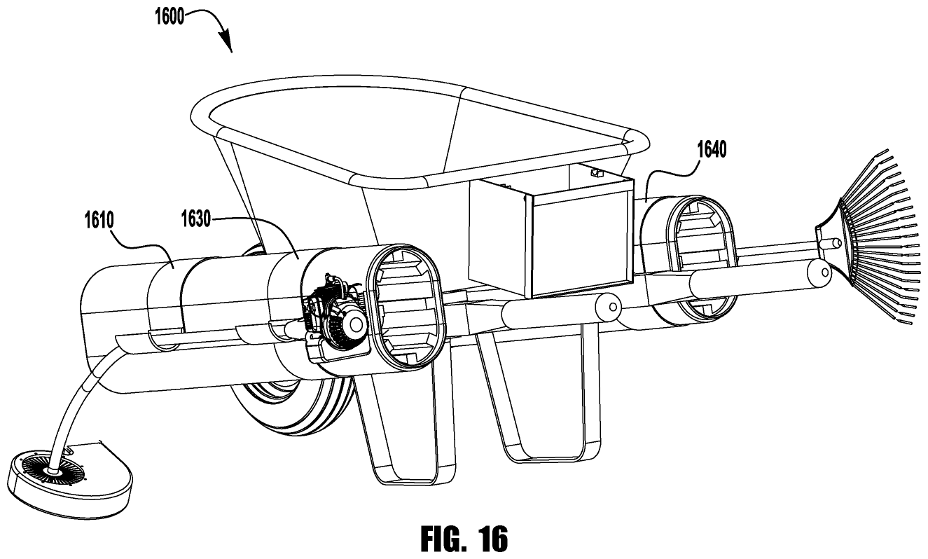

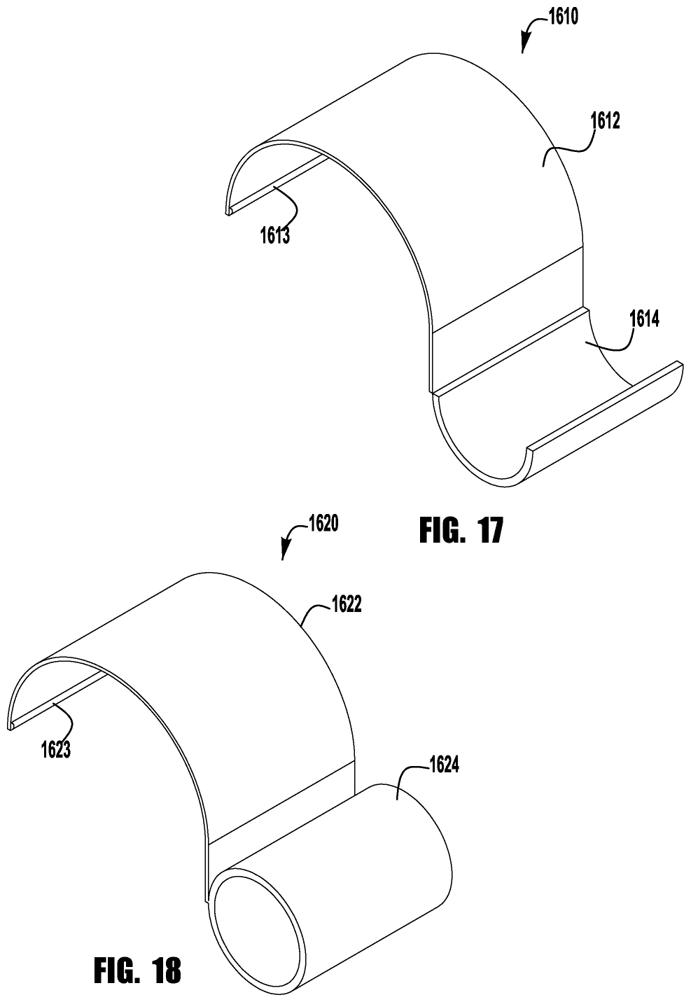

FIG. 16 shows another exemplary embodiment 1600 with extensions/extenders/clips attached to a tube of a wheelbarrow. In particular, with additional reference to FIGS. 17-21, tube extensions 1610, 1620, 1630, 1640 may be attached to tubes of a wheelbarrow to provide additional storage and support for various items, such as, for example, tools and equipment. Other types of extensions can also be utilized to similarly attach to other portions and/or features of the wheelbarrow. The tube extensions 1610, 1620, 1630, 1640 can consist of any suitable material, can be configured as a one-piece design, and/or used as a modular attachment. The storage/transport tube extensions 1610, 1620, 1630, 1640 can hold different sizes and shapes of tools and equipment along the tubes. They can be removeable, interchangeable, and/or used in combination. In various embodiments, one flange portion of the extension can slide over and/or clip onto the tube and another flange portion can be used to store and/or support an item. In some embodiments, there can be multiple retention devices/shapes on each extension and/or there can be multiple extensions on one or more tubes or other portion of the wheelbarrow.

In one exemplary embodiment, with reference to FIG. 17, extension 1610 includes a tube-engagement flange 1612 and a support flange 1614. In this embodiment, the flange 1612 is C-shaped to match the shape of an interfacing tube, such that the extension 1610 attaches to the outer surface of the tube, as shown in FIG. 16. The inner surface is shown with an optional feature, such as rib 1613, to engage with a feature of the tube to aid in retention and prevent rotation of the extension 1610 around the tube. Also in this embodiment, the flange 1614 is C-shaped to accommodate the shape of an item, such as a tool or equipment, as shown in FIG. 16. One or both of flanges 1612, 1614 can be a variety of shapes suitable for various tube shapes, applications, and/or uses. Other extensions can also have various lengths along the tube length.

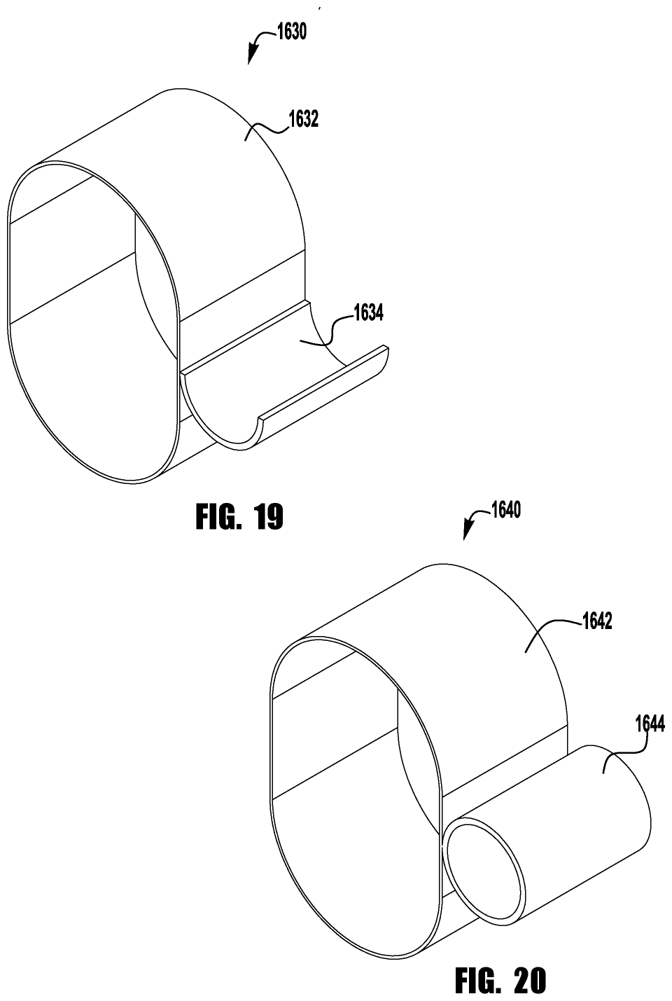

In another exemplary embodiment, with reference to FIG. 18, extension 1620 includes a tube-engagement flange 1622 and a support flange 1624. In this embodiment, the flange 1622 is C-shaped to match the shape of an interfacing tube, such that the extension 1620 attaches to the outer surface of the tube, similar to extension 1610 shown in FIG. 16. The inner surface is shown with an optional feature, such as rib 1623, to engage with a feature of the tube to aid in retention and prevent rotation of the extension 1620 around the tube. Also in this embodiment, the flange 1624 is a closed/circular-shaped to accommodate the shape of an item, such as a tool or equipment, for example, sliding into the flange 1624. One or both of flanges 1622, 1624 can be a variety of shapes suitable for various tube shapes, applications, and/or uses. Other extensions can also have various lengths along the tube length.

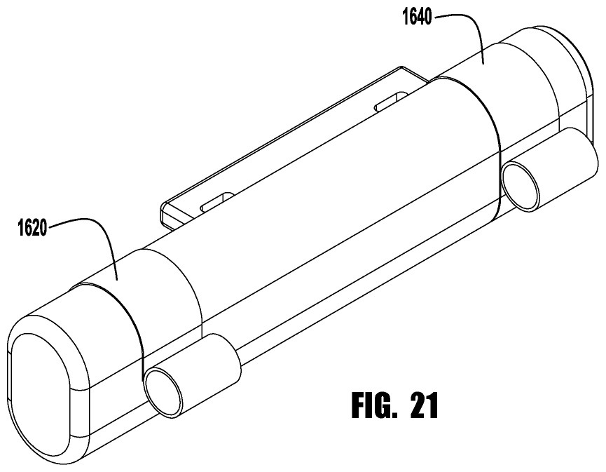

In another exemplary embodiment, with reference to FIG. 19, extension 1630 includes a tube-engagement flange 1632 and a support flange 1634. In this embodiment, the flange 1632 is closed/circular or elliptical-shaped to match the shape of an interfacing tube, such that the extension 1620 slides over the outer surface of the tube from one end. The inner surface may also include an optional rib (not shown) to engage with a feature of the tube to aid in retention and prevent rotation of the extension 1630 around the tube, for example, if the tube has a circular cross-section (e.g., a rib similar to rib 1613, shown in FIG. 17). Also in this embodiment, the flange 1634 is C-shaped to accommodate the shape of an item, such as a tool or equipment, as shown in FIG. 16. One or both of flanges 1632, 1634 can be a variety of shapes suitable for various tube shapes, applications, and/or uses. Other extensions can also have various lengths along the tube length.

In another exemplary embodiment, with reference to FIG. 20, extension 1640 includes a tube-engagement flange 1642 and a support flange 1644. In this embodiment, the flange 1642 is closed/circular or elliptical-shaped to match the shape of an interfacing tube, such that the extension 1640 slides over the outer surface of the tube from one end, as shown in FIG. 16. The inner surface may also include an optional rib (not shown) to engage with a feature of the tube to aid in retention and prevent rotation of the extension 1640 around the tube, for example, if the tube has a circular cross-section (e.g., a rib similar to rib 1623, shown in FIG. 18). Also in this embodiment, the flange 1644 is a closed/circular-shaped to accommodate the shape of an item, such as a tool or equipment, for example, sliding into the flange 1644. One or both of flanges 1642, 1644 can be a variety of shapes suitable for various tube shapes, applications, and/or uses. Other extensions can also have various lengths along the tube length. FIG. 21 shows extensions 1620, 1640 attached to a tube.

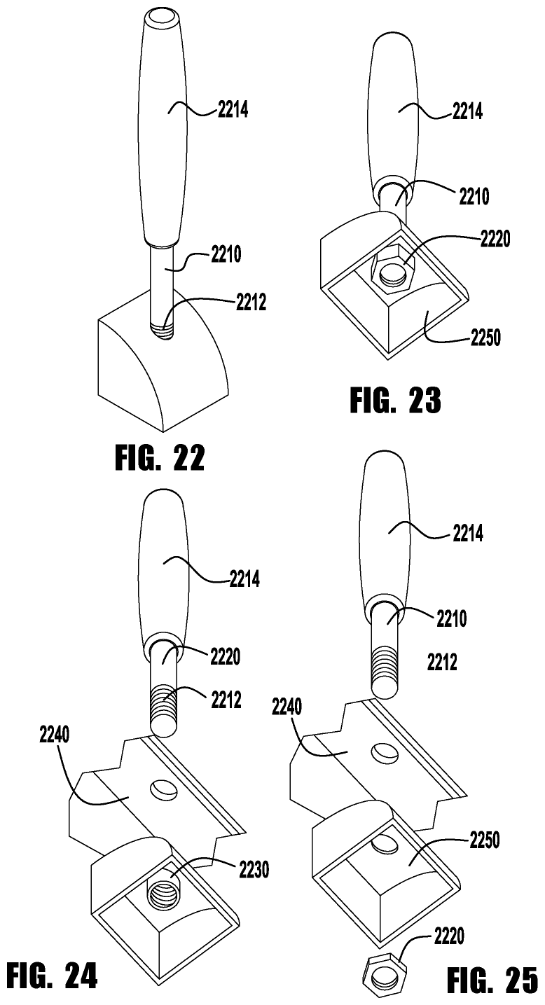

FIG. 22 shows another exemplary embodiment of a stability or transport pin for attachment to a wheelbarrow. As mentioned above, one or more transport pins can be installed in exemplary locations around the rim of the tub and generally extending vertically above the rim surface. As described in detail above, the transport pins may be selectively attached to and/or installed into the wheelbarrow and utilized to stabilize items transported by the wheelbarrow. In this embodiment, transport pin 2210 is shown as a straight post. Transport pin 2210 may be attached to the wheelbarrow in any manner, including as discussed above, similar to transport pin 782.

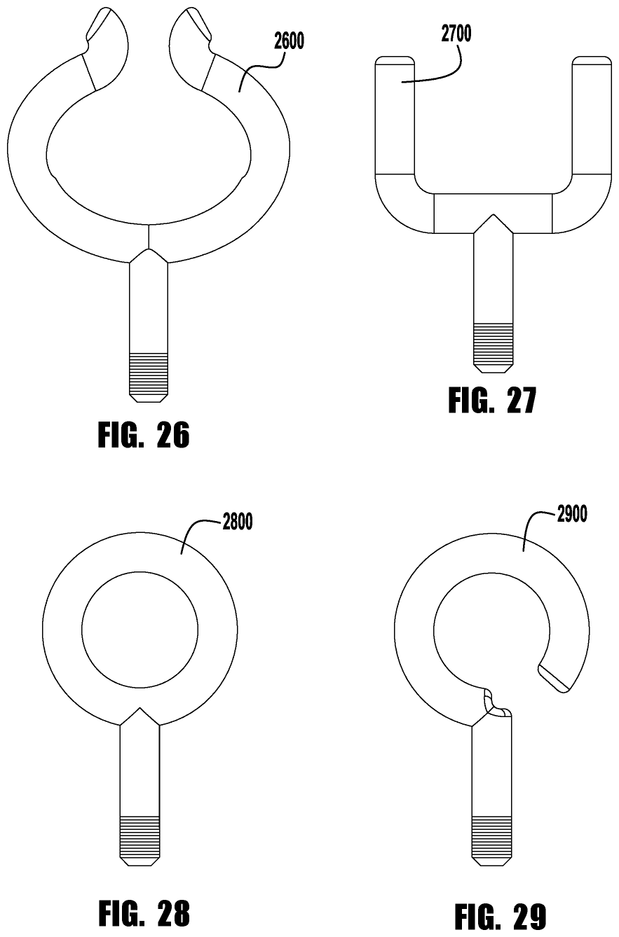

In this embodiment, transport pin 2210 is shown with an optional threaded shaft 2212 and an optional coating 2214. With additional reference to FIGS. 23-25, the threaded shaft 2212 may be used to engage a threaded receiver in the tub (or other portion of the wheelbarrow), a threaded nut 2220 (as shown in FIGS. 23 and 25), and/or a threaded back-up block 2230 (as shown in FIG. 24). In one embodiment, the transport pin 2210 shaft 2212 can extend through the tub rim 2240 and thread into a thread embedded in the rim. In another embodiment, the transport pin 2210 shaft 2212 can extend through the tub rim 2240 and thread into the nut 2220 positioned on the other side of the rim 2240. In another embodiment, the transport pin 2210 shaft 2212 can extend through the tub rim 2240 and thread into the threaded back-up block 2230 positioned on the other side of the rim 2240. In another embodiment, the transport pin 2210 shaft 2212 can extend through the tub rim 2240 and pass through a non-threaded back-up block 2250 and into nut 2220 positioned on the other side of the rim 2240. The back-up block or other device (e.g., washer) can be used to provide clamping strength and distributed force such that a load on the transport pin 2210 will not cause the transport pin to pull out of the tub.

In other exemplary embodiments, FIG. 26 shows a transport pin 2600 with a round shape and open at the top, FIG. 27 shows a transport pin 2700 with a squared shape and open at the top, FIG. 28 shows a transport pin 2800 with a closed round shape, and FIG. 29 shows a transport pin 2900 with a round shape and open at the bottom. Each of these transport pins 2600, 2700, 2800, 2900 can attach to the wheelbarrow in any manner described above, including the threaded embodiments described in relation to transport pin 2210 (e.g., with or without a back-up block, nut, etc.). The transport pins can be rigid or flexible and consist of any material or combination of materials suitable to any application, purpose, and/or environment. The transport pins can include different shapes and sizes holding/retaining different tools/equipment either during use or in storage. In one embodiment, transport pins can secure a tarp that can cover the tub and prevent items from spilling or blowing away, for example, via circumferential eyelets or eye holes to attach to the appropriate transport pin for retention.

The transport pins can be used to stabilize loads, support items (e.g., tools or equipment), act as attachment points or hold-downs for items with eyelets (e.g., tarp or cover), act as a tie down and/or pivot point for a rope or bungee, attach/clamp/lock items or attachments to the wheelbarrow, etc. These uses can be associated with items stored on the wheelbarrow and/or with a worksite (e.g., threading a rope through a transport pin and using the weight and stability of the wheelbarrow to secure or winch something attached to the other end of the rope). In various embodiments, one or more of any of the transport pins are exchangeable and can be used in combination to suit any particular need or application.

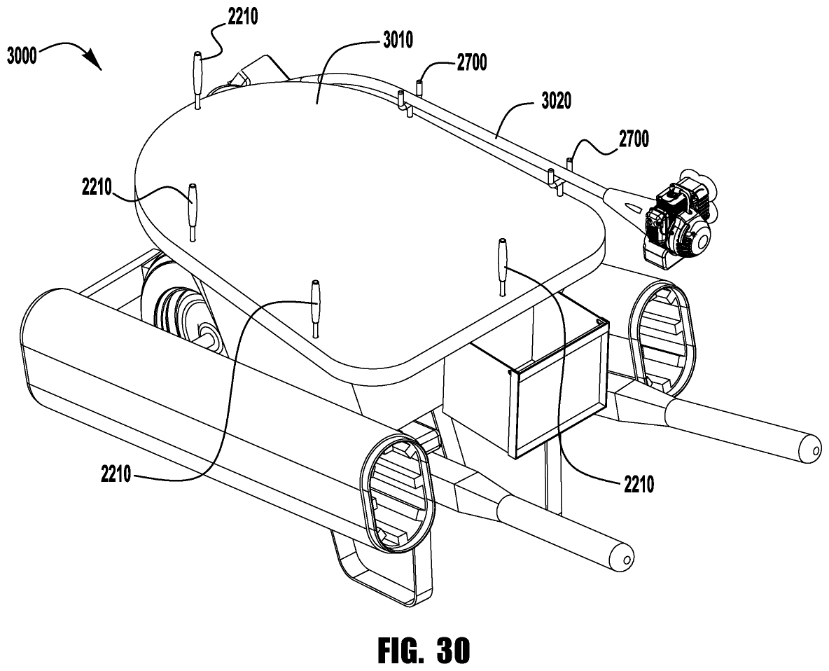

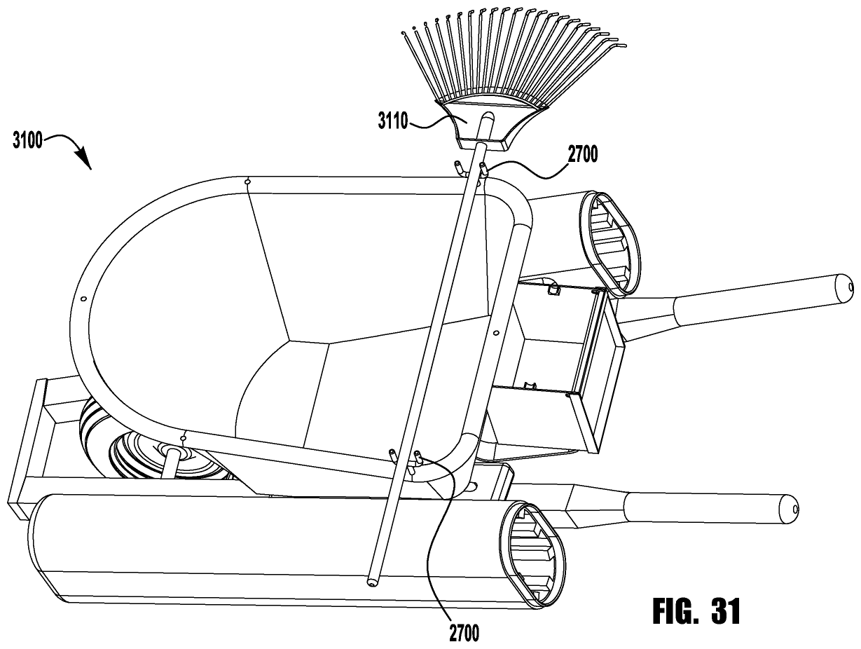

For example, with reference to FIG. 30, an exemplary embodiment 3000 shows various transport pins attached to a wheelbarrow. In particular, several transport pins 2210, 2700 are used to attach a lid or cover 3010 over the tub of the wheelbarrow. In some embodiments, the lid 3010 can be used as a workbench. The transport pins 2700 also serve a secondary purpose by supporting tool 3020. In another example, with reference to FIG. 31, an embodiment 3100 shows transport pins 2700 attached to a wheelbarrow and supporting a tool 3110.

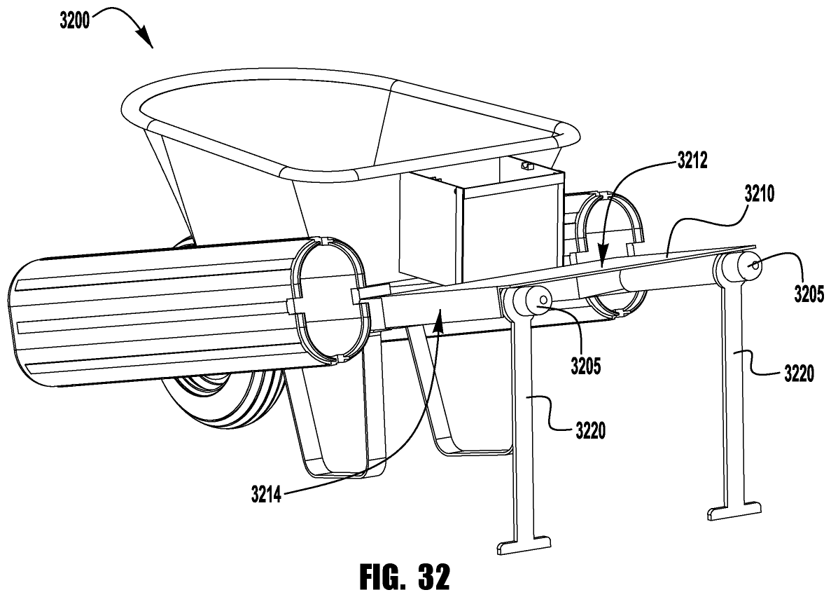

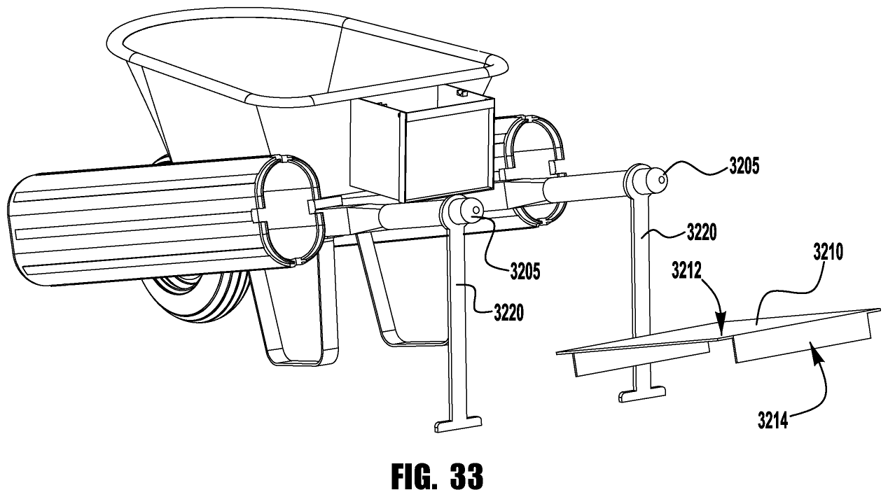

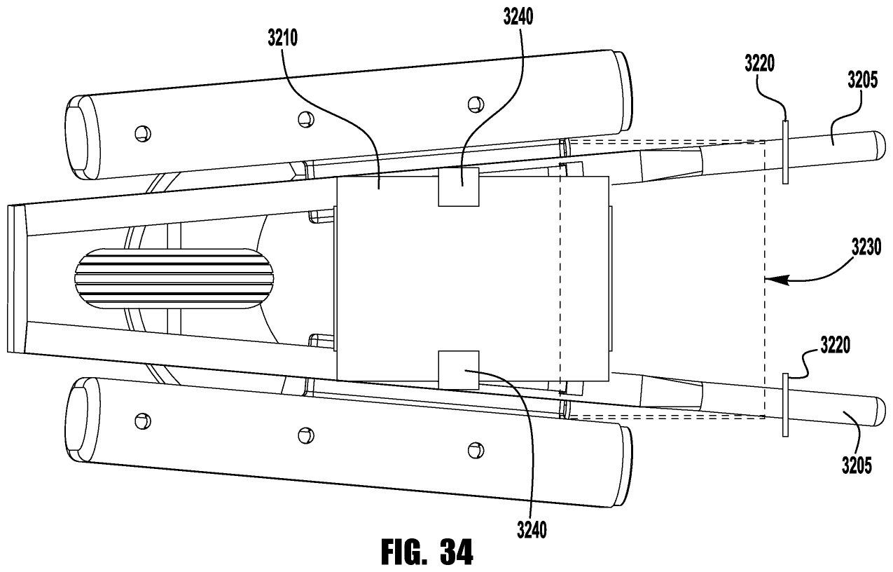

FIG. 32 shows another exemplary embodiment 3200 with a seat attached to a wheelbarrow. Seat 3210 can be configured as a modular attachment to a wheelbarrow, including, for example, as a one-piece design. In this embodiment, the seat 3210 is completely removable, including to reposition between seating and storage positions. In this embodiment, with additional reference to FIGS. 33-34, seat 3210 can be positioned on top of the wheelbarrow handles 3205 with a seating surface 3212. In this embodiment, the handles 3205 of the wheelbarrow provide support for the seat 3210. The seat can also include optional sides 3214 that can orient and/or stabilize the seat 3210 on the handles 3205, for example, to prevent side-to-side movement of the seat 3210 when positioned on the handles 3205.

In another exemplary embodiment, stabilizers or supports 3220 can also be attached to the handles 3205 (or another portion of the wheelbarrow) to provide additional support to the wheelbarrow, for example, to prevent tipping of the wheelbarrow when a user sits on the seat 3210 or uses the seat 3210 as a working surface. In this embodiment, the supports 3220 are positioned around the handles 3205 and make contact with the ground when the user sits on the seat 3210 or uses the seat 3210 as a working surface. In particular, the supports 3220 have an upper opening that allows the handle 3205 end to slide through the opening and secure the support 3220 to the handle 3205. The lower end of the support 3220 can rest on the ground. The supports 3220 can provide stability for the seat 3210 for sitting and/or a flat working surface 3212 on the seat for performing various tasks.

The supports 3220 can be stored in various locations of the wheelbarrow, including, for example, in the seat 3210. Although this embodiment is shown as a fixed length design, various other configurations can be adjustable to vary the length or height of the supports 3220, including, for example, those described below for stabilizers. The seat 3210 and supports 3220 can be various shapes, sizes, materials, etc. suitable for various applications.

FIG. 33 shows the seat 3210 removed from the seating position (as shown in FIG. 32 on top of the handles 3205). FIG. 34 shows the seat 3210 stored underneath the wheelbarrow tub. In this embodiment, two brackets 3240 are shown supporting the seat 3210 in the stored position. Another bracket or stop (not shown) can be used to stop the seat 3210 as the seat 3210 is slid into the storage slot under the tub. FIG. 34 also shows an outline 3230 of the seat 3210 in the seating position from below, highlighting that the seat 3210 can simply be removed, rotated 90 degrees, and then placed in its new position (seating or storage).

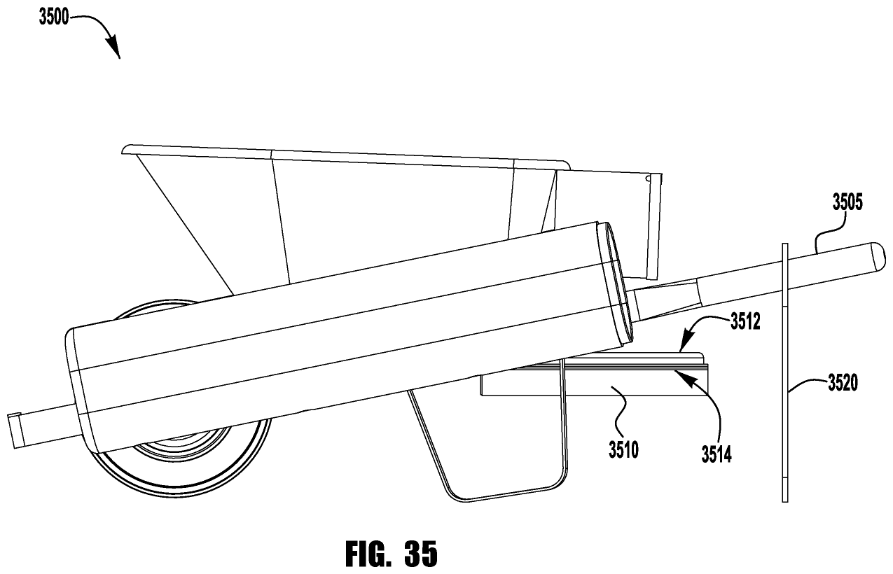

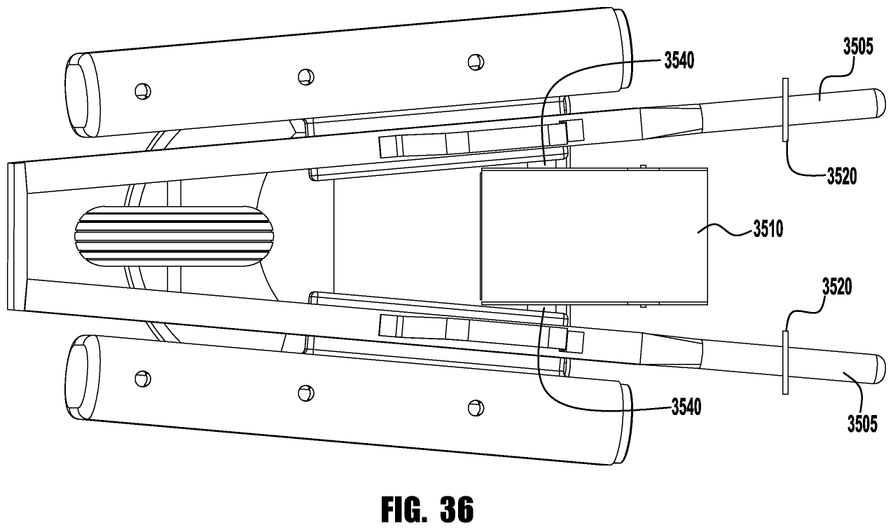

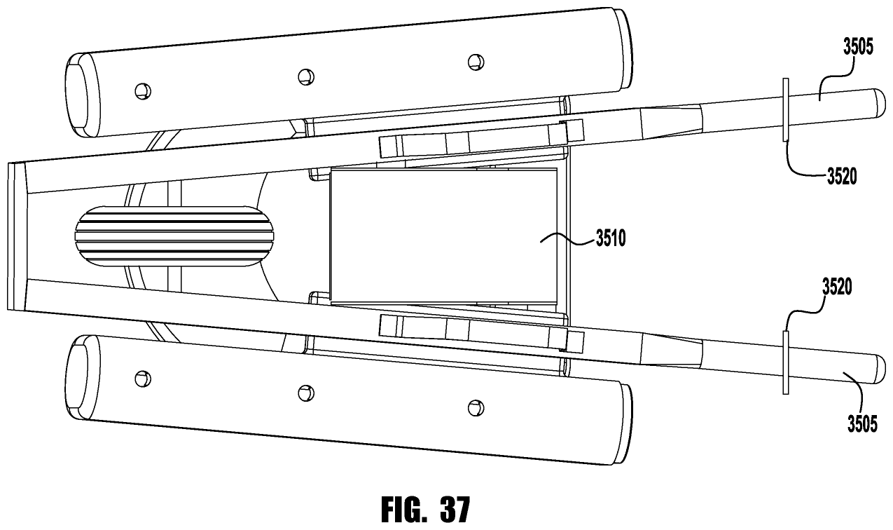

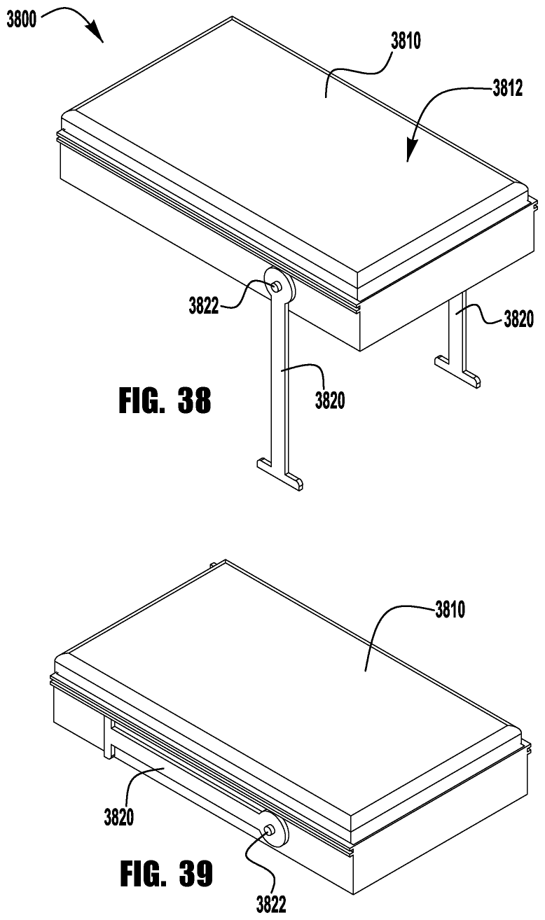

FIG. 35 shows another exemplary embodiment 3500 with a seat and/or storage tray attached to a wheelbarrow. Seat (and/or tray) 3510 can be configured as a modular attachment to a wheelbarrow, including, for example, as a one-piece design. Although described below as a seat 3510, in other embodiments, the attachment can be configured as a seat where the seating/working surface also functions as a removable (including, e.g., liftable, slidable, etc.) lid covering a storage compartment within the seat 3510. In other embodiments, the attachment may be a storage tray only, with or without a lid. In this embodiment, the seat 3510 is attached to the wheelbarrow, including seating and storage positions. Like seat 3210, seat 3510 can also be used as a working surface. In this embodiment, with additional reference to FIGS. 36-37, seat 3510 can be positioned between the wheelbarrow handles 3505 with a seating surface 3512. In this embodiment, the seat 3510 can move in and out of a storage position under the tub, for example, along tracks 3514 in the sides of the seat 3510 that are configured to interface with brackets or guides 3540. FIGS. 35 and 36 show the seat 3510 in the extended or seating position. FIG. 37 shows the seat 3510 in the storage position under the tub.

In another exemplary embodiment, stabilizers or supports 3520 can also be attached to the handles 3505 (or another portion of the wheelbarrow) to provide additional support to the wheelbarrow, for example, to prevent tipping of the wheelbarrow when a user sits on the seat 3510. In this embodiment, the supports 3520 are positioned around the handles 3505 and make contact with the ground when the user sits on the seat 3510. In particular, the supports 3520 have an upper opening that allows the handle 3505 end to slide through the opening and secure the support 3520 to the handle 3505. The lower end of the support 3520 can rest on the ground. The supports 3520 can provide stability for the seat 3510 for sitting and/or a flat working surface 3512 on the seat for performing various tasks.

The supports 3520 can be stored in various locations of the wheelbarrow, including, for example, in the seat 3510. The seat 3510 and supports 3520 can be various shapes, sizes, materials, etc. suitable for various applications.

In another exemplary embodiment, as shown in FIG. 38, a seat 3810 with seating surface 3812 and integrated supports 3820 replaces seat 3510 described above. Like seat 3210, seat 3810 can also be used as a working surface. In this embodiment, seat 3810 includes integrated stabilizers or supports 382 to provide additional support to the seat 3810, for example, to prevent tipping of the wheelbarrow when a user sits on the seat 3810. In this embodiment, the supports 3820 are attached to the sides of the seat 3810 and make contact with the ground when the user sits on the seat 3810. In particular, the supports 3820 have an upper end attached to the seat 3810 (e.g., at hub 3822) and a lower end that can rest on the ground. The supports 3820 can provide stability for the seat 3810 for sitting and/or a flat working surface 3812 on the seat for performing various tasks. In this embodiment, as shown in FIG. 39, supports 3820 can pivot about hub 3822 into a storage position alongside the seat 3810 before the seat 3810 is moved to its storage position under the tub, as described above for seat 3510. In various embodiments, one or more supports 3520 can be used in combination with one or more supports 3820.

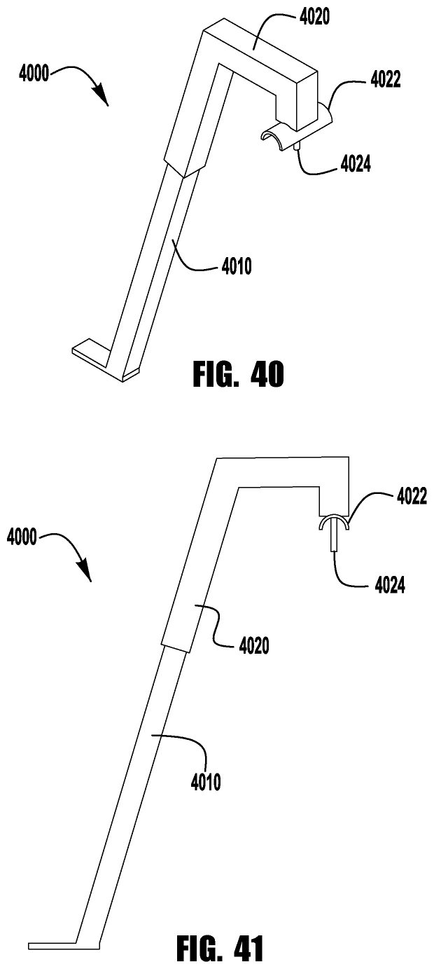

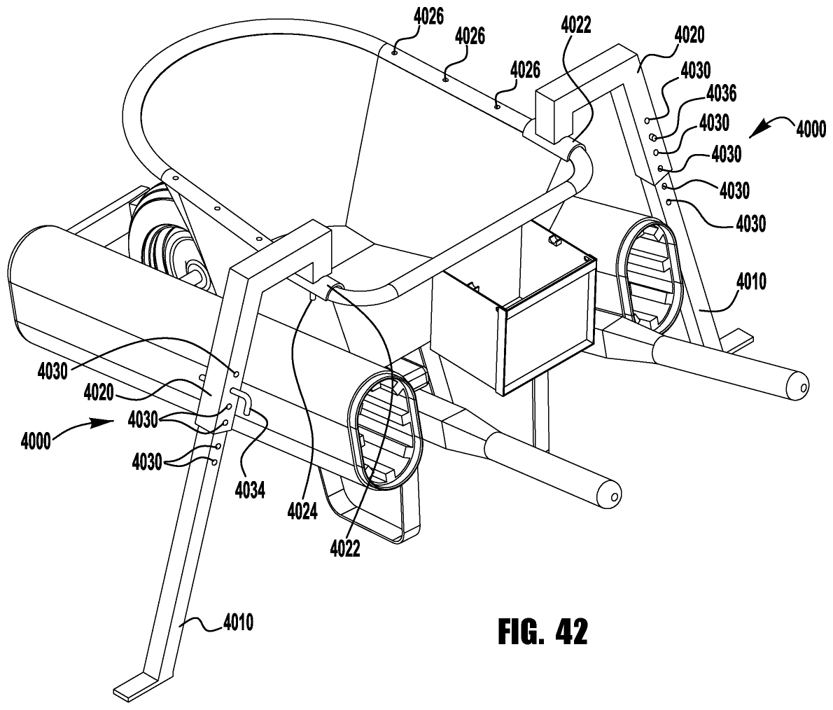

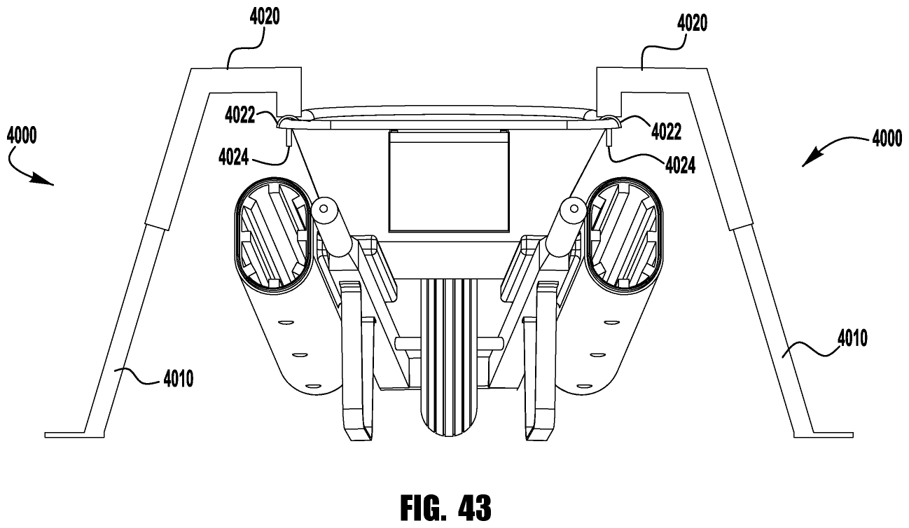

FIG. 40 shows an exemplary embodiment of a stabilizer 4000 that can be attached to a wheelbarrow. In particular, stabilizer 4000 can be configured as a modular attachment for a wheelbarrow, for example, to provide lateral support to the wheelbarrow when stationary and/or when moving. The stabilizer can be a fixed length or can be adjustable. With additional reference to FIGS. 41-43, in this embodiment, the stabilizer 4000 is adjustable with a lower support 4010 and an upper support 4020, where the lower support 4010 can slide within the upper support 4020 to adjust the overall stabilizer 4000 length. In other embodiments, the upper support 4020 could slide within the lower support 4010. In addition to this telescoping design, various other configurations can be used to adjust the length of a stabilizer. The stabilizer 4000 can be various shapes, sizes, angles, materials, etc. suitable for various applications.

In this embodiment, stabilizer 4000 is also shown with a top support 4022 and locating pin 4024 for insertion into a hole (and/or slot) 4026 of a wheelbarrow. In particular, pin 4024 can insert through a hole 4026 in the wheelbarrow (e.g., in the rim of the tub) and the top support 4022 flanges can make contact with a larger surface of the wheelbarrow (e.g., along the rim of the tub) for support. Various configurations of top support 4022 flanges, including, for example, specific or universal designs, can accommodate various wheelbarrow tub/rim sizes and shapes for proper engagement. In various embodiments, the hole 4026 in the wheelbarrow may also be a transport pin hole, for example, with several holes 4026 available for use in the wheelbarrow rim, as shown in FIG. 42. Several other configurations can be used to attach the stabilizer 4000 to the wheelbarrow.

In this embodiment, the stabilizer 4000 is adjustable by sliding the lower support 4010 within the upper support 4020 to adjust the overall stabilizer 4000 length. In one embodiment, as shown in FIG. 42, the supports 4010, 4020 include various holes 4030 to accept a locking pin 4034 passing through holes aligned in the supports 4010, 4020. To change the length of the stabilizer 4000, the pin 4034 can be removed, the supports 4010, 4020 adjusted to align a set of holes 4030 in each support 4010, 4020, and then inserting the pin 4034 through the aligned holes 4030 to lock the supports 4010, 4020 in position. In another embodiment, also shown in FIG. 42, a spring-loaded button 4036 attached to the lower support 4010 can engage a hole 4030 in the upper support 4020. To change the length of the stabilizer 4000, the button 4036 can be depressed, the supports 4010, 4020 adjusted to align the button 4036 with a hole 4030 in the upper support 4020, and then allowing the button 4036 to pop back through the aligned hole 4030 of the upper support 4020 to lock the supports 4010, 4020 in position. Several other alignment and locking mechanisms can be used in various other embodiments.

In various embodiments, the stabilizer 4000 can be adjusted to be even with the ground (e.g., for stationary support) and/or a certain distance above the ground (e.g., for transporting support). For example, when the wheelbarrow is stationary at a work site (e.g., during loading or unloading), the stabilizer 4000 can be adjusted to make contact with the ground to prevent the wheelbarrow from tipping, for example, due to uneven loading, forces exerted onto the wheelbarrow, etc. In another example, when the wheelbarrow is moving, the stabilizer 4000 can be adjusted (e.g., to a shorter length) to not make contact with the ground to prevent the stabilizer from making unintended contact with the ground (e.g., when traversing over uneven terrain), which could cause the wheelbarrow to tip. However, if the wheelbarrow does start to lean sideways while moving, the stabilizer 4000 will then make contact with the ground and prevent the wheelbarrow from tipping to the side. In some embodiments, the stabilizer 4000 length may not need to be adjusted while transitioning between stationary and transporting modes if the handle lift from the user is sufficient to create the desired gap between the bottom of the stabilizer 4000 and the ground during transport.

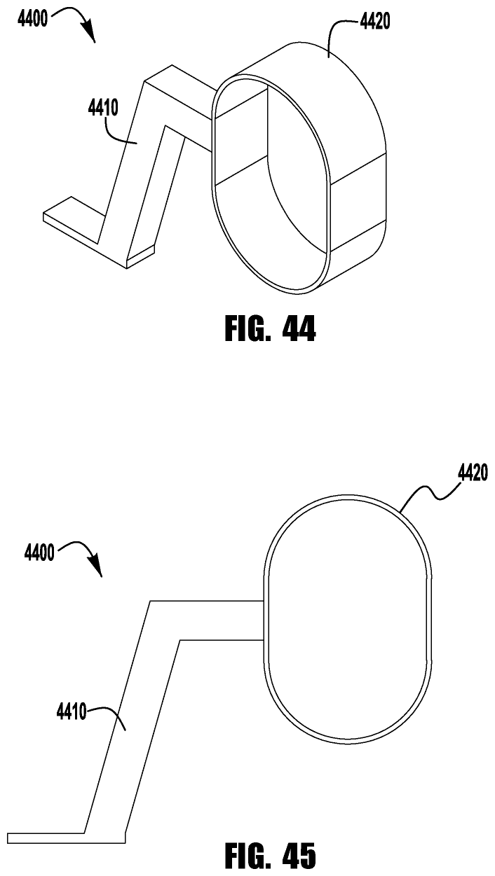

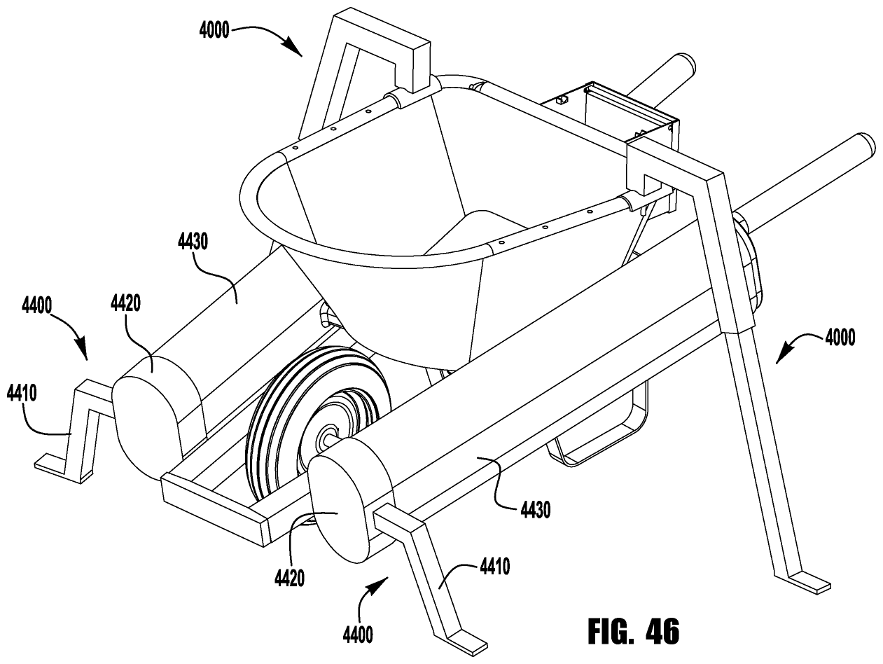

FIG. 44 shows an exemplary embodiment of a stabilizer 4400 that can be attached to a wheelbarrow. In particular, stabilizer 4400 can be configured as a modular attachment for a wheelbarrow, for example, to provide lateral support to the wheelbarrow when stationary and/or when moving. The stabilizer can be a fixed length or can be adjustable. With additional reference to FIGS. 45-47, in this embodiment, the stabilizer 4400 includes a lower support 4410 and an upper support 4420, where the lower support 4410 can make contact with the ground and the upper support 4420 attaches to the wheelbarrow. Although this embodiment is shown as a fixed length design, various other configurations can be adjustable to vary the length of the stabilizer, including, for example, those described above for stabilizer 4000. The stabilizer 4400 can be various shapes, sizes, angles, materials, etc. suitable for various applications.

In this embodiment, stabilizer 4400 is also shown with an upper support 4420 configured for attaching around a tube 4430 of a wheelbarrow. In particular, upper support 4420 is shown configured as a collar that slides over the outer surface of tube 4430. In various embodiments, a stop or retention feature can be added to the stabilizer 4400 and/or the tube 4430 to lock the stabilizer 4400 into a particular position on the tube 4430 (e.g., a pin through a hole, a rib (e.g., similar to rib 1613 described above), etc.) to aid in retention and prevent rotation and/or sliding of the stabilizer 4400 around and/or along the tube 4430. Various configurations of upper support 4420, including, for example, specific or universal designs, can accommodate various wheelbarrow tube sizes and shapes for proper engagement. Several other configurations can be used to attach the stabilizer 4400 to the wheelbarrow.

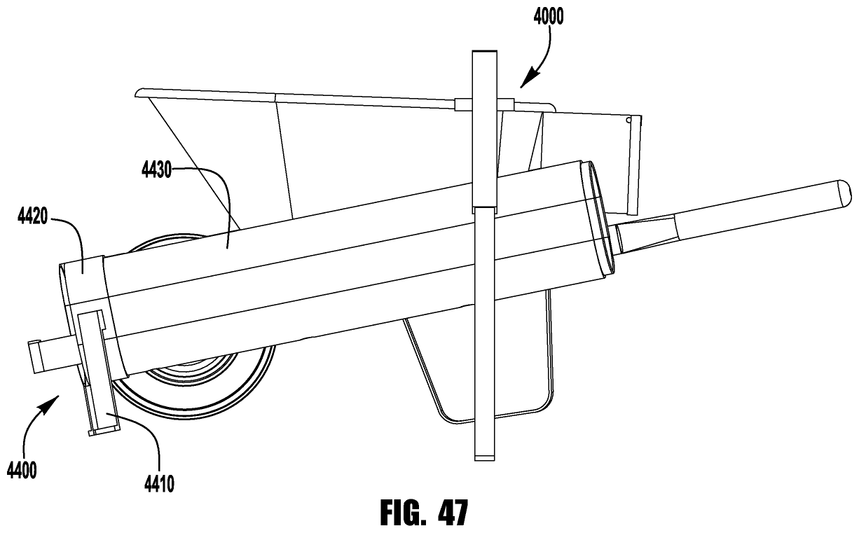

In various embodiments, the stabilizer 4400 can include an adjustment mechanism (e.g., as described above for stabilizer 4000) and can be adjusted similarly. In some embodiments, the stabilizer 4400 can attach over either end of tube 4430, including using an adjustable stabilizer or various fixed lengths. Also, as shown in FIGS. 46-47, one or more stabilizers 4000 and/or 4400 can be used in combination when stationary and/or when moving, depending on the application and needed stability.

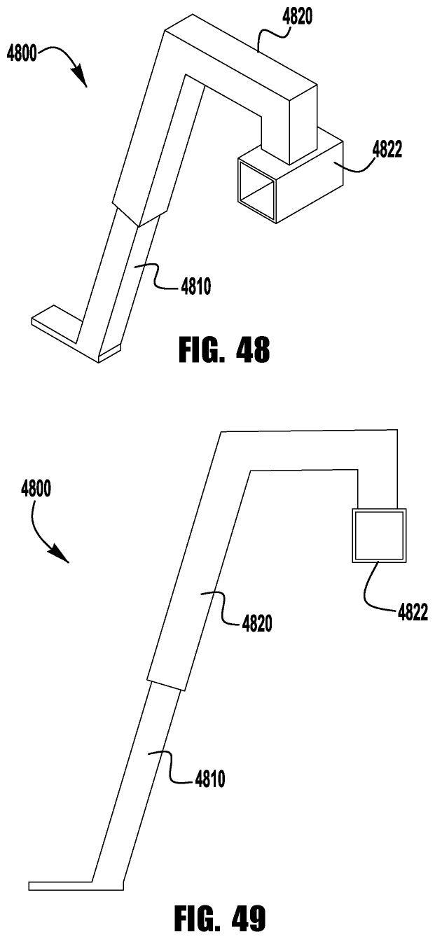

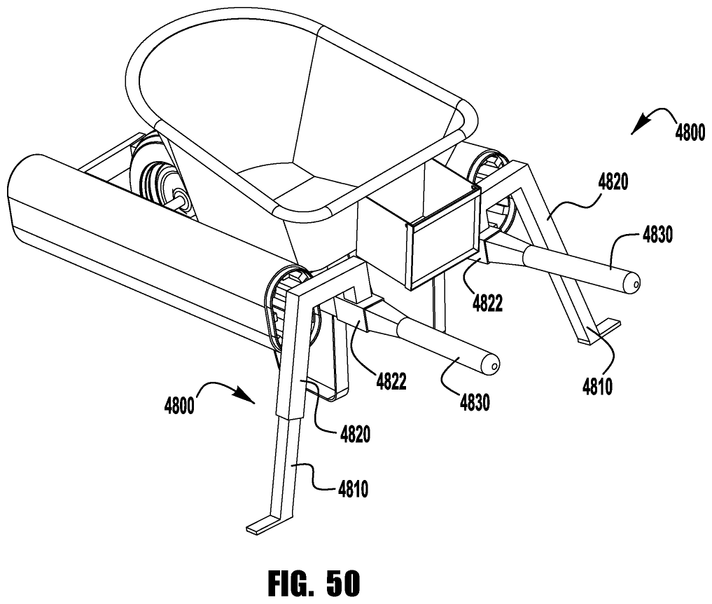

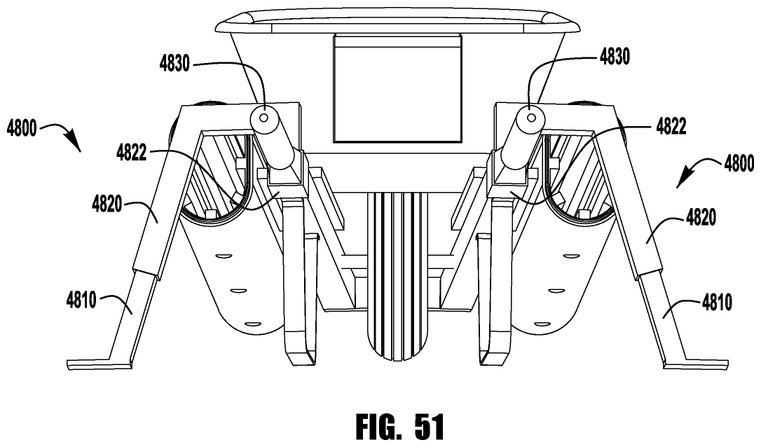

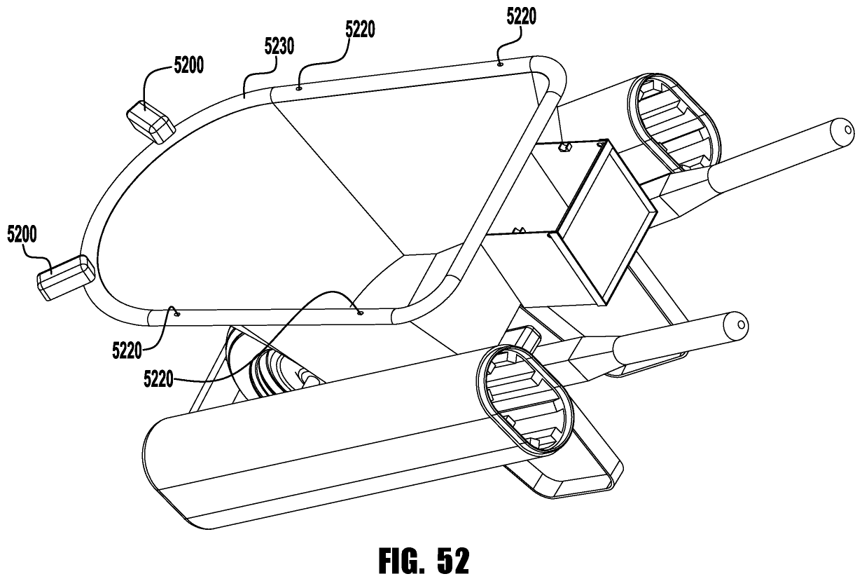

FIG. 48 shows an exemplary embodiment of a stabilizer 4800 that can be attached to a wheelbarrow. In particular, stabilizer 4800 can be configured as a modular attachment for a wheelbarrow, for example, to provide lateral support to the wheelbarrow when stationary and/or when moving. The stabilizer can be a fixed length or can be adjustable. With additional reference to FIGS. 49-51, in this embodiment, the stabilizer 4800 is adjustable with a lower support 4810 and an upper support 4820, where the lower support 4810 can slide within the upper support 4820 to adjust the overall stabilizer 4800 length. In other embodiments, the upper support 4820 could slide within the lower support 4810. In addition to this telescoping design, various other configurations can be used to adjust the length of a stabilizer. The stabilizer 4800 can be various shapes, sizes, angles, materials, etc. suitable for various applications.

In this embodiment, stabilizer 4800 is also shown with a top support 4822 configured for attaching around a side support handle 4830 of a wheelbarrow. In particular, upper support 4822 is shown configured as a collar that slides over the outer surface of handle 4830, for example, with a matching cross-section shape. In various embodiments, a stop or retention feature can be added to the stabilizer 4800 and/or the handle 4830 to lock the stabilizer 4800 into a particular position on the handle 4830 (e.g., a pin through a hole, a rib (e.g., similar to rib 1613 described above), etc.) to aid in retention and prevent rotation and/or sliding of the stabilizer 4800 around and/or along the handle 4830. Various configurations of top support 4822 flanges, including, for example, specific or universal designs, can accommodate various wheelbarrow side support/handle 4830 sizes and shapes for proper engagement. Several other configurations can be used to attach the stabilizer 4800 to the wheelbarrow.

In this embodiment, the stabilizer 4800 is adjustable by sliding the lower support 4810 within the upper support 4820, or vice versa, to adjust the overall stabilizer 4800 length. In some embodiments, various length locking mechanisms, for example, those shown in FIG. 42 for supports 4010, 4020 of stabilizer 4000, can be utilized, for the same reasons and functions described above. Several other alignment and locking mechanisms can be used in various other embodiments.

One or more stabilizers 4000, 4400, and/or 4800 can be used in combination when stationary and/or when moving, depending on the application and needed stability. Furthermore, one or more stabilizers 4000, 4400, and/or 4800 can be used instead of or in combination with supports 3220, 3520, 3820 for seating and/or working shelf stability. Any of these stabilizers and/or supports can be used alone or in combination for any other use of the wheelbarrow needing additional support and/or stability.

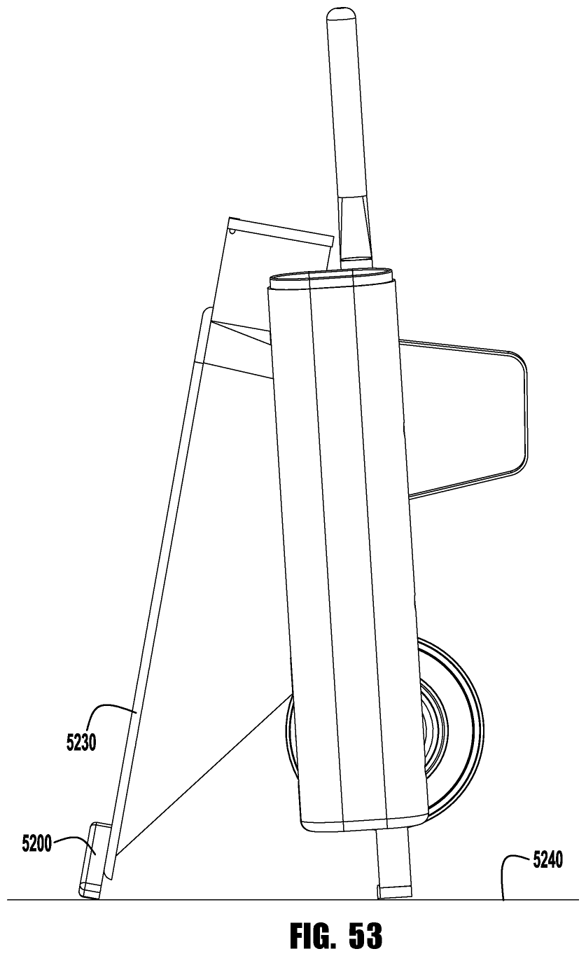

FIG. 52 shows an exemplary embodiment of a toe or strut 5200 that can be attached to a wheelbarrow. In particular, strut 5200 can be configured as a modular attachment for a wheelbarrow, for example, to provide (e.g., lateral) stabilization and/or support to the wheelbarrow when stationary, moving, or tipping, for example, to dump materials, clean the wheelbarrow, etc. The strut 5200 can be a fixed length or can be adjustable. With additional reference to FIG. 53, in this embodiment, the strut 5200 is a fixed length. In other embodiments, other configurations can be used to adjust the length of a strut, including, for example, the telescoping two-part designs described above. The strut 5200 can be various shapes, sizes, angles, materials, etc. suitable for various applications.

In this embodiment, strut 5200 is shown attached to the rim 5230 of a wheelbarrow. In particular, for example, a pin or threaded shaft of the strut 5200 can insert through a hole 5220 in the wheelbarrow (e.g., in the rim 5230 of the tub) and attach to the wheelbarrow, for example, via a nut and/or back-up block as described above in reference to the transport pins above (see FIGS. 22-25). Various configurations of strut 5200 shapes, including, for example, specific or universal designs, can accommodate various wheelbarrow tub/rim sizes and shapes for proper engagement. In various embodiments, the hole 5220 in the wheelbarrow may also be a transport pin hole 5220, for example, with several holes 5220 available for use in the wheelbarrow rim 5230, as shown in FIG. 52. Several other configurations can be used to attach the strut 5200 to the wheelbarrow.

In various embodiments, struts 5200 can be attached to the rim/tub, tubes, handles, etc. in any manner suited to prevent tipping and/or provide support during tipping, including use in combination with any of the stabilizers and/or supports described above. Struts 5200 can be attached to the wheelbarrow along any side, for example, for front-tipping or side-tipping support. FIG. 53 shows an exemplary embodiment of struts 5200 attached to the rim 5230 of a wheelbarrow, supporting the wheelbarrow against the ground 5240 during a front-tipping operation.

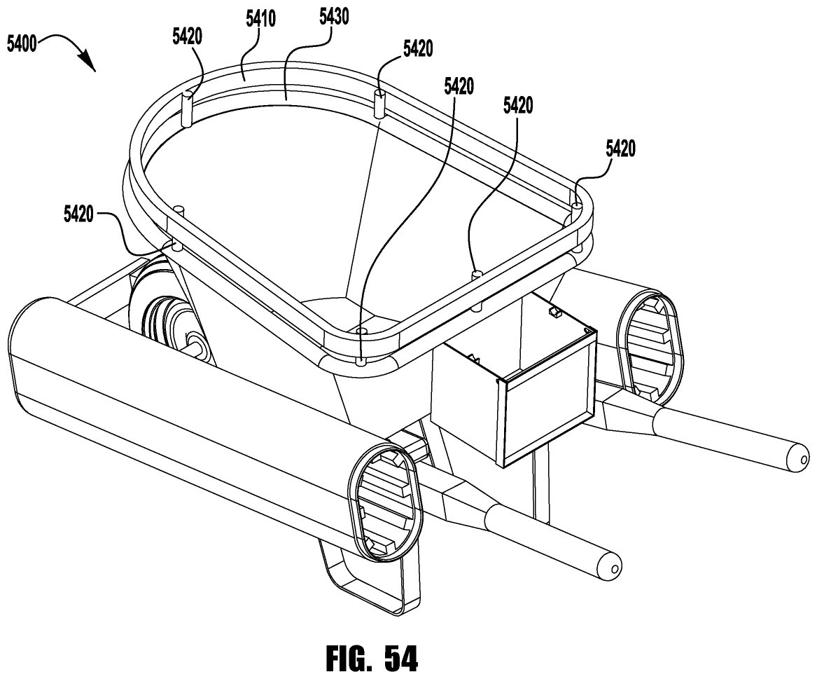

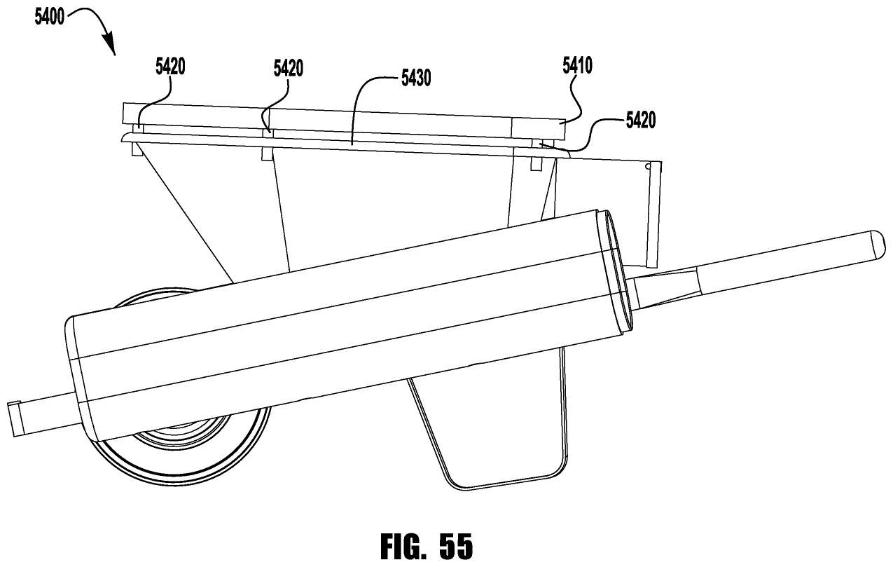

FIG. 54 shows an exemplary embodiment of a wall extender 5400 that can be attached to a wheelbarrow. In particular, wall extender 5400 can be configured as a modular attachment for a wheelbarrow, for example, to extend the side walls of the wheelbarrow tub, for example, to increase the cargo capacity or height. The extender can be a fixed height or can be adjustable. With additional reference to FIG. 55, in this embodiment, the extender 5400 is a fixed height. In other embodiments, other configurations can be used to adjust the height of an extender, including, for example, stacking extenders or a telescoping design described below. The extender 5400 can be various shapes, sizes, angles, materials, etc. suitable for various applications.

In this embodiment, extender 5400 is shown attached to the rim 5430 of a wheelbarrow. In particular, for example, a wall 5410 is attached to a pin or threaded shaft 5420 of the wall extender 5400, which can insert through a hole and/or slot in the wheelbarrow (e.g., in the rim 5430 of the tub) and attach to the wheelbarrow, for example, via a nut and/or back-up block as described above in reference to the transport pins above (see FIGS. 22-25). In embodiments with a threaded engagement, the pins 5420 can rotate within the extender 5400. In other embodiments, the extender 5400 pins 5420 can insert into the wheelbarrow rim 5430 holes without a locking means. Various configurations of extender 5400 shapes, including, for example, specific or universal designs, can accommodate various wheelbarrow tub/rim sizes and shapes for proper engagement. In various embodiments, the holes in the wheelbarrow rim 5430 may also be transport pin holes, for example, with several holes available for use in the wheelbarrow rim 5430. Several other configurations can be used to attach the extender 5400 to the wheelbarrow.

Although FIGS. 54-55 show one extender 5400 extending all of the tub side walls, in other embodiments extenders can be configured to selectively extend one or more walls, alone or in combination with other extenders. In these embodiments, latching mechanisms can be used to secure one extender side to another extender side for added stability.

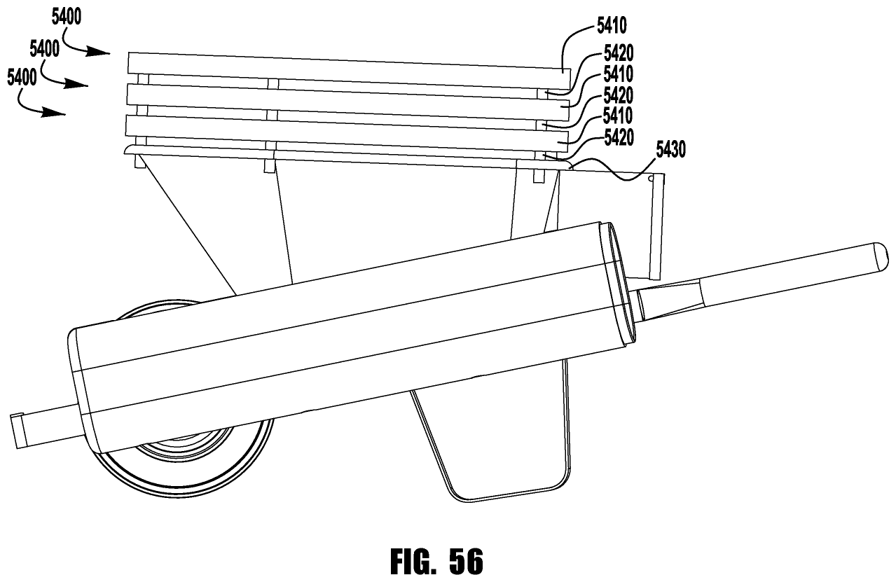

In another exemplary embodiment, as shown in FIG. 56, multiple extenders 5400 are stacked to increase the overall height of the extended wall. One extender 5400 can interface with another extender 5400 in any suitable manner, including, for example, inserting the pin 5420 of one extender 5400 into the top of a lower extender 5400 (e.g., where the top of each pin 5420 has an open hole to act as a receiver or a hollowed recess to receive the tapered bottom tip of a pin 5420 from an adjacent extender).

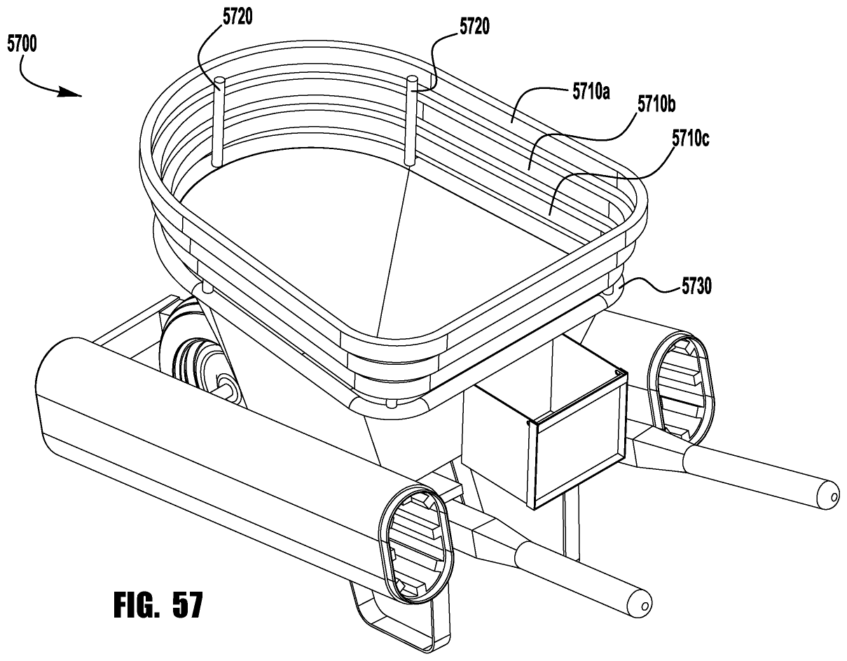

In another exemplary embodiment, as shown in FIG. 57, an extender 5700 includes multiple wall sections 5710a, 5710b, 5710c that can telescope up and down along support pins 5720, allowing for a selective height (and condensed storage when not in use). Various types of locking or latching mechanisms can be used to retain the extender 5700 at the desired height when extended. Extender 5700 similarly attaches to the wheelbarrow rim 5730 via pins 5720.

In other embodiments, extenders and/or sections of the extenders can be removeable or pivot along a hinge up-and-down and/or side-to-side (e.g., like a gate) to allow side access to the tub without removing the extender. In other embodiments, a lid or cover, as described above, can be attached to the top of the extender, for example, where the tops of the pins of the extender act as receiving holes for other modular attachments (e.g., transport pins, etc.)

In various embodiments, a storage bin (e.g., as described above), which can be removable, can contain a power unit (e.g., consisting of replaceable or rechargeable battery/batteries). The power unit can be configured with a plug that allows a direct connection of the unit to a power source for recharging or one or more removeable batteries that can then be placed in a charger or directly connected to a power source for recharging. In some embodiments, charging “docking areas” can be located on the inside and/or outside of the bin/box that holds the charging units/ports. These docking areas can include the placement of and/or connection to various vendor charging units for the batteries of cordless devices to be recharged at any time during use. In other embodiments, ports or docks can include USB ports or other type plugs configured for various devices, including, for example, smart devices (phones, tablets, etc.), speakers, lights, other rechargeable devices/batteries, etc. In some embodiments, the power unit or battery source can use AC-DC/DC-AC converter(s) or similar power conversion devices, breakers, GFCIs, fuses, switches, indicators, etc. In various embodiments, the power compartment and charging areas can be waterproof or water repellent.

For example, in one embodiment, a battery location or compartment can be inside or below the storage bin (e.g., waterproof/water resistant) and can have a hinged (optionally locking) door to facilitate replacement and removal of a rechargeable battery. The rechargeable battery can be in a housing that allows quick plugin/plug out of a rear plug/dock. The rear battery plug/dock allows charging of the rechargeable battery and can also be the power source/connection to outlets and tool charging docks, USB's, etc. associated with the storage bin and wheelbarrow. Conduit and/or wiring can route from the battery around the compartment (e.g., in channels) to plugs and docking stations located around the storage bin/box. Plugs can be male/female and include USB ports or other device ports, as mentioned above. The compartment door and plugs can be hinged with covers to keep dry and/or protected.

The rechargeable battery can be charged while in the wheelbarrow (e.g., via an attached or removable/attachable cord) or can be removed for charging while removed from the wheelbarrow (e.g., via an attached or removable/attachable cord or its own charging dock). The storage bin and battery compartment can include one or more hardwired and/or removable tool battery recharging docks. Devices/tool batteries can plug into a charger for charging, where the charging power is provided by the rechargeable battery of the wheelbarrow. In some embodiments, a direct charging outlet allows simultaneous overnight charging of the rechargeable battery and charging docks/ports with tool batteries. Tool/device chargers can be permanent or removable from the storage bin. In various embodiments, chargers for devices/tool batteries can be integrated into the storage bin or plugged into an outlet provided by the storage bin, with charging power from the rechargeable battery of the wheelbarrow. This allows for the use of any vendor tool/device battery charging unit. Various tool charging system docks can be placed into the bin or holder, for example, with the electrical cord wrapped around the holder and plugged into an outlet, which can have the optional cover. The bottom of the outlet cover can be open to allow for cord/plug access to the outlet.

Any of these features can be combined in various embodiments. Several exemplary embodiments are described below.

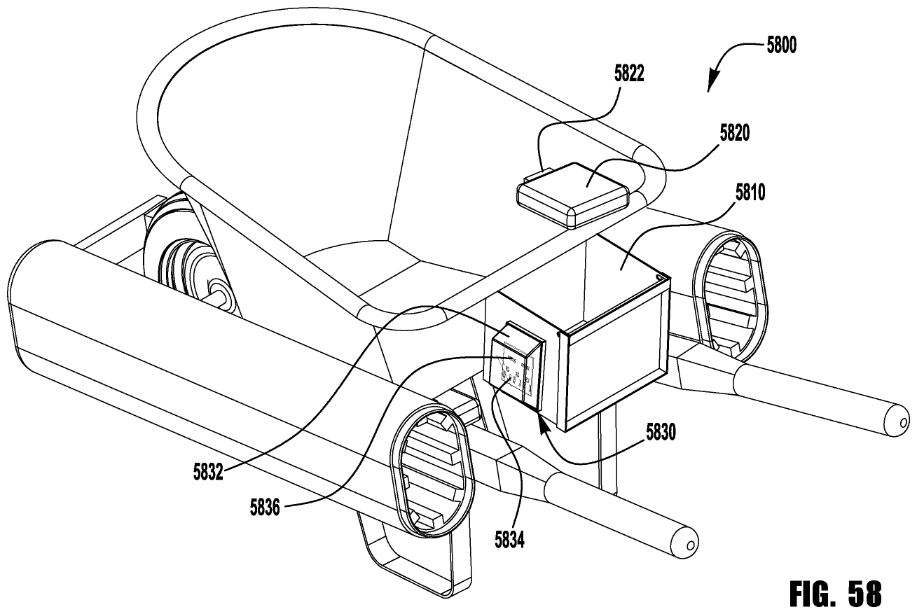

FIG. 58 shows an exemplary embodiment 5800 of a storage bin and power unit that can be attached to a wheelbarrow. In particular, a power unit or rechargeable battery 5820 can be connected to a storage bin 5810 with power distribution, configured as a modular attachment for a wheelbarrow, for example, to provide power/charging to various devices and/or equipment. The storage bin 5810 can be configured as any of the storage bins mentioned above, including, for example, mounting, materials, features, lid, etc.

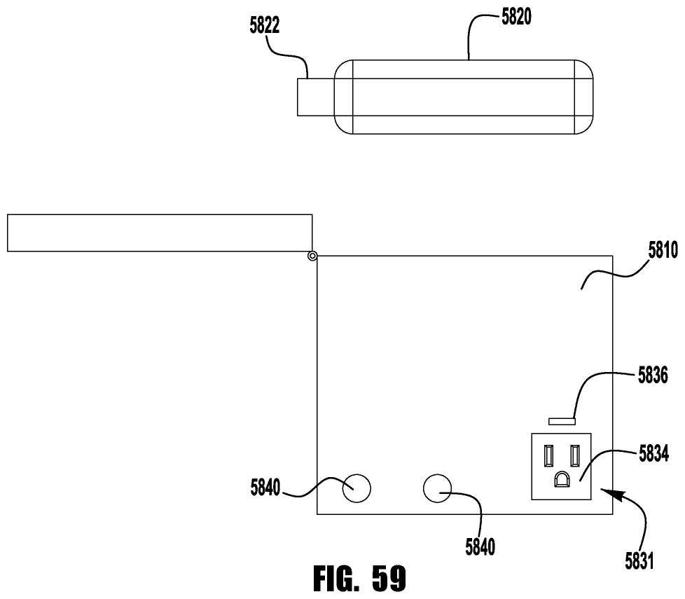

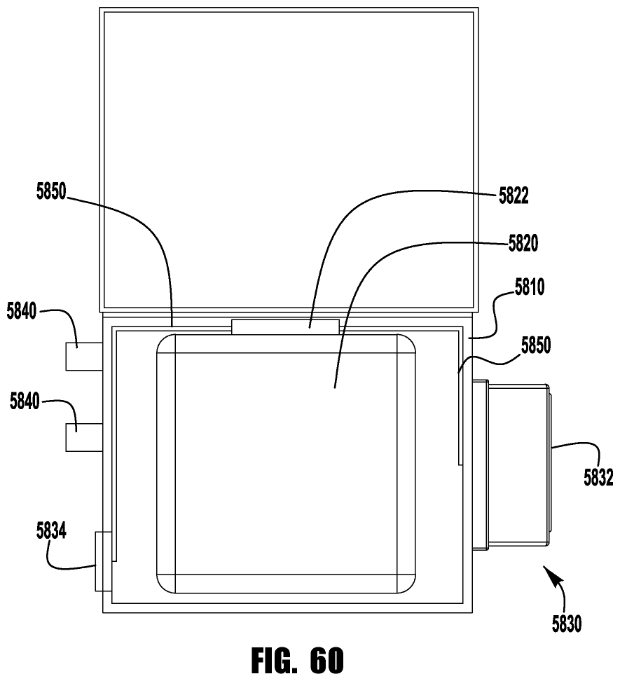

With additional reference to FIGS. 59-60, in this embodiment, the storage bin 5810 includes a receptacle configured to receive a plug 5822 of the rechargeable battery 5820. In this embodiment, the rechargeable battery 5820 can be charged in a separate charging dock (e.g., via the plug 5822 or a separate charging cord plugged into a standard outlet) and then connected to the storage bin 5810 via the plug 5822. In other embodiments, the rechargeable battery 5820 can be charged while connected to the storage bin 5810, for example, via a charging cord plugged into a standard outlet (including embodiments where the rechargeable battery is hardwired to the power distribution system). When charged and connected to the storage bin 5810, the rechargeable battery 5820 can provide power/charging to various devices and/or equipment without the need for access to a standard outlet/receptacle. The power unit or rechargeable battery 5820 can be various shapes, sizes, materials, power types (e.g., AC, DC), voltages, capacities (e.g., amp hours), etc. suitable for various applications.

In this embodiment, rechargeable battery 5820 is connected to a power distribution system 5850 (e.g., including receptacle, wires, circuits, conduit, outlets, etc.) in the bottom of the storage bin 5810 via plug 5822. The power distribution system 5850 is connected to one or more receptacles or plugs, for example, for various devices or chargers. This embodiment includes exemplary receptacles 5830, 5831, which receive power from the rechargeable battery 5820 via the power distribution system 5850. Receptacle 5830 is shown mounted to a side of the storage bin 5810 and includes a cover 5832 (e.g., weatherproof with holes along the bottom for cord passage), 110v AC outlets 5834, and USB (e.g., 5v DC) outlets 5836. Receptacle 5831 is shown mounted to another side of the storage bin 5810 and includes a 110v AC outlet 5834 and a USB outlet 5836. Although not shown, a cover could also protect receptacle 5831. This side of the storage bin 5810 also includes supports 5840 that can be used to support a device utilizing receptacle 5831. For example, supports can be used for a phone, tool battery charger, etc. Although shown here as straight posts, any configuration of these supports 5841 can be used to support a device, including L-shaped brackets, a shelf, a slot, a hook, etc. In this manner, when the rechargeable battery is charged, devices and tools can be plugged into receptacles 5830, 5831 to receive power when a standard/fixed source of power is not available to the worksite or wheelbarrow. As can be appreciated, receptacles 5830, 5831 can include any number and configuration of outlets, plugs, or any other power connection suitable for a particular device and/or application.

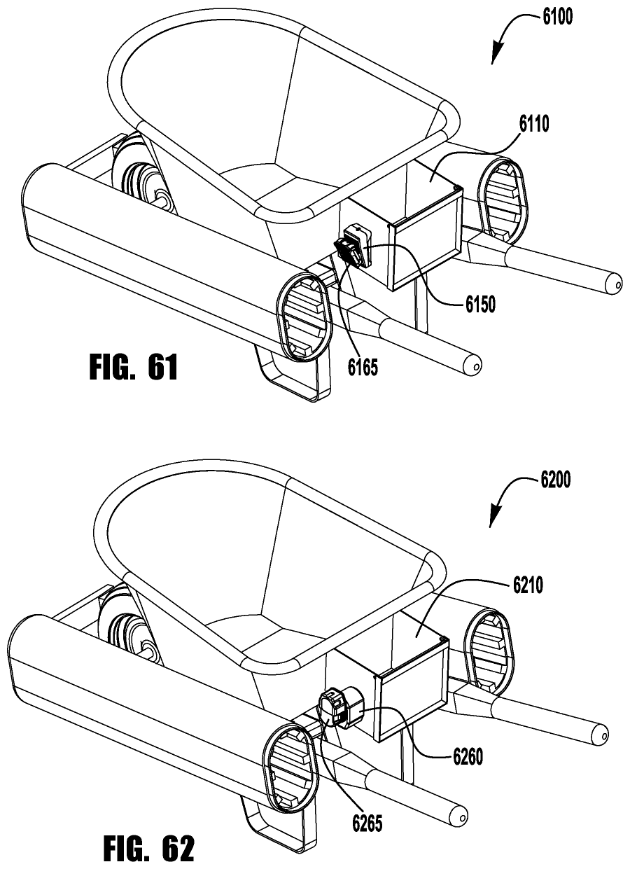

In another embodiment 6100, as shown in FIG. 61, a tool battery charger 6160 for charging tool battery 6165 is mounted on a side of the storage bin 6110. In various embodiments, the charger 6160 can be hardwired into the power distribution system mentioned above or plugged into an outlet of the system, as described above. Similarly, in another embodiment 6200, as shown in FIG. 62, another tool battery charger 6260 for charging tool battery 6265 is mounted on a side of the storage bin 6210. In various embodiments, the charger 6260 can be hardwired into the power distribution system mentioned above or plugged into an outlet of the system, as described above. In other embodiments, a variety of types of tool battery chargers can integrated into the system and/or plugged into the system, alone or in combination.

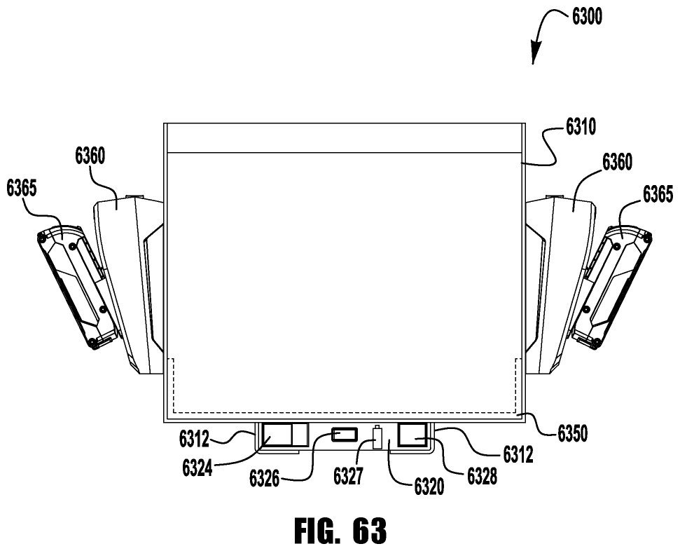

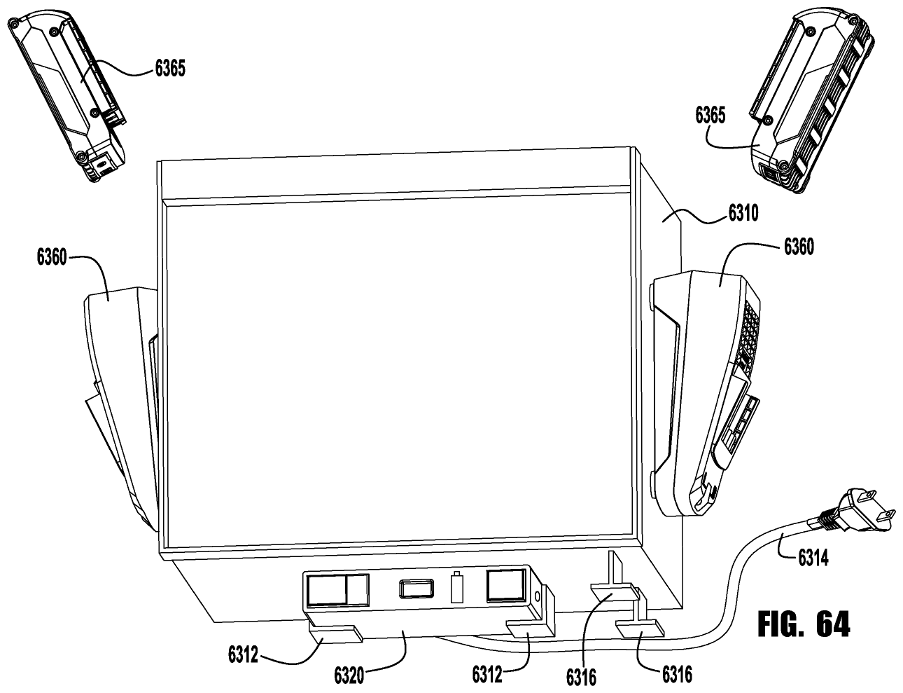

FIG. 63 shows an exemplary embodiment 6300 of a storage bin and power unit that can be attached to a wheelbarrow. In particular, a power unit or rechargeable battery 6320 can be connected to a storage bin 6310 with power distribution, configured as a modular attachment for a wheelbarrow, for example, to provide power/charging to various devices and/or equipment. The storage bin 6310 can be configured as any of the storage bins mentioned above, including, for example, mounting, materials, features, lid, etc.

With additional reference to FIG. 64, in this embodiment, the rechargeable battery 6320 is removably attached to the bottom of the storage bin 6310 (e.g., by sliding in and out), for example, via support brackets 6312. In some embodiments, the rechargeable battery 6320 is weatherproof and in other embodiments, a cover may protect the rechargeable battery 6320. The power unit or rechargeable battery 6320 can be various shapes, sizes, materials, power types (e.g., AC, DC), voltages, capacities (e.g., amp hours), etc. suitable for various applications.

In this embodiment, the rechargeable battery 6320 can be charged in a separate charging dock (e.g., via a plug or a separate charging cord plugged into a standard outlet) and then connected to the storage bin 6310 via the plug, as described above in embodiment 5800, which can be mounted, for example, to the top or back of the rechargeable battery 6320 with an interfacing surface/plug of the storage bin 6310. In other embodiments, the rechargeable battery 6320 can be charged while connected to the storage bin 6310, for example, via a charging cord 6314 plugged into a standard outlet, as shown in FIG. 64 (including embodiments where the rechargeable battery is hardwired to the power distribution system 6350). In some embodiments, the charging cord 6314 is removable from the back of the rechargeable battery 6320 and can be stored, for example, in the storage bin 6310. In other embodiments, the charging cord 6314 can be wrapped around brackets 6316 for storage.

As described in embodiment 5800 above, when charged and connected to the storage bin 6310, the rechargeable battery 6320 can provide power/charging to various devices and/or equipment without the need for access to a standard outlet. The power unit or rechargeable battery 6320 can be various shapes, sizes, materials, power types (e.g., AC, DC), voltages, capacities (e.g., amp hours), etc. suitable for various applications.

In this embodiment, rechargeable battery 6320 is connected to a power distribution system 6350 (e.g., including receptacle, wires, circuits, conduit, outlets, etc.). The power distribution system 6350 can be connected to one or more receptacles or plugs, for example, for various devices or chargers. In this embodiment, tool battery chargers 6360 for charging tool batteries 6365 are shown mounted on the sides of the storage bin 6310. In other embodiments, the storage bin 6310 can also include one more receptacles 5830, 5831, as described above. In embodiments with side-mounted receptacles/chargers and an outside mounted rechargeable battery, more space can be reserved for other items in the storage bin 6310. However, in other embodiments, receptacles/chargers can be mounted inside the storage bin 6310.

In this embodiment, the rechargeable battery 6320 housing is shown with an ON/OFF switch 6324 for turning the battery power on and off, a reset button 6326 for resetting a circuit (e.g., after an overcurrent, ground fault (e.g., with a GFCI circuit or receptacle), surge, excessive temperature, etc.), an LCD display 6327 (e.g., showing mode, connection status, voltage, battery state of charge, etc.), and a mode button 6328 for indexing through and/or selecting various rechargeable battery 6320 functions and options. In other embodiments, some or all of these features can be included on the bottom and/or side surfaces of the rechargeable battery 6320 and/or storage bin 6310. These and other features can be included in the any of the rechargeable batteries disclosed herein, including, for example, on any viewable/accessible surface of the rechargeable battery and/or storage bin. For example, these features can be included on the top and/or side surface(s) of rechargeable battery 5820 and/or storage bin 5810. In yet other embodiments, some features may be associated with chargers (e.g., state of charge of the tool battery), receptacles (e.g., a reset button on a GFCI outlet), etc. Various other features may be available in other embodiments. In some embodiments, the rechargeable battery may also include receptacles directly in its housing.

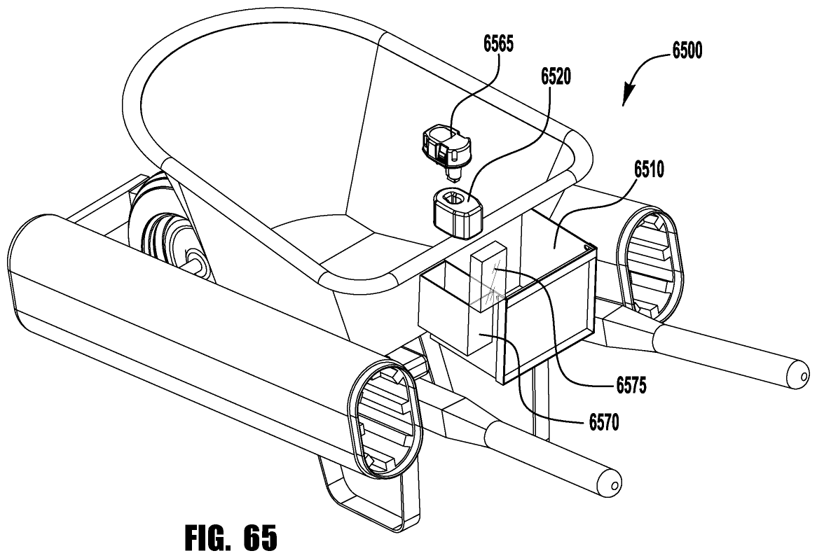

FIG. 65 shows an exemplary embodiment 6500 of a storage bin and an accessory bin that can be attached to a wheelbarrow. In particular, an accessory bin 6570 can be connected to a storage bin 6510 with power distribution, configured as a modular attachment for a wheelbarrow, for example, to provide power/charging to various devices and/or equipment. The storage bin 6310 can be configured as any of the storage bins mentioned above, including, for example, mounting, materials, features, lid, etc.

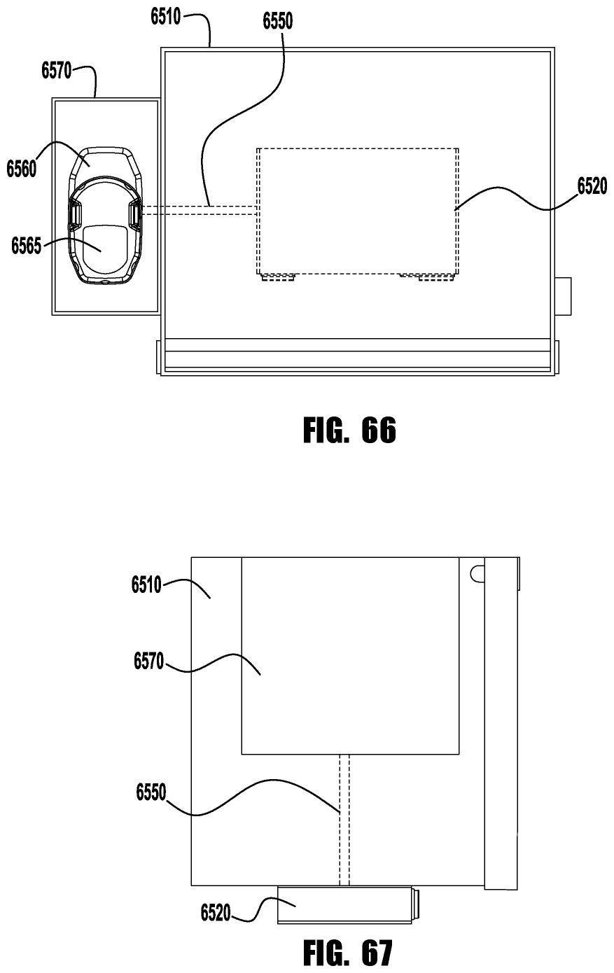

With additional reference to FIGS. 66-67, in this embodiment, the accessory bin 6570 is removably attached to the side (or bottom) of the storage bin 6510 via any suitable attachment means, including, for example, bolts/nuts, tabs, hooks, etc. In some embodiments, the accessory bin 6570 has a weatherproof cover 6575. The power unit or rechargeable battery 6520 can be configured and operate similar to any of the rechargeable batteries mentioned above, including mounted inside or outside of the storage bin 6510 (as shown) or mounted inside or outside of the accessory bin 6570.

In this manner, the accessory bin 6570 can be a modular attachment separate from the storage bin 6510, and is adaptable for mounting anywhere on the wheelbarrow, including with a rechargeable battery mounted to the accessory bin 6570. Like the embodiments with side-mounted chargers and outside mounted rechargeable battery, this embodiment can reserve more space for other items in the storage bin 6510.

Also in this embodiment, rechargeable battery 6520 is connected to a power distribution system 6550 that leads to the accessory bin 6570. In this manner, the receptacles or plugs, for example, for various devices or chargers, can be placed in the accessory bin 6570 supplied with power from the rechargeable battery 6520 via the power distribution system 6550. In this embodiment, tool battery charger 6560 for charging tool battery 6565 is shown in the accessory bin 6570. In other embodiments, the accessory bin 6570 can also include one more receptacles 5830, 5831, inside or outside the accessory bin 6570, as described above. In other embodiments, the storage bin 6510 can also include any of the receptacles or plugs discussed above.

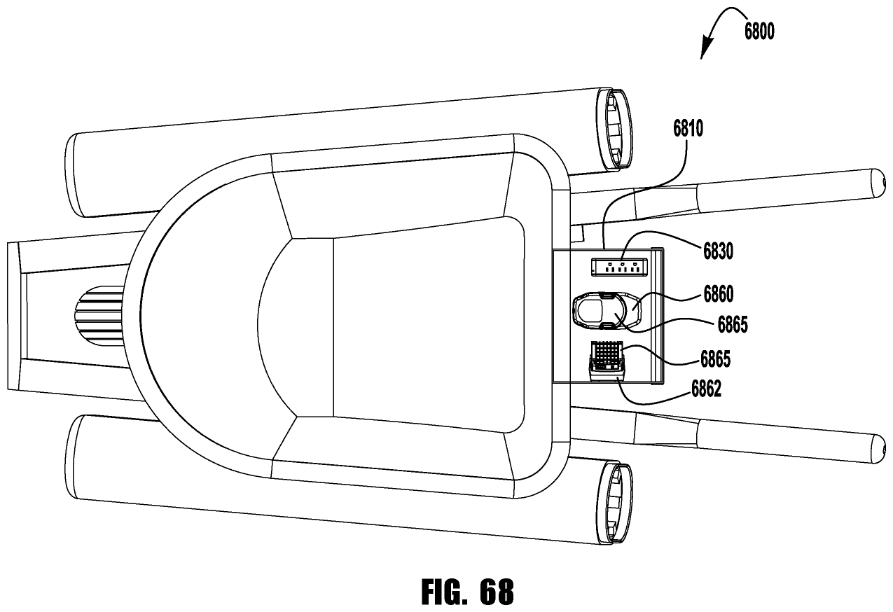

FIG. 68 shows an exemplary embodiment 6800 of a storage bin and power unit that can be attached to a wheelbarrow. In particular, a power unit or rechargeable battery 6820 can be connected to a storage bin 6810 with power distribution, configured as a modular attachment for a wheelbarrow, for example, to provide power/charging to various devices and/or equipment. The storage bin 6810 can be configured as any of the storage bins mentioned above, including, for example, mounting, materials, features, lid, etc.

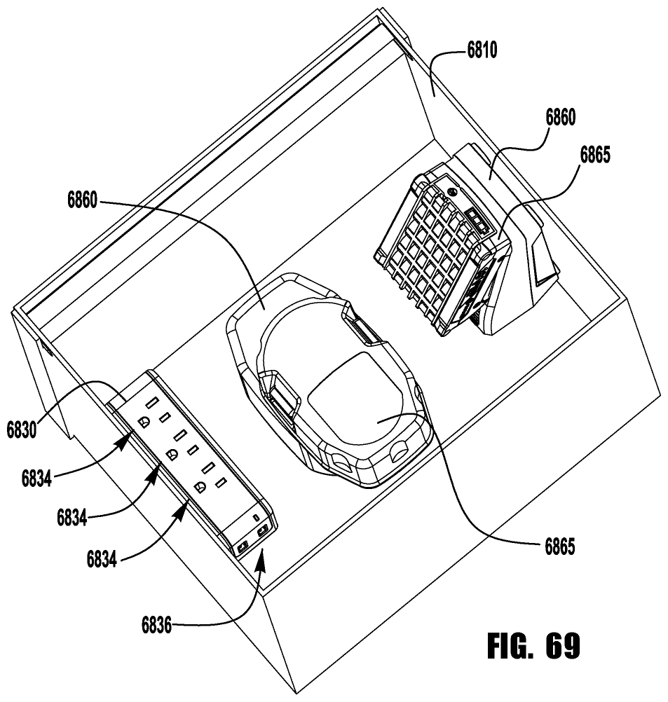

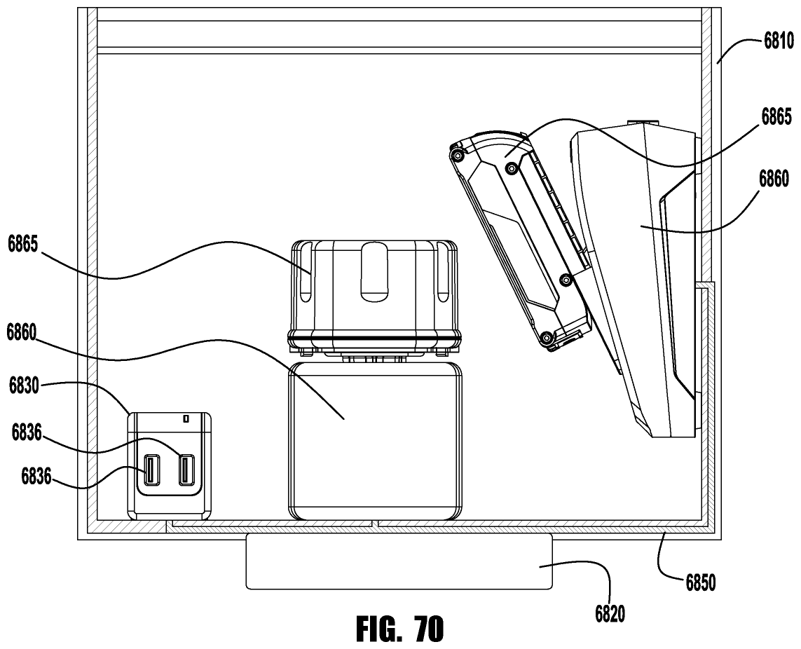

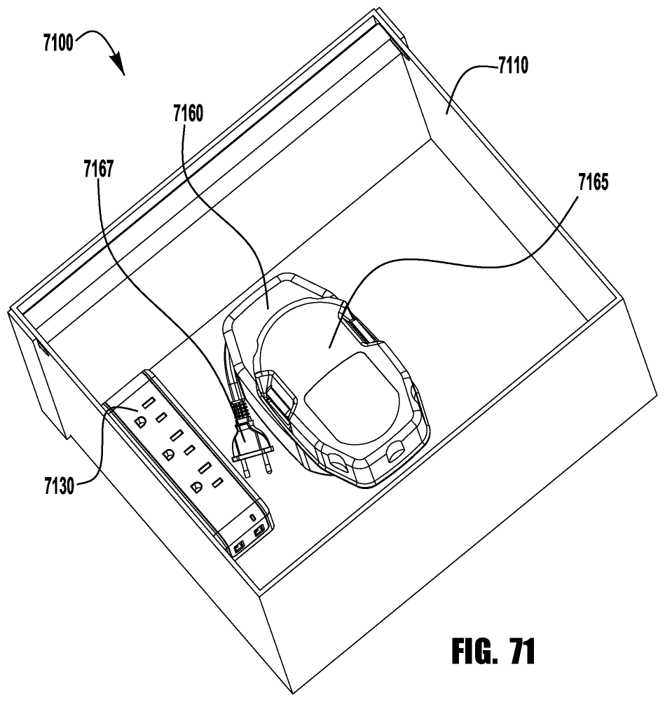

With additional reference to FIGS. 69-70, in this embodiment, the power unit or rechargeable battery 6820 can be configured and operate similar to any of the rechargeable batteries mentioned above, including mounted inside or outside of the storage bin 6810 (as shown).

In this embodiment, rechargeable battery 6820 is connected to a power distribution system 6850 (e.g., including receptacle, wires, circuits, conduit, outlets, etc.). The power distribution system 6850 can be connected to one or more receptacles or plugs, for example, for various devices or chargers. In this embodiment, tool battery chargers 6860 for charging tool batteries 6865 are shown mounted on the inside of the storage bin 6810. In this embodiment, the storage bin 6810 also includes a receptacle 6830 with 110v AC outlets 6834 and USB outlets 6836, which can operate similar to receptacles 5830, 5831, as described above. However, in other embodiments, one or more receptacles/chargers can be mounted for access outside the storage bin 6810.

FIG. 71 shows an exemplary embodiment 7100 of a storage bin and power unit that can be attached to a wheelbarrow. In particular, a power unit or rechargeable battery can be connected to a storage bin 7810 with power distribution, configured as a modular attachment for a wheelbarrow, for example, as described above in embodiment 6800. However, in this embodiment, the power distribution system is only connected to a receptacle 7130, which can be configured as receptacle 6830 above. In this manner, any number of devices can be connected to the receptacle 7130 via their own charging cords. For example, tool battery charger 7160 for charging tool batteries 7165 is shown inside of the storage bin 7110 with its charging cord 7167, which can be connected to receptacle 7130.

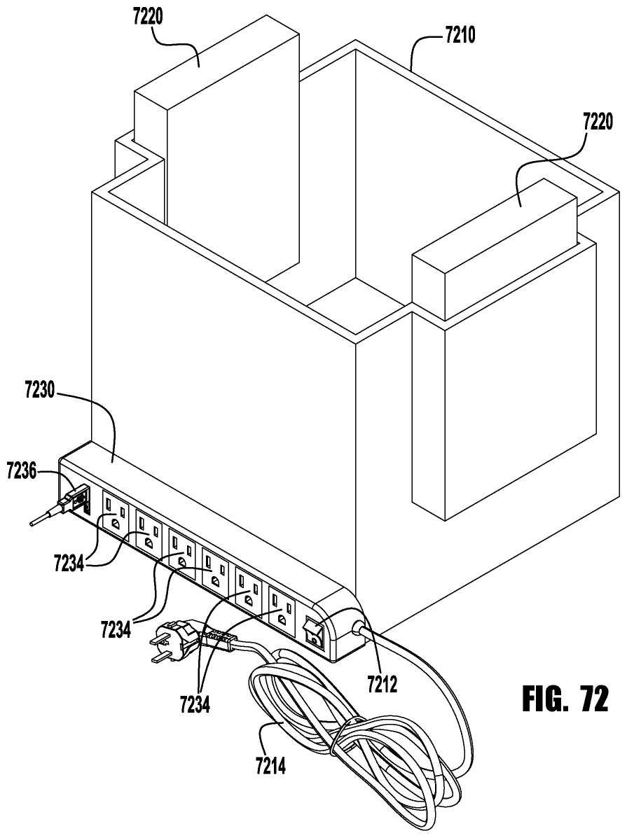

FIG. 72 shows an exemplary embodiment of a removable storage bin 7210 with an integrated power unit, for example, that can be placed in the above-mentioned storage bin(s) or other location of a wheelbarrow. In this embodiment, storage bin 7210 can include all of the features mentioned above for storage bins, but can be placed inside of another storage bin, for example, for more regular removal (e.g., for use elsewhere, charging, cleaning, etc.). In particular, one or more power units or rechargeable batteries 7220 can be removably connected to the storage bin 7210 with power distribution, configured as a modular attachment for a wheelbarrow, for example, to provide power/charging to various devices and/or equipment. The storage bin 7210 can be configured as any of the storage bins mentioned above, including, for example, materials, features, lid, etc.

In this embodiment, the storage bin 7210 includes a charging cord 7214 that charges the one or more rechargeable batteries 7220. When the batteries 7220 are charged, they can provide power via a power distribution system to the receptacle 7230, which can include 110v AC outlets 7234 and USB outlets 7236, which can operate similar to receptacles 5830, 5831, as described above. Power may also be provided to various charges directly or by plugging them into the receptacle 7230, as described above. A switch 7212 can toggle between battery 7220 charging and power distribution modes (e.g., with the charging cord 7214 disconnected from a standard power source when charging battery 7220). In other embodiments, receptacle 7230 can be mounted anywhere on the storage bin 7210, including inside the storage bin 7210.

In other embodiments, the dual battery design, which can be utilized by any other embodiment described above, can allow for charging of one battery (e.g., while removed from the storage bin) while the other battery provides power to the receptacles.

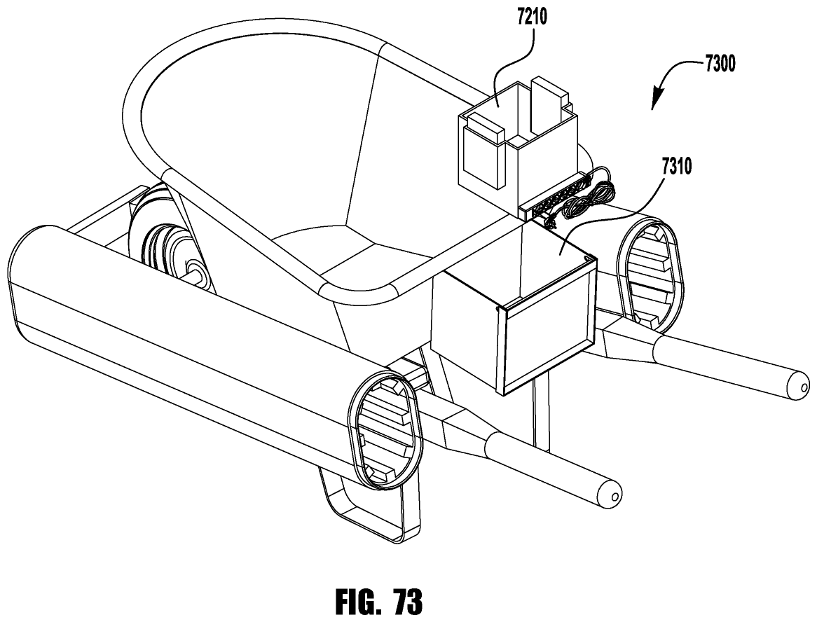

With additional reference to FIG. 73, embodiment 7300 shows the storage bin 7210 as it is being placed into the storage bin 7310 of a wheelbarrow. The batteries 7220 of storage bin 7210 can be charged via the charging cord 7214 when the storage bin 7210 is inside of the wheelbarrow or removed. In this manner, after the wheelbarrow includes storage bin 7310, storage bin 7210 can be utilized for adding the power unit capabilities and features to the wheelbarrow in a more temporary or easily removable manner. Furthermore, the storage bin 7210 can be placed in other locations of the wheelbarrow or worksite and may be used for other needs and/or with other wheelbarrows.

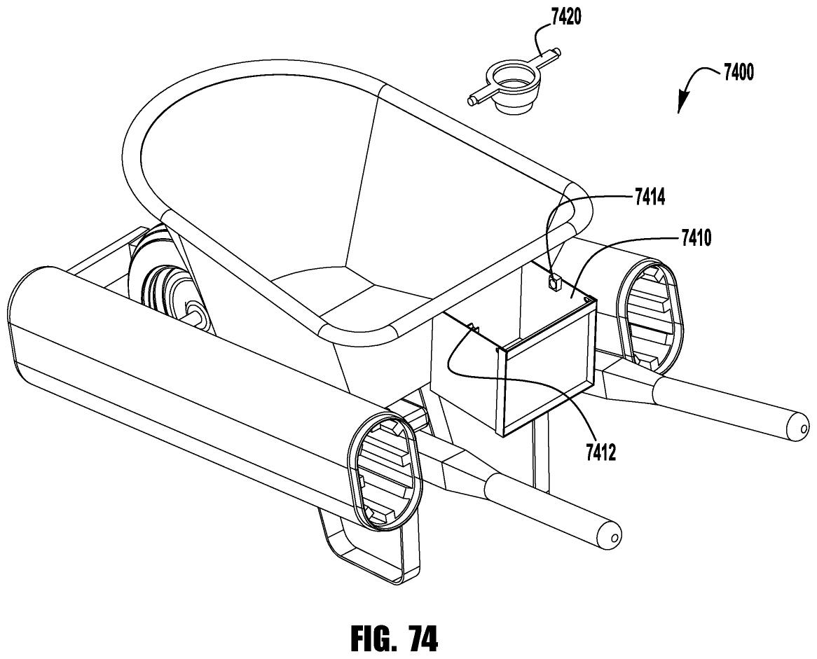

FIG. 74 shows an exemplary embodiment 7400 of a storage bin and cupholder that can be attached to a wheelbarrow. In particular, a cupholder 7420 can be connected to a storage bin 7410, configured as a modular attachment for a wheelbarrow to provide a place to store a cup in the wheelbarrow that will not tip/spill during use of the wheelbarrow. The storage bin 7410 can be configured as any of the storage bins mentioned above, including, for example, mounting, materials, features, lid, etc. The cupholder 7420 can be various shapes, sizes, angles, materials, etc. suitable for various applications.

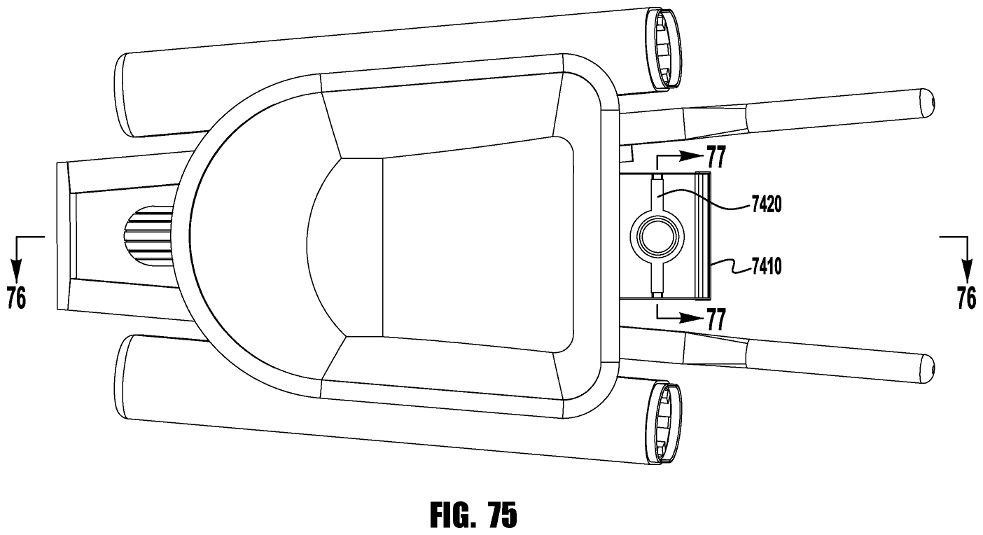

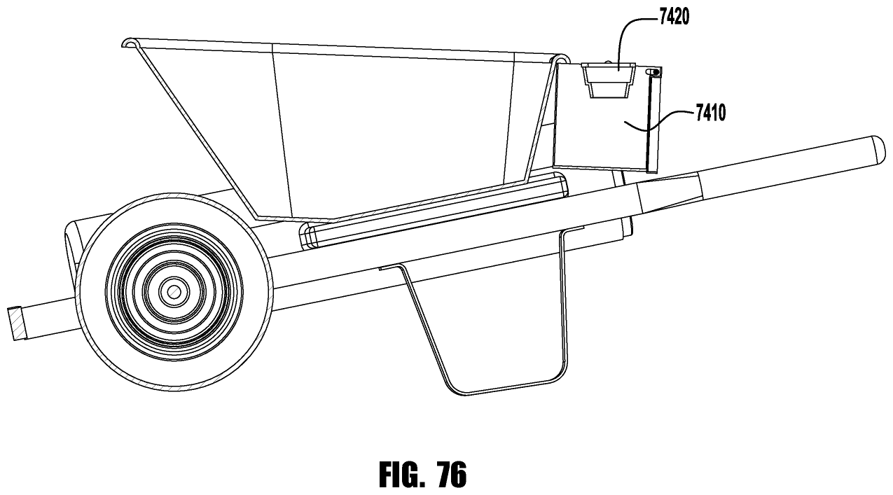

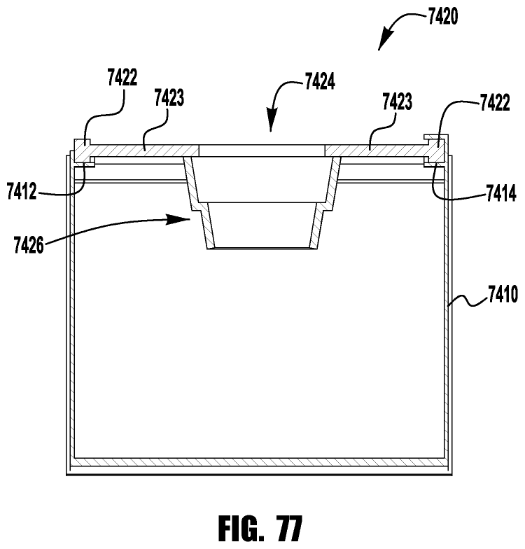

With additional reference to FIGS. 75-78, the cupholder includes a cup receptacle 7424 and arms 7423 that form a rotatable axle/axis when placed into the storage bin 7410. The cupholder 7420 can be placed into the storage bin 7410 by engaging the ends or hubs 7422 of arms 7423 into receivers 7412, 7414 of the storage bin 7410. Receiver 7414 can be a closed shape that surrounds the hub 7422 of arm 7423 when inserted into the receiver 7414. Receiver 7412 can be an open shape that only partially surrounds the hub 7422 of arm 7423 when inserted into the receiver 7412. In this manner, when placing the cupholder 7420 into the storage bin 7410, one hub 7422 can first be inserted into receiver 7414, followed by inserting the other hub 7422 into or onto receiver 7412. The shapes of receivers 7412, 7414 and hubs 7422 allow the cupholder 7420 to rotate about the axis of arms 7423 during use of the wheelbarrow, including tipping, as shown in FIG. 78. When not in use, the cupholder 7420 can be stored in the wheelbarrow, including in the storage bin 7410.

In this embodiment, the cupholder 7420 is symmetrical about its arm 7423 axis, shown as the cross-section of FIG. 77. The symmetry allows the horizontal center of gravity of a cup and its contents placed in the cupholder 7420 to remain along the axis. The cup receptacle 7424 can be configured to allow the vertical center of gravity of a cup and its contents placed in the cupholder 7420 to remain near or below the axis. In some embodiments, the cup receptacle 7424 can include one or more weights (e.g., near the bottom, as a weighted base) to lower the center of gravity and/or add mass to assist in balance/rotation during wheelbarrow movement (e.g., tipping). The cup receptacle 7424 can also include an adjustable cup receiver portion 7426 to allow for receiving different size cups and to maintain the proper position/height. For example, the cup receptacle 7424 can include flexible retention tabs inside the cup receiver portion 7426 to engage different size drink holders (e.g., bottles, cans, cups, mugs, etc.). In this manner, the center of gravity will cause the cupholder 7420 to pivot/rotate along the axis of its arms 7423 to keep the cup from spilling during use of the wheelbarrow. In some embodiments, more than one cupholder 7420 can be provided in a kit to accommodate a wide range of cup sizes and shapes.

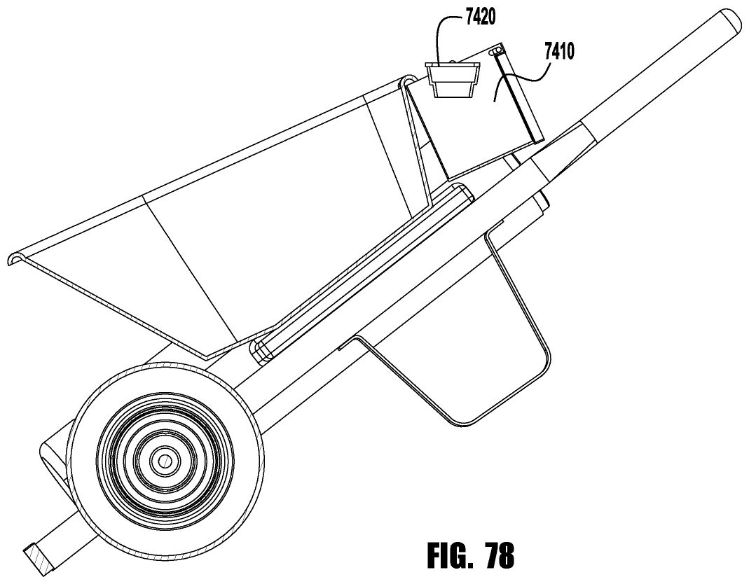

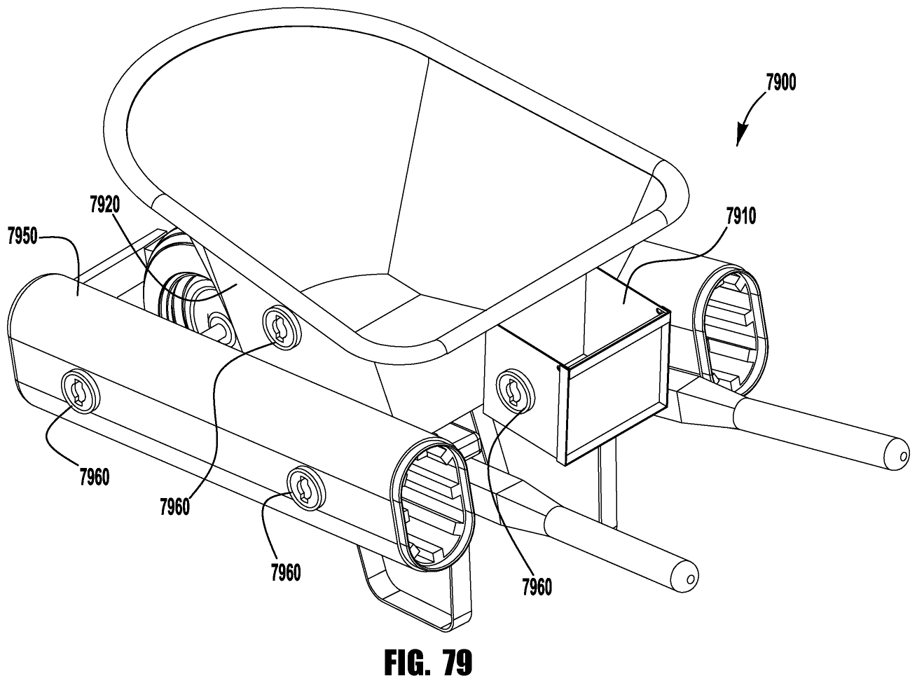

FIG. 79 shows an exemplary embodiment 7900 with attachment holders that can be attached to a wheelbarrow. In particular, attachment holders 7960 can be configured as a modular attachment for a wheelbarrow to provide a releasable quick connect for an attachment or accessory. The wheelbarrow can be configured as any of the wheelbarrows mentioned above, including, for example, components, materials, features, etc. The attachment holders 7960 can be various shapes, sizes, angles, materials, etc. suitable for various applications.

One or more attachment holders 7960 can be configured to attach to any component surface of a wheelbarrow, including, for example, a storage bin 7910, a tub 7920, a tube 7950, etc. In various embodiments, the surfaces can include horizontal or vertical surfaces, also including inside or outside of the various components. In different embodiments, the attachment members or holders 7960 can be originally included as part of a wheelbarrow component and/or can be attached to the wheelbarrow via any suitable attachment means, including, screws, bolts/nuts, adhesive, hooks, clips, etc.

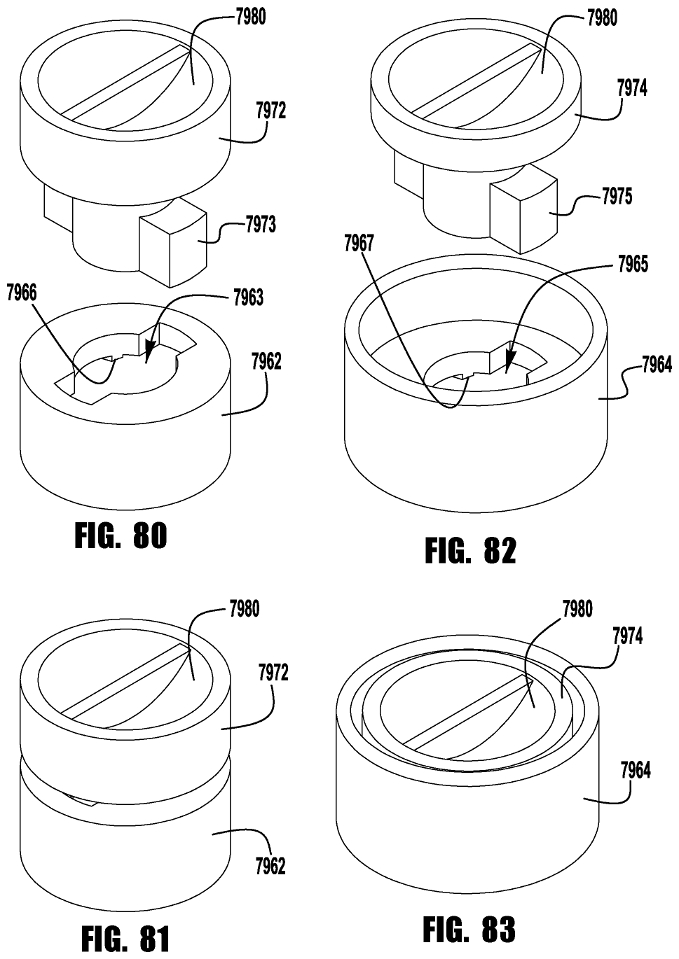

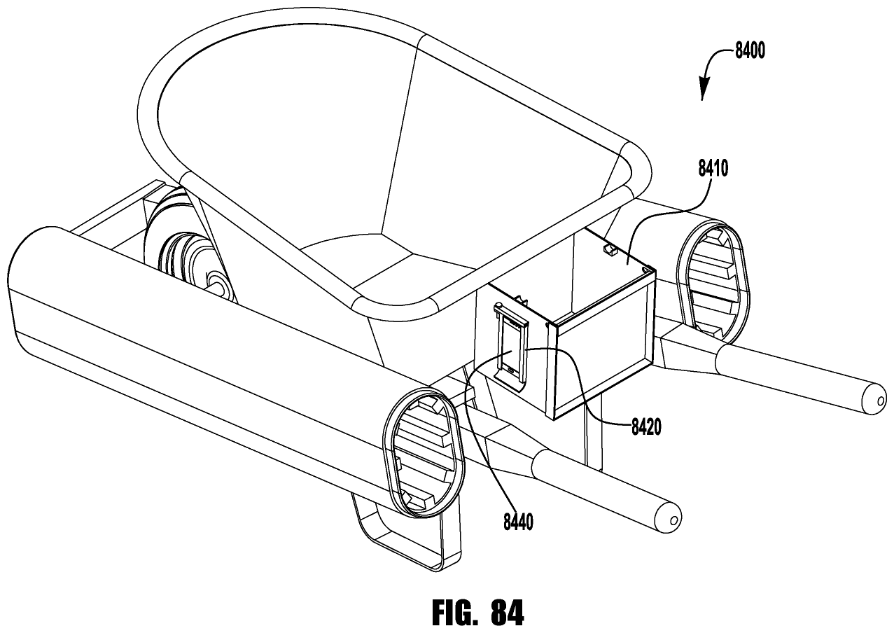

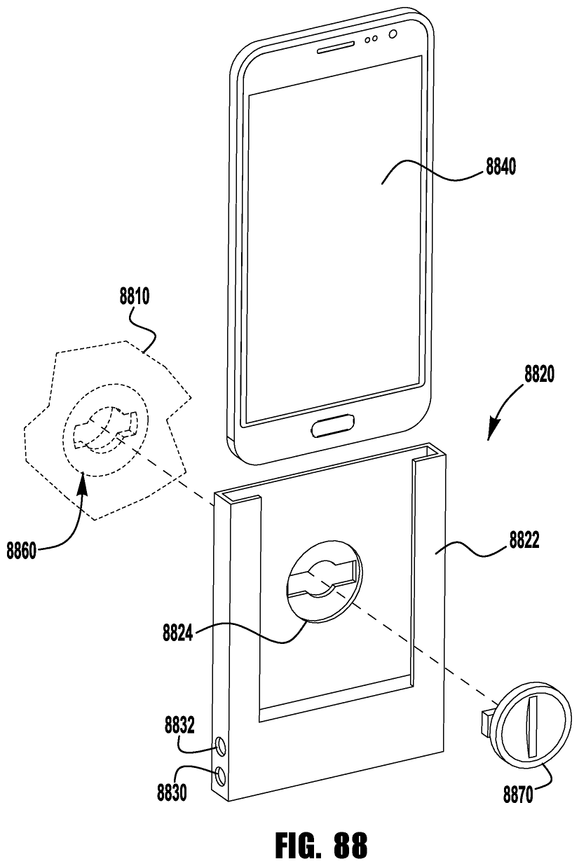

With additional reference to FIGS. 80-83, two embodiments of attachment members or holders 7960 are shown as holders 7962, 7964 interfacing with locking tabs 7972, 7974, respectively. Locking tabs 7972, 7974 can be associated with the attachment to be attached to the wheelbarrow, for example, by being integrated with a surface of the attachment or passing through the surface to attach the attachment to the wheelbarrow, as described in more detail below. In these embodiments, locking tabs 7972, 7974 can also include an actuator 7980 that, for example, allows for twisting of the locking tabs 7972, 7974 as they are inserted into the holders 7962, 7964, respectively. Holders 7962, 7964 can also include keyways 7963, 7965 and locking tabs 7972, 7974 can also include keys 7973, 7975 for proper engagement of the of the locking tabs 7972, 7974 as they are inserted into the holders 7962, 7964, respectively. For example, as shown in FIG. 80 (before engagement) and FIG. 81 (after engagement), locking tab 7972 can engage holder 7962 by aligning and inserting key 7973 within keyway 7963, then twisting the locking tab 7972 via the actuator 7980 until the key 7973 snaps over a retention feature 7966 of the keyway 7963. Similarly, as shown in FIG. 88 (before engagement) and FIG. 83 (after engagement), locking tab 7974 can engage holder 7964 by aligning and inserting key 7975 within keyway 7965, then twisting the locking tab 7974 via the actuator 7980 until the key 7975 snaps over a retention feature 7967 of the keyway 7965.

In these embodiments, holders 7962, 7964 and locking tabs 7972, 7974 are configured to not penetrate the surface of the wheelbarrow component that they attach to. However, in other embodiments, the keys of the locking tabs can engage keyways configured into the surface of the wheelbarrow component, such that the key does penetrate the surface of the wheelbarrow component.

Either of these embodiments may be used depending on the nature of the surfaces of the attachment and the wheelbarrow surface, for example, including how a surface of the attachment is retained by the locking tab 7972, 7974 when engaged with the holder 7962, 7964, respectively. As can be appreciated, many other varieties of engagement mechanisms can be used as part of the holders and locking tabs to secure an item to a wheelbarrow in a manner that allows for quick connect and release.

For example, FIG. 84 shows an exemplary embodiment 8400 with an accessory holder that can be attached to a wheelbarrow. In particular, accessory holder 8420 can be configured as a modular attachment for a wheelbarrow to provide a releasable quick connect holder for an accessory or device 8440, such as, for example, a phone, tablet, speaker, etc. In various embodiments, the accessory holder 8420 can be configured to utilize any of the holders 7962, 7964 and locking tabs 7972, 7974 mentioned above. In this embodiment, the accessory holder 8420 is shown attached to a storage bin 8410, but in other embodiments the accessory holder 8420 can be attached to any surface of the wheelbarrow, as described above. The accessory holder 8420 can be various shapes, sizes, materials, etc. suitable for various applications.

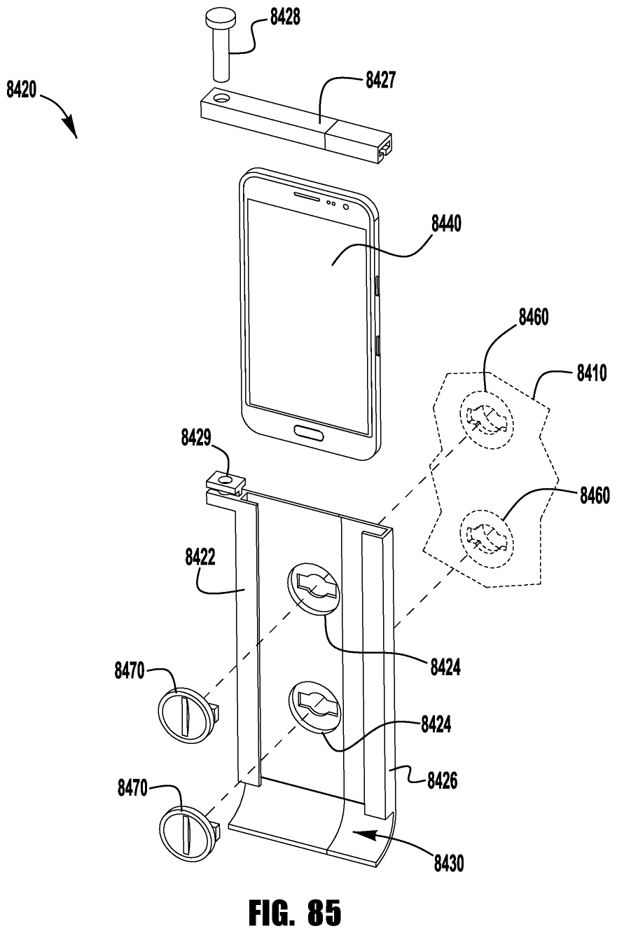

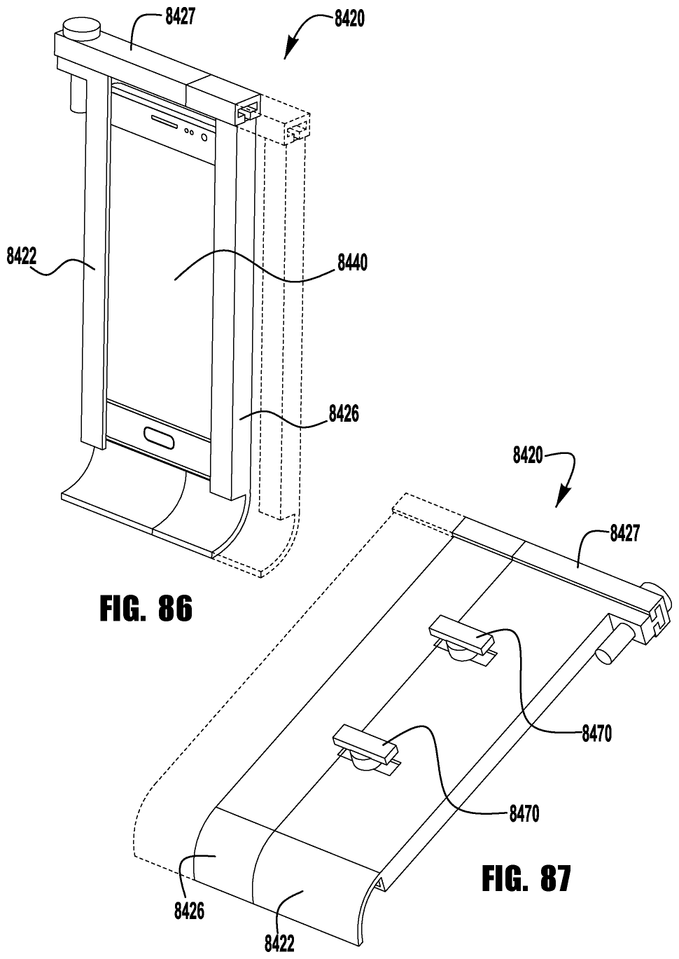

With additional reference to FIGS. 85-87, the accessory holder 8420 can include a main support 8422 (e.g., with a device flange), an adjustable support 8426 for adjustably sizing the holder to conform to the size of the held device 8440 with the main support 8422 (shown as dashed lines in FIGS. 86-87), a top support 8427, an optional locking pin 8428 (e.g., post, screw, nub, etc.) with receiver 8429 (which may also allow the top support 8427 to lift and pivot/rotate while loading/unloading the device in or out of the holder 8420), and a bottom support 8430 that can optionally have an acoustic channel shape (e.g., curved outward) to direct sound from the bottom of the device 8400 out of the holder 8420. In other embodiments, the holder 8420 may also include a similar mechanism to allow for height sizing adjustments. In other embodiments, various mechanisms can be used to secure and lock the device 8440 into a holder.

In this embodiment, the accessory holder 8420 includes locking tabs 8470 that pass through holes 8424 (e.g., in the main support 8422) to retain the holder 8420 to holders 8460 integrated into or attached to the storage bin 8410 (e.g., via a key/keyway configuration described above) for removably attaching the accessory holder 8820 to the storage bin 8410.

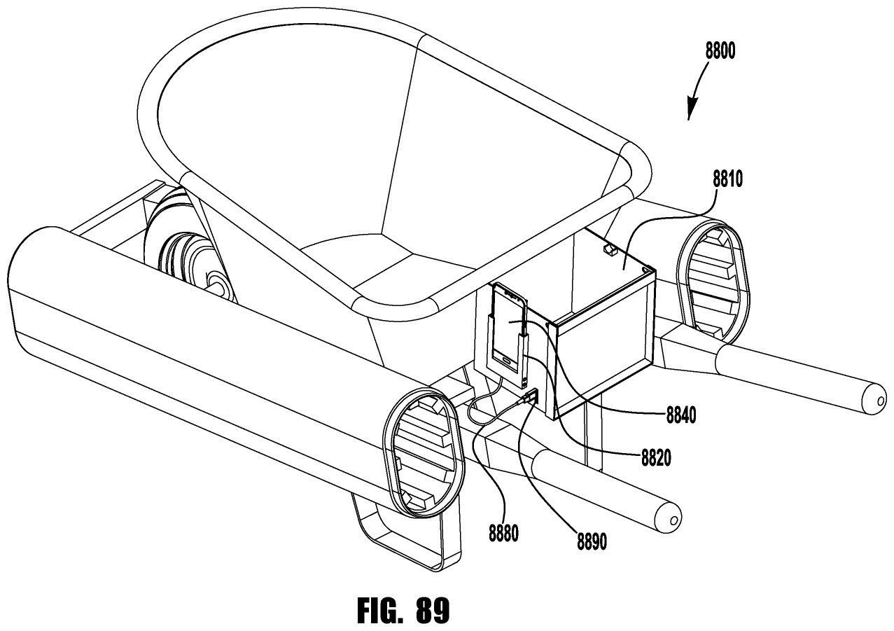

In another example, FIGS. 88-89 show an exemplary embodiment 8800 with an accessory holder that can be attached to a wheelbarrow. In particular, accessory holder 8820 can be configured as a modular attachment for a wheelbarrow to provide a releasable quick connect holder for an accessory or device 8840, such as, for example, a phone, tablet, speaker, etc. In various embodiments, the accessory holder 8820 can be configured to utilize any of the holders 7962, 7964 and locking tabs 7972, 7974 mentioned above. In this embodiment, the accessory holder 8820 is shown attached to a storage bin 8810, but in other embodiments the accessory holder 8820 can be attached to any surface of the wheelbarrow, as described above. The accessory holder 8820 can be various shapes, sizes, materials, etc. suitable for various applications.

In this embodiment, the accessory holder 8820 can include a main body 8822 (e.g., with device flanges), acoustic channel 8830 to allow sound to exit the holder 8820, and cord passage holes 8832 in the side and/or bottom of body 8822. In other embodiments, the holder 8820 may also include sizing mechanisms. FIG. 89 shows power cord 8880 connecting to a USB receptacle 8890 in the storage bin 8810 for providing power to the device 8840 (e.g., as described above).

In this embodiment, the accessory holder 8820 includes locking tab 8870 that passes through hole 8824 (e.g., in the main body 8822) to retain the holder 8820 to holder 8860 integrated into or attached to the storage bin 8810 (e.g., via a key/keyway configuration described above) for removably attaching the accessory holder 8820 to the storage bin 8810.

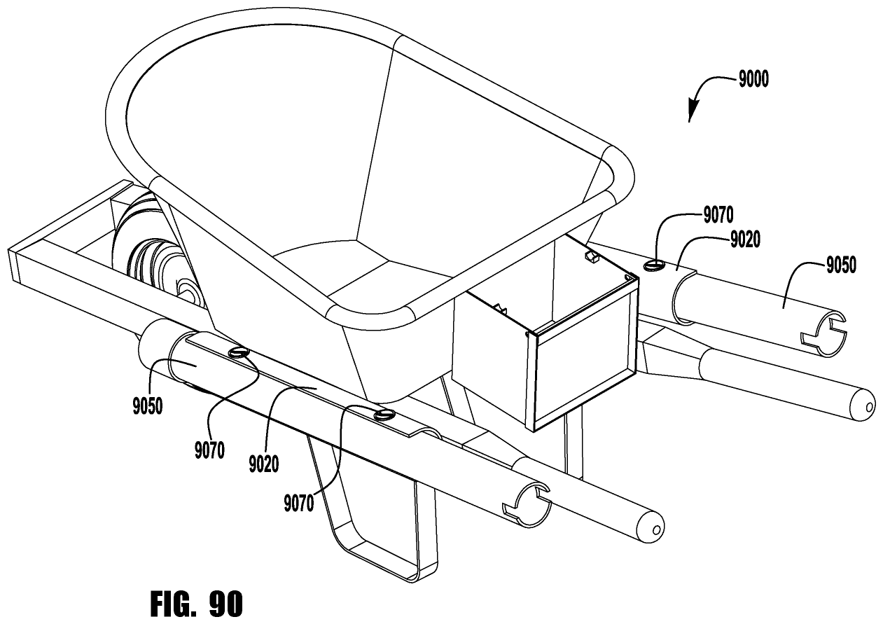

FIG. 90 shows an exemplary embodiment 9000 with an accessory holder that can be attached to a wheelbarrow. In particular, accessory holder 9020 can be configured as a modular attachment for a wheelbarrow to provide a releasable quick connect holder for an accessory, such as, for example, a modular tube 9050. In various embodiments, the accessory holder 9020 can be configured to utilize any of the holders 7962, 7964 and locking tabs 7972, 7974 mentioned above. In this embodiment, the accessory holder 9020 is shown attached to a wheelbarrow where a tube 9050 can be attached (e.g., between the tub and side support), but in other embodiments the accessory holder 9020 can be attached to any surface of the wheelbarrow. The tube 9050 can be used to transport various items, as described above. The accessory holder 9020 can be various shapes, sizes, materials, etc. suitable for various applications.

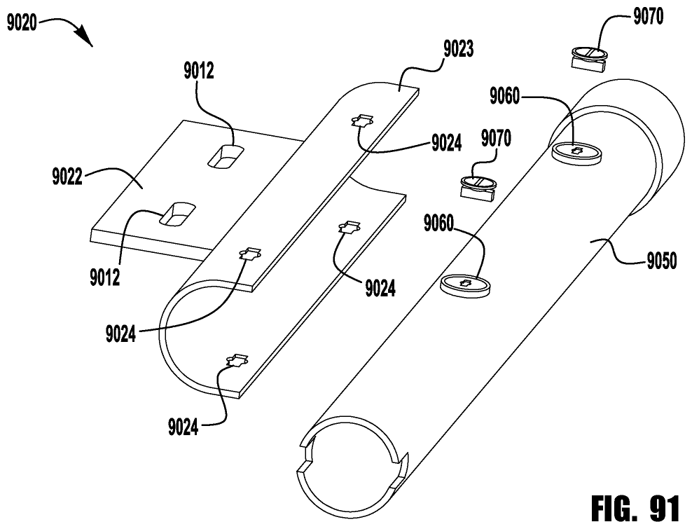

With additional reference to FIG. 91, the accessory holder 9020 can include a main support 9022 (e.g., with a fin or flange) for attaching to the wheelbarrow (e.g., via holes/slots 9012 in this embodiment that can accommodate the bolts that attach the tub to the side supports, as described above), an open support 9023 for accepting an accessory (e.g., in this embodiment, modular tube 9050). The accessory holder 9020 can be various shapes, sizes, materials, etc. suitable for various applications.

In this embodiment, the accessory holder 9020 includes locking tabs 9070 that pass through holes 9024 (e.g., in the support 9023) to retain the holder 9060 integrated into or attached to the tube 9050 (e.g., via a key/keyway configuration described above) to accessory holder 9020 for removably attaching the tube 9050 to the wheelbarrow.

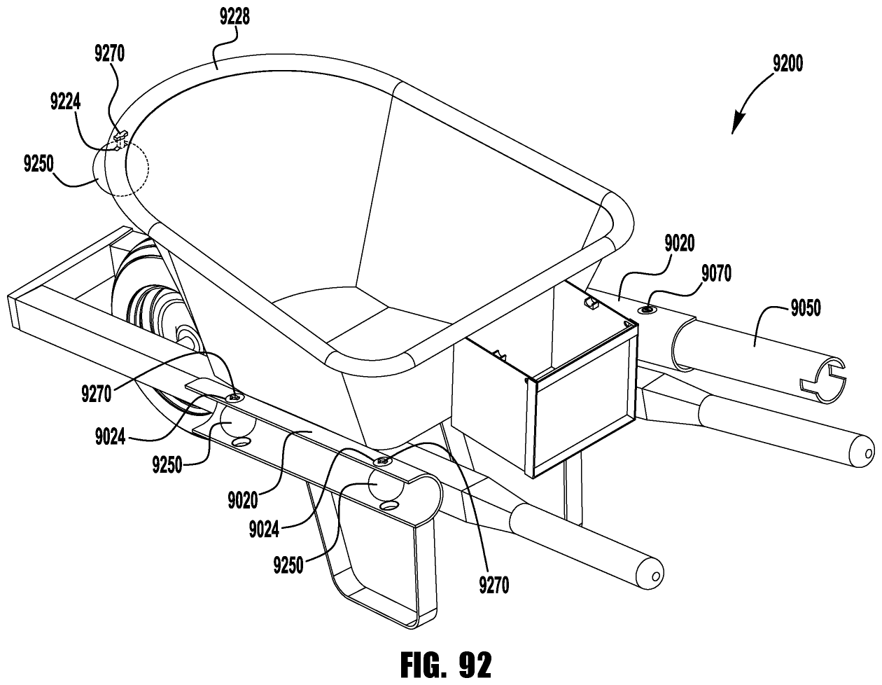

In another example, FIGS. 92-93 show an exemplary embodiment 9200 with two accessory holders 9020 shown attached to a wheelbarrow with a tube 9050 attached to an accessory holder 9020 on one side and counterweights 9250 attached to an accessory holder 9020 on the other side. One or more counterweights 9250 can be used to balance the weight distribution on the wheelbarrow, for example, when one side of the wheelbarrow has a heavier load than the other side (e.g., with heavy items in one tube, against one side of the tub, etc.). Embodiment 9200 also shows a counterweight 9250 attached to the front rim 9228 of the wheelbarrow tub, for example, to balance a heavy load near the rear of the wheelbarrow or to assist with front tipping.

In this embodiment, the counterweights 9250 include locking tab 9270 that can pass through hole 9024 to retain the counterweight 9250 to holder 9020 (e.g., via a key/keyway configuration described above) and/or through hole 9224 to retain the counterweight 9250 to the rim 9228 for removably attaching the counterweights 9250 to the wheelbarrow.

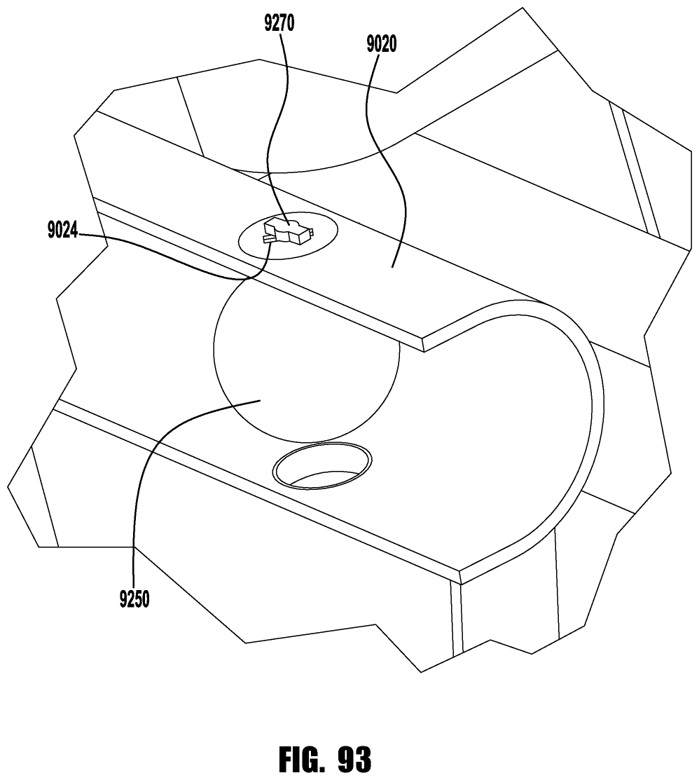

FIG. 94 shows an exemplary embodiment 9400 of support wheels attached to a wheelbarrow. In particular, one or more support wheels can be configured as a modular attachment for a wheelbarrow. In this embodiment, one or more accessory wheels 9436 can be mounted, for example, to the front extension (e.g., 104, as described above) or an extended front wheel axle 9434 (including along with a front wheel 9432). The accessory wheel(s) 9436 can provide additional support to the wheelbarrow, including, for example, to prevent tipping and/or to better distribute the weight. In various embodiments, the accessory wheels 9436 can be configured (e.g., via various diameters) to be at the same level as the front wheel 9432 or above. The wheel 9432, 9436 may be constructed from various materials, including, for example, rubber, plastic, etc. The wheels 9432, 9436 may be part of a wheel assembly that may also include other components, such as, for example, a wheel hub, a wheel bearing, etc., suitable for allowing the wheelbarrow to roll in a preferably stable and smooth manner.

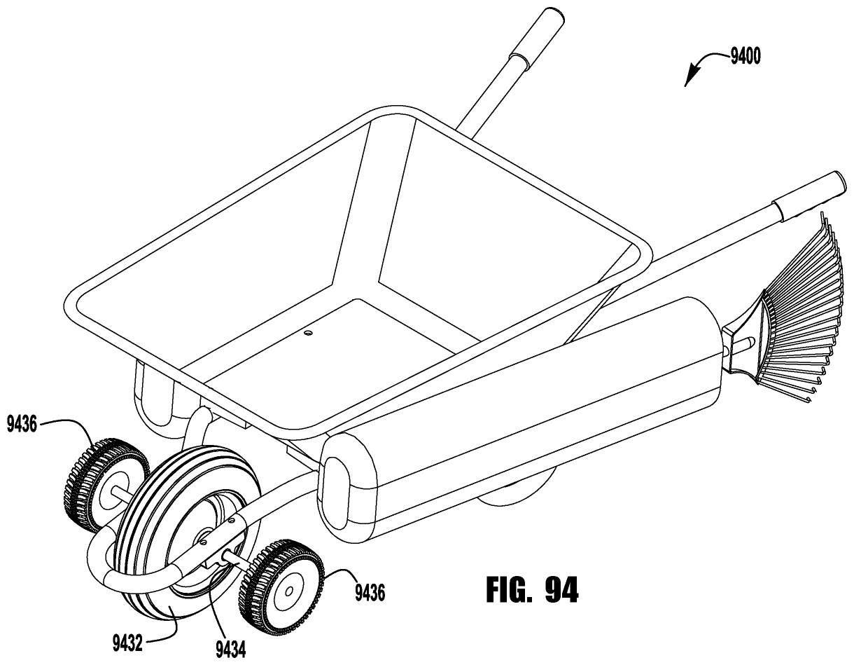

FIG. 95 shows an exemplary embodiment 9500 of a storage bin 9560 and locking lid 9570 that can be configured as a modular attachment for a wheelbarrow. The storage bin 9560 can be generally configured as any of the storage bins mentioned above, including, for example, mounting, materials, features, lid, etc. In this embodiment, the storage bin 9560 attaches to the tub 9520 of a wheelbarrow, but in other embodiments, can be attached to any portion of the wheelbarrow. Unlike several storage bin embodiments described above, storage bin 9560 does not utilize the rim 9528 of the tub 9520 to lock the lid 9570 in the closed position as the wheelbarrow is tipped. As such, the lid 9570 can be oriented in any direction around the storage 9560.

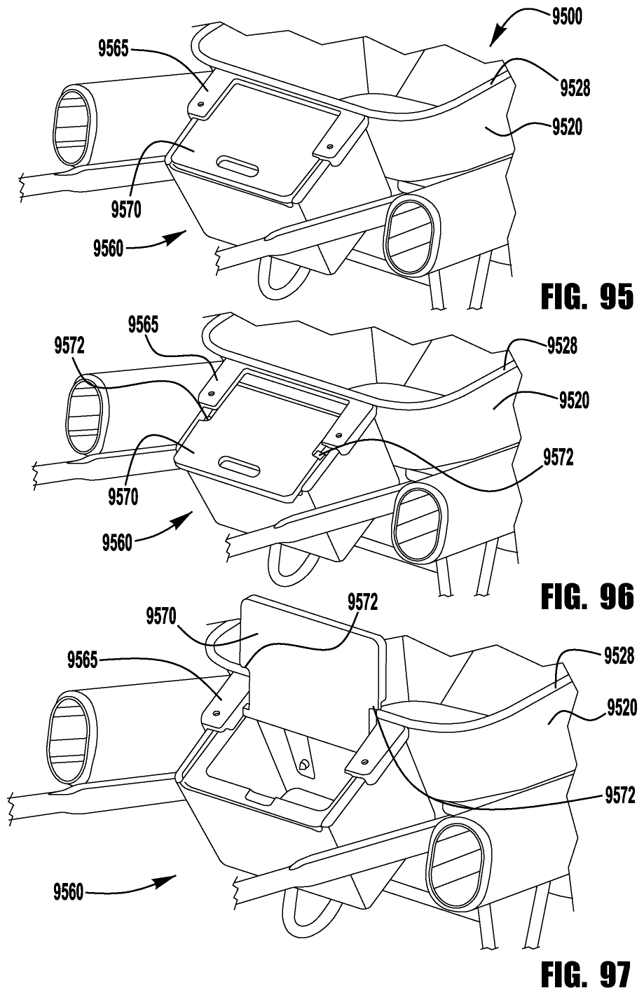

In this embodiment, locking lid 9570 is attached to the storage bin 9560 with a portion of bracket 9565 covering a portion of the lid 9570 when the lid 9570 is in the closed position (e.g., as shown in FIG. 95). In this manner, the lid 9570 is locked in the closed position, including during tipping of the wheelbarrow. With additional reference to FIGS. 96-97, to open the lid 9570, lid 9570 can be slid away from bracket 9565, such that the portion of the lid 9570 (e.g., one or more tabs 9572) that was covered by the bracket 9565 (e.g., as shown in FIG. 95 to prevent opening during tipping) is now exposed (e.g., as shown in FIG. 96). Then the lid 9570 can be rotated up to allow access to the storage bin 9560, including, for example, where another portion of the lid 9570 is retained by the bracket 9565, such that the lid 9570 rotates open (e.g., as shown in FIG. 97). In other embodiments, the lid 9570 can slide completely out from under bracket 9565 and be removed from the storage bin 9560.

As described above, one or more modular attachments, including, for example, auxiliary storage devices, transport/stability pins, lids/covers, seats, stabilizers/struts, other storage/support devices, auxiliary power (outlets, charges, etc.), batteries, cupholders, tub extensions/baskets, device holders, attachment holders, counterweights, stabilizer wheels, quick connection/release mechanisms, etc. can be attached to a wheelbarrow In various embodiments. One or more modular attachments or devices can be selectively added or attached to the wheelbarrow, alone or in combination, as needed. In some embodiments, the modular attachments or devices can be included with the wheelbarrow from the onset. In other embodiments, modular attachments can be added to the wheelbarrow later. In some embodiments, one or more modular attachments can be included in a kit for selectively retrofitting a wheelbarrow.

While the present invention has been illustrated by the description of embodiments thereof, and while the embodiments have been described in considerable detail, it is not the intention of the applicant to restrict or in any way limit the scope of the appended claims to such detail. Additional advantages and modifications will readily appear to those skilled in the art. For example, component types, geometries, shapes, and dimensions can be modified without changing the overall role or function of the components. Therefore, the inventive concept, in its broader aspects, is not limited to the specific details, the representative apparatus, and illustrative examples shown and described. Accordingly, departures may be made from such details without departing from the spirit or scope of the applicant's general inventive concept.

What is claimed:

1. A wheelbarrow auxiliary storage device, comprising:
a tube configured to attach to a frame or a tub of a wheelbarrow, wherein the tube is configured to store an item transported by the wheelbarrow and retain the item stored in the tube when the wheelbarrow is in a tipping position; and
an integrated mounting member for attaching the tube to the frame or the tub of the wheelbarrow;
wherein a length of the attached tube and a length of an elongated item stored in the tube are in a substantially horizontal position when the wheelbarrow is not in a tipping position.

2. The wheelbarrow auxiliary storage device of claim 1, wherein the tube comprises:
a first end of the tube oriented towards a rear extension of the frame, wherein the first end is closed; and
a second end of the tube oriented towards a front extension of the frame, wherein the second end is open for insertion of the item.

3. The wheelbarrow auxiliary storage device of claim 2, wherein the second end of the tube includes one or more notches along a perimeter of the second end that is configured to engage a feature of the item when stored in the tube.

4. The wheelbarrow auxiliary storage device of claim 1, wherein an inside surface of the tube includes one or more ridges along the length of the tube.

5. The wheelbarrow auxiliary storage device of claim 1, wherein the tube comprises at least one drain hole.

6. The wheelbarrow auxiliary storage device of claim 1, further comprising a tube extension attached to the tube, wherein the tube extension comprises at least one flange configured to store another item transported by the wheelbarrow.

7. The wheelbarrow auxiliary storage device of claim 6, wherein the tube extension attaches to the tube by clipping to the side of the tube.

8. The wheelbarrow auxiliary storage device of claim 6, wherein the tube extension attaches to the tube by sliding over the first end or the second end of the tube.

10. The wheelbarrow auxiliary storage device of claim 1, further comprising a stabilizer attached to the tube, wherein the stabilizer comprises at least one support configured to make contact with the ground to stabilize the wheelbarrow.

11. The wheelbarrow auxiliary storage device of claim 10, wherein the stabilizer attaches to the tube by sliding over the first end or the second end of the tube.

12. The wheelbarrow auxiliary storage device of claim 1, further comprising an attachment holder attached to the tube, wherein the attachment holder is configured to releasably receive a mating tab associated with an accessory to the wheelbarrow, such that engagement of the tab to the attachment holder retains the accessory to the wheelbarrow and disengagement of the tab from the attachment holder releases the accessory from the wheelbarrow.

13. The wheelbarrow auxiliary storage device of claim 1, wherein the integrated mounting member is configured to attach the tube to of the wheelbarrow via hardware that connects the tub to the frame.

14. A wheelbarrow auxiliary storage device, comprising:
an accessory holder configured to attach to a frame or a tub of a wheelbarrow, wherein the accessory holder is configured to releasably receive a tube, and wherein the tube is configured to store an item transported by the wheelbarrow and retain the item stored in the tube when the wheelbarrow is in a tipping position; and
an integrated mounting member for attaching the accessory holder to the frame or the tub of the wheelbarrow;
wherein a length of the attached tube and a length of an elongated item stored in the tube are in a substantially horizontal position when the wheelbarrow is not in a tipping position.

15. The wheelbarrow auxiliary storage device of claim 14, wherein the tube comprises an attachment holder, wherein the attachment holder is configured to receive a mating tab associated with the accessory holder, such that engagement of the tab to the attachment holder retains the tube to the accessory holder and disengagement of the tab from the attachment holder releases the tube from the accessory holder.

16. The wheelbarrow auxiliary storage device of claim 14, wherein the accessory holder is further configured to releasably receive a counterweight configured to selectively attach to the accessory holder to balance the weight distribution of the wheelbarrow, and wherein the accessory holder is configured to receive a mating tab associated with the counterweight, such that engagement of the tab to the accessory holder retains the counterweight to the accessory holder and disengagement of the tab from the accessory holder releases the counterweight from the accessory holder.

17. The wheelbarrow auxiliary storage device of claim 14, wherein the tube comprises:
a first end of the tube oriented towards a rear extension of the frame, wherein the first end is closed; and
a second end of the tube oriented towards a front extension of the frame, wherein the second end is open for insertion of the item.

18. A wheelbarrow auxiliary storage kit, comprising:
an accessory holder configured to attach to a frame or a tub of a wheelbarrow, wherein the accessory holder is configured to releasably receive an accessory;
an integrated mounting member for attaching the accessory holder to the frame or the tub of the wheelbarrow;
a tube configured to attach to at least one of the accessory holder, a frame, or a tub of the wheelbarrow, wherein the tube is configured to store an item transported by the wheelbarrow and retain the item stored in the tube when the wheelbarrow is in a tipping position, and wherein a length of the attached tube and a length of an elongated item stored in the tube are in a substantially horizontal position when the wheelbarrow is not in a tipping position; and
a storage bin mountable to the tub or the frame of the wheelbarrow that stores an item transported by the wheelbarrow.

19. The wheelbarrow auxiliary storage kit of claim 18, further comprising:
a tube extension attachable to the tube, wherein the tube extension comprises at least one flange configured to store another item transported by the wheelbarrow; and
a stabilizer attachable to the tube or the tub, wherein the stabilizer comprises at least one support configured to make contact with the ground to stabilize the wheelbarrow.

20. The wheelbarrow of claim 18, wherein the storage bin comprises a power distribution system for providing power to at least one receptacle via a rechargeable battery.
